(19) United States
(12) Patent Application Publication
(10) Pub. No.: US 2025/0088333 A1
(43) Pub. Date: Mar. 13, 2025

(54) GROUP COMMON BEAM INDICATION

(71) Applicant: Samsung Electronics Co., Ltd., Suwon-si (KR)

(72) Inventors: Dalin Zhu, Allen, TX (US); Emad Nader Farag, Flanders, NJ (US); Eko Onggosanusi, Coppell, TX (US)

(21) Appl. No.: 18/824,788

(22) Filed: Sep. 4, 2024

Related U.S. Application Data
(60) Provisional application No. 63/538,191, filed on Sep. 13, 2023.
(60) Provisional application No. 63/541,167, filed on Sep. 28, 2023.
(60) Provisional application No. 63/541,512, filed on Sep. 29, 2023.
(60) Provisional application No. 63/542,221, filed on Oct. 3, 2023.
(60) Provisional application No. 63/542,411, filed on Oct. 4, 2023.

(51) Int. Cl. H04L 5/00; H04W 72/232

(52) U.S. Cl. CPC H04L 5/0053; H04W 72/232

(57) ABSTRACT

Methods and apparatuses for group common beam indication. A method performed by a user equipment (UE) includes receiving a plurality of first transmission configuration indication (TCI) states in a group common downlink control information (DCI) and receiving first information related to a plurality of channel measurement resources (CMRs) for coherent-joint transmission (CJT). The method further includes determining, based on the plurality of first TCI states, at least one second TCI state; determining an association between the at least one second TCI state and the first information; and receiving, based on the association, the plurality of CMRs. The first information comprises at least a number of the plurality of CMRs and time-frequency domain resource configurations for the plurality of CMRs.

### CROSS-REFERENCE TO RELATED AND CLAIM OF PRIORITY

The present application claims priority under 35 U.S.C. § 119(e) to U.S. Provisional Patent Application No. 63/538,191 filed on Sep. 13, 2023; U.S. Provisional Patent Application No. 63/541,167 filed on Sep. 28, 2023; U.S. Provisional Patent Application No. 63/541,512 filed on Sep. 29, 2023; U.S. Provisional Patent Application No. 63/542,221 filed on Oct. 3, 2023; and U.S. Provisional Patent Application No. 63/542,411 filed on Oct. 4, 2023, which are hereby incorporated by reference in their entirety.

### TECHNICAL FIELD

The present disclosure relates generally to wireless communication systems and, more specifically, the present disclosure relates to methods and apparatuses for group common beam indication.

### BACKGROUND

Wireless communication has been one of the most successful innovations in modern history. Recently, the number of subscribers to wireless communication services exceeded five billion and continues to grow quickly. The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage are of paramount importance. To meet the demand for wireless data traffic having increased since deployment of 4G communication systems, and to enable various vertical applications, 5G communication systems have been developed and are currently being deployed.

### SUMMARY

The present disclosure relates to group common beam indication.

In one embodiment, a user equipment (UE) is provided. The UE includes a transceiver configured to receive a plurality of first transmission configuration indication (TCI) states in a group common downlink control information (DCI) and receive first information related to a plurality of channel measurement resources (CMRs) for coherent-joint transmission (CJT). The UE further includes a processor operably coupled to the transceiver. The processor is configured to determine, based on the plurality of first TCI states, at least one second TCI state and determine an association between the at least one second TCI state and the first information. The transceiver is further configured to receive, based on the association, the plurality of CMRs. The first information comprises at least a number of the plurality of CMRs and time-frequency domain resource configurations for the plurality of CMRs.

In another embodiment, a base station (BS) is provided. The BS includes a processor and a transceiver operably coupled to the processor. The transceiver is configured to transmit a plurality of first TCI states in a group common DCI; transmit first information related to a plurality of CMRs for CJT, and transmit the plurality of CMRs based on an association between at least one second TCI state from the plurality of first TCI states and the first information. The first information comprises at least a number of the plurality of CMRs and time-frequency domain resource configurations for the plurality of CMRs.

In yet another embodiment, a method performed by a UE is provided. The method includes receiving a plurality of first TCI states in a group common DCI and receiving first information related to a plurality of CMRs for CJT. The method further includes determining, based on the plurality of first TCI states, at least one second TCI state; determining an association between the at least one second TCI state and the first information; and receiving, based on the association, the plurality of CMRs. The first information comprises at least a number of the plurality of CMRs and time-frequency domain resource configurations for the plurality of CMRs.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2 illustrates an example gNodeB (gNB) according to embodiments of the present disclosure;

FIG. 3 illustrates an example user equipment (UE) according to embodiments of the present disclosure;

FIGS. 4A and 4B illustrates an example of a wireless transmit and receive paths according to embodiments of the present disclosure;

FIG. 5A illustrates an example of a wireless system according to embodiments of the present disclosure;

FIG. 5B illustrates an example of a multi-beam operation according to embodiments of the present disclosure;

FIG. 6 illustrates an example of a transmitter structure for beamforming according to embodiments of the present disclosure;

FIG. 7 illustrates a diagram of an example multiple transmission-and-reception-point (multi-TRP) system according to embodiments of the present disclosure;

FIG. 8 illustrates a diagram of an example association/mapping between indicated transmission configuration indication (TCI) state for physical downlink shared channel-coherent joint transmission (PDSCH-CJT) and channel measurement resources (CMRs) configured for CJT according to embodiments of the present disclosure;

FIG. 9 illustrates a diagram of an example association/mapping between first/second indicated TCI states for PDSCH-CJT and first/second CMR group configured for CJT according to embodiments of the present disclosure; and

FIG. 10 illustrates an example method performed by a UE in a wireless communication system according to embodiments of the present disclosure.

### DETAILED DESCRIPTION

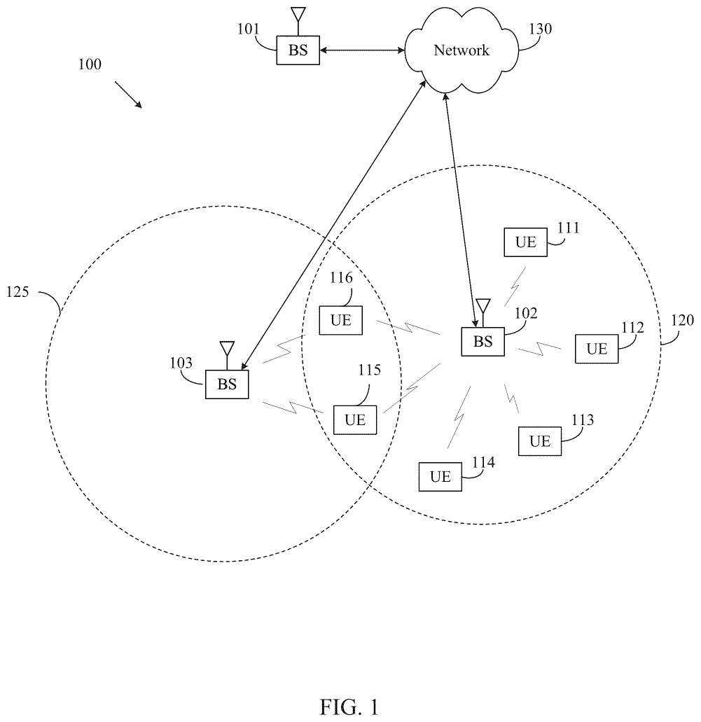

FIGS. 1-10, discussed below, and the various, non-limiting embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

To meet the demand for wireless data traffic having increased since deployment of 4G communication systems, and to enable various vertical applications, 5G/NR communication systems have been developed and are currently being deployed. The 5G/NR communication system is implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (CoMP), reception-end interference cancelation and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G, or even later releases which may use terahertz (THz) bands.

The following documents and standards descriptions are hereby incorporated by reference into the present disclosure as if fully set forth herein: [1] 3GPP TS 38.211 v16.1.0, “NR; Physical channels and modulation;” [2] 3GPP TS 38.212 v16.1.0, “NR; Multiplexing and Channel coding;” [3]3GPP TS 38.213 v16.1.0, “NR; Physical Layer Procedures for Control;” [4] 3GPP TS 38.214 v16.1.0, “NR; Physical Layer Procedures for Data;” [5] 3GPP TS 38.321 v16.1.0, “NR; Medium Access Control (MAC) protocol specification;” and [6] 3GPP TS 38.331 v16.1.0, “NR; Radio Resource Control (RRC) Protocol Specification.”

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to how different embodiments may be implemented. Different embodiments of the present disclosure may be implemented in any suitably arranged communications system.

FIG. 1 illustrates an example wireless network 100 according to embodiments of the present disclosure. The embodiment of the wireless network 100 shown in FIG. 1 is for illustration only. Other embodiments of the wireless network 100 could be used without departing from the scope of this disclosure.

As shown in FIG. 1, the wireless network 100 includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

The dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof for utilizing a group common beam indication. In certain embodiments, one or more of the BSs 101-103 include circuitry, programing, or a combination thereof to support or provide the group common beam indication.

Although FIG. 1 illustrates one example of a wireless network, various changes may be made to FIG. 1. For example, the wireless network 100 could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

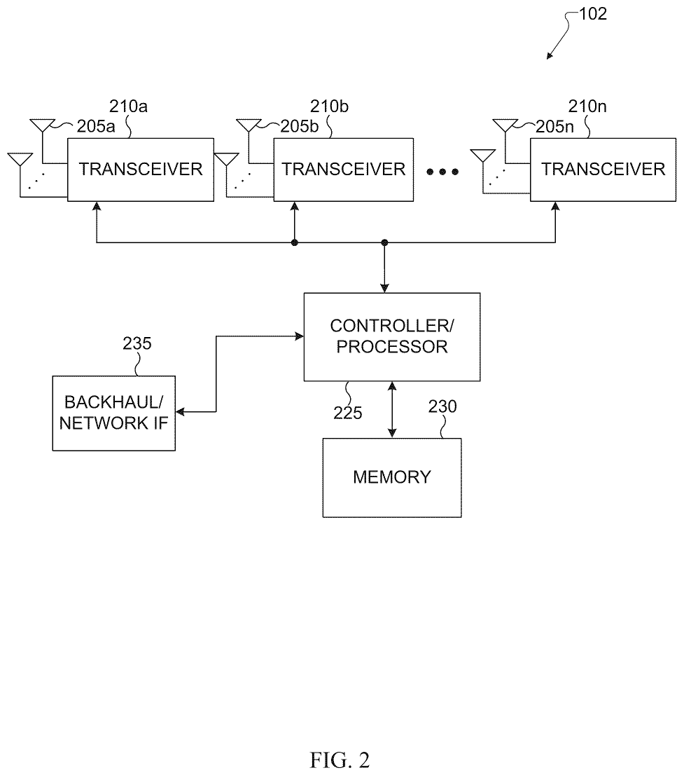

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming radio frequency (RF) signals, such as signals transmitted by UEs in the wireless network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of uplink (UL) channel signals and the transmission of downlink (DL) channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. Any of a wide variety of other functions could be supported in the gNB 102 by the controller/processor 225.

The controller/processor 225 is also capable of executing programs and other processes resident in the memory 230, such as supporting a group common beam indication. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

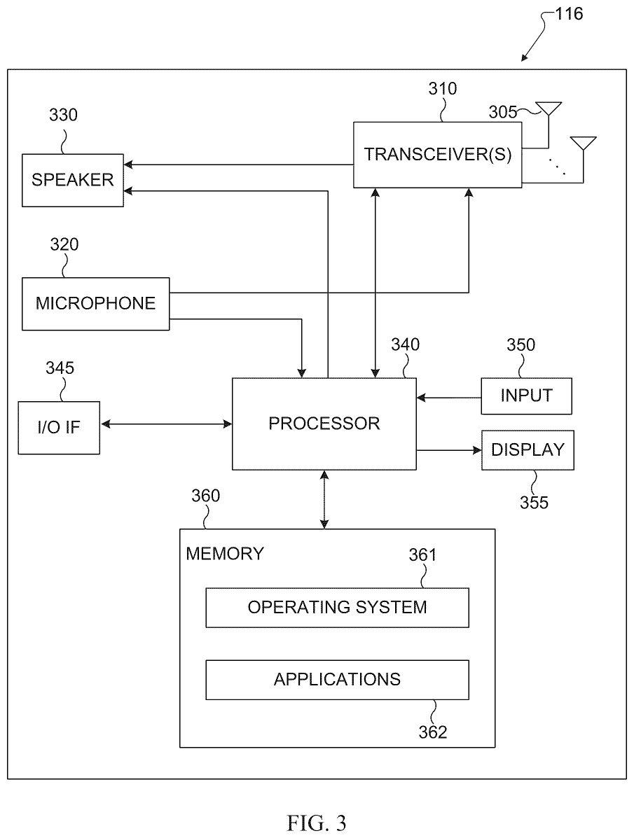

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna(s) 305, an incoming RF signal transmitted by a gNB of the wireless network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360. For example, the processor 340 may execute processes to utilize and/or identify a group common beam indication as described in embodiments of the present disclosure. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes, for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

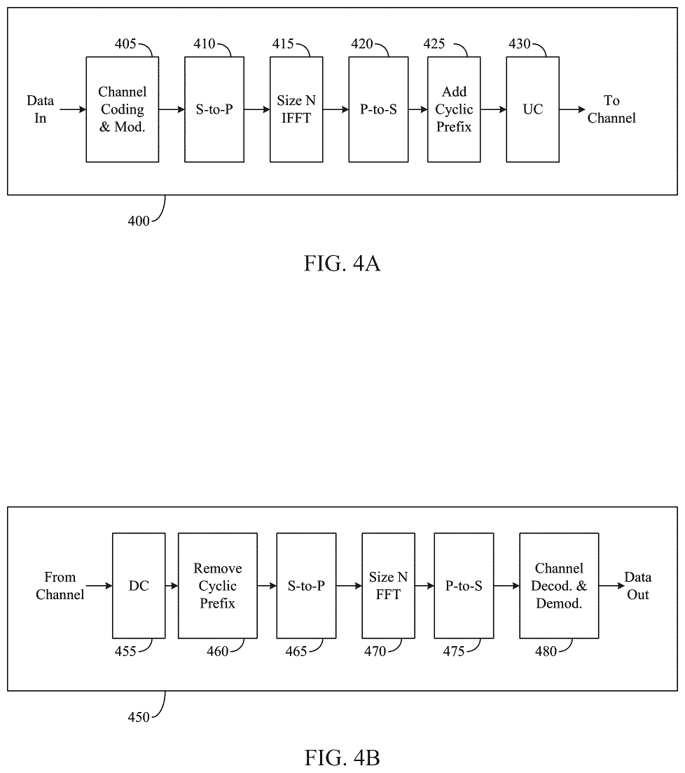

FIG. 4A and FIG. 4B illustrate an example of wireless transmit and receive paths 400 and 450, respectively, according to embodiments of the present disclosure. For example, a transmit path 400 may be described as being implemented in a gNB (such as gNB 102), while a receive path 450 may be described as being implemented in a UE (such as UE 116). However, it will be understood that the receive path 450 can be implemented in a gNB and that the transmit path 400 can be implemented in a UE. In some embodiments, the transmit path 400 and/or receive path 450 is configured to receive a group common beam indication as described in embodiments of the present disclosure.

As illustrated in FIG. 4A, the transmit path 400 includes a channel coding and modulation block 205, a serial-to-parallel (S-to-P) block 410, a size N Inverse Fast Fourier Transform (IFFT) block 415, a parallel-to-serial (P-to-S) block 420, an add cyclic prefix block 425, and an up-converter (UC) 430. The receive path 250 includes a down-converter (DC) 455, a remove cyclic prefix block 460, a S-to-P block 465, a size N Fast Fourier Transform (FFT) block 470, a parallel-to-serial (P-to-S) block 475, and a channel decoding and demodulation block 480.

In the transmit path 400, the channel coding and modulation block 405 receives a set of information bits, applies coding (such as a low-density parity check (LDPC) coding), and modulates the input bits (such as with Quadrature Phase Shift Keying (QPSK) or Quadrature Amplitude Modulation (QAM)) to generate a sequence of frequency-domain modulation symbols. The serial-to-parallel block 410 converts (such as de-multiplexes) the serial modulated symbols to parallel data in order to generate N parallel symbol streams, where N is the IFFT/FFT size used in the gNB 102 and the UE 116. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to a RF frequency for transmission via a wireless channel. The signal may also be filtered at a baseband before conversion to the RF frequency.

As illustrated in FIG. 4B, the down-converter 455 down-converts the received signal to a baseband frequency, and the remove cyclic prefix block 460 removes the cyclic prefix to generate a serial time-domain baseband signal. The serial-to-parallel block 465 converts the time-domain baseband signal to parallel time-domain signals. The size N FFT block 470 performs an FFT algorithm to generate N parallel frequency-domain signals. The (P-to-S) block 475 converts the parallel frequency-domain signals to a sequence of modulated data symbols. The channel decoding and demodulation block 480 demodulates and decodes the modulated symbols to recover the original input data stream.

Each of the gNBs 101-103 may implement a transmit path 400 that is analogous to transmitting in the downlink to UEs 111-116 and may implement a receive path 450 that is analogous to receiving in the uplink from UEs 111-116. Similarly, each of UEs 111-116 may implement a transmit path 400 for transmitting in the uplink to gNBs 101-103 and may implement a receive path 450 for receiving in the downlink from gNBs 101-103.

Each of the components in FIGS. 4A and 4B can be implemented using only hardware or using a combination of hardware and software/firmware. As a particular example, at least some of the components in FIGS. 4A and 4B may be implemented in software, while other components may be implemented by configurable hardware or a mixture of software and configurable hardware. For instance, the FFT block 470 and the IFFT block 415 may be implemented as configurable software algorithms, where the value of size N may be modified according to the implementation.

Furthermore, although described as using FFT and IFFT, this is by way of illustration only and should not be construed to limit the scope of this disclosure. Other types of transforms, such as Discrete Fourier Transform (DFT) and Inverse Discrete Fourier Transform (IDFT) functions, can be used. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIGS. 4A and 4B illustrate examples of wireless transmit and receive paths 400 and 450, respectively, various changes may be made to FIGS. 4A and 4B. For example, various components in FIGS. 4A and 4B can be combined, further subdivided, or omitted and additional components can be added according to particular needs. Also, FIGS. 4A and 4B are meant to illustrate examples of the types of transmit and receive paths that can be used in a wireless network. Any other suitable architectures can be used to support wireless communications in a wireless network.

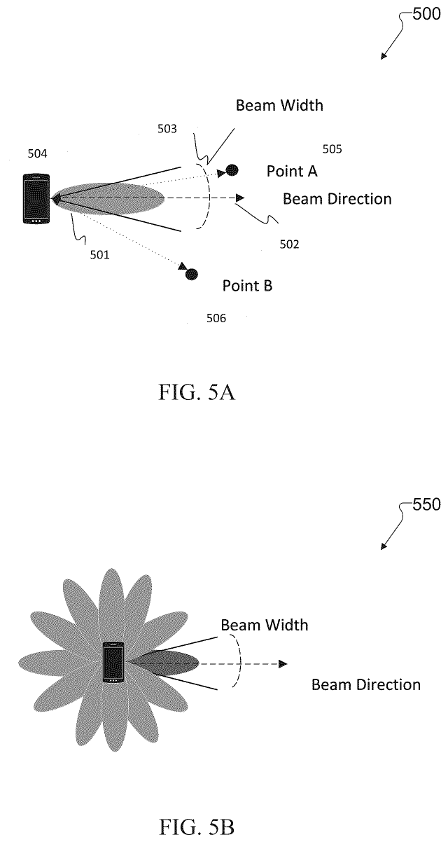

As illustrated in FIG. 5A, in a wireless system 500, a beam 501 for a device 504 can be characterized by a beam direction 502 and a beam width 503. For example, the device 504 (or UE 116) transmits RF energy in a beam direction and within a beam width. The device 504 receives RF energy in a beam direction and within a beam width. As illustrated in FIG. 5A, a device at point A 505 can receive from and transmit to device 504 as Point A is within a beam width and direction of a beam from device 504. As illustrated in FIG. 5A, a device at point B 506 cannot receive from and transmit to device 504 as Point B 506 is outside a beam width and direction of a beam from device 504. While FIG. 5A, for illustrative purposes, shows a beam in 2-dimensions (2D), it should be apparent to those skilled in the art, that a beam can be in 3-dimensions (3D), where the beam direction and beam width are defined in space.

FIG. 5B illustrates an example of a multi-beam operation 550 according to embodiments of the present disclosure. For example, the multi-beam operation 550 can be utilized by UE 116 of FIG. 3. This example is for illustration only and other embodiments can be used without departing from the scope of the present disclosure.

In a wireless system, a device can transmit and/or receive on multiple beams. This is known as “multi-beam operation”. While FIG. 5B, for illustrative purposes, a beam is in 2D, it should be apparent to those skilled in the art, that a beam can be 3D, where a beam can be transmitted to or received from any direction in space.

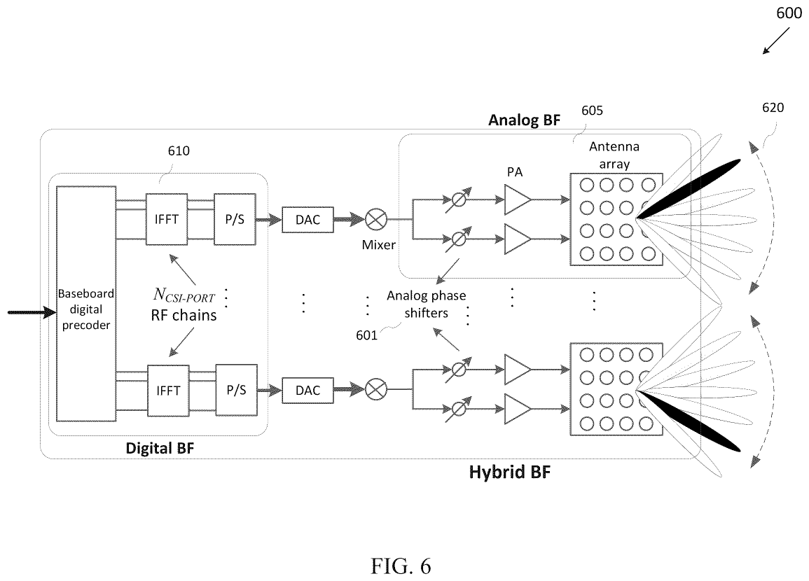

FIG. 6 illustrates an example of a transmitter structure 600 for beamforming according to embodiments of the present disclosure. In certain embodiments, one or more of gNB 102 or UE 116 includes the transmitter structure 600. For example, one or more of antenna 205 and its associated systems or antenna 305 and its associated systems can be included in transmitter structure 600. This example is for illustration only and other embodiments can be used without departing from the scope of the present disclosure.

Accordingly, embodiments of the present disclosure recognize that Rel-14 LTE and Rel-15 NR support up to 32 channel state indication refence signal (CSI-RS)antenna ports which enable an eNB or a gNB to be equipped with a large number of antenna elements (such as 64 or 128). A plurality of antenna elements can then be mapped onto one CSI-RS port. For mmWave bands, although a number of antenna elements can be larger for a given form factor, a number of CSI-RS ports, that can correspond to the number of digitally precoded ports, can be limited due to hardware constraints (such as the feasibility to install a large number of analog-to-digital converters (ADCs)/digital-to-analog converters (DACs) at mmWave frequencies) as illustrated in FIG. 6. Then, one CSI-RS port can be mapped onto a large number of antenna elements that can be controlled by a bank of analog phase shifters 601. One CSI-RS port can then correspond to one sub-array which produces a narrow analog beam through analog beamforming 605. This analog beam can be configured to sweep across a wider range of angles 620 by varying the phase shifter bank across symbols or slots/subframes. The number of sub-arrays (equal to the number of RF chains) is the same as the number of CSI-RS ports NCS-PORT. A digital beamforming unit 610 performs a linear combination across NCS-PORT analog beams to further increase a precoding gain. While analog beams are wideband (hence not frequency-selective), digital precoding can be varied across frequency sub-bands or resource blocks. Receiver operation can be conceived analogously.

Since the transmitter structure 600 of FIG. 6 utilizes multiple analog beams for transmission and reception (wherein one or a small number of analog beams are selected out of a large number, for instance, after a training duration that is occasionally or periodically performed), the term “multi-beam operation” is used to refer to the overall system aspect. This includes, for the purpose of illustration, indicating the assigned DL or UL TX beam (also termed “beam indication”), measuring at least one reference signal for calculating and performing beam reporting (also termed “beam measurement” and “beam reporting”, respectively), and receiving a DL or UL transmission via a selection of a corresponding RX beam. The system of FIG. 6 is also applicable to higher frequency bands such as >52.6 GHz (also termed frequency range 4 or FR4). In this case, the system can employ only analog beams. Due to the O2 absorption loss around 60 GHz frequency (˜10 dB additional loss per 100 m distance), a larger number and narrower analog beams (hence a larger number of radiators in the array) are needed to compensate for the additional path loss.

The text and figures are provided solely as examples to aid the reader in understanding the present disclosure. They are not intended and are not to be construed as limiting the scope of the present disclosure in any manner. Although certain embodiments and examples have been provided, it will be apparent to those skilled in the art based on the disclosures herein that changes in the embodiments and examples shown may be made without departing from the scope of the present disclosure. The transmitter structure 600 for beamforming is for illustration only and other embodiments can be used without departing from the scope of the present disclosure.

Although the figures illustrate different examples of user equipment, various changes may be made to the figures. For example, the user equipment can include any number of each component in any suitable arrangement. In general, the figures do not limit the scope of this disclosure to any particular configuration(s). Moreover, while figures illustrate operational environments in which various user equipment features disclosed in this patent document can be used, these features can be used in any other suitable system.

Any of the above variation embodiments can be utilized independently or in combination with at least one other variation embodiment.

Although the present disclosure has been described with exemplary embodiments, various changes and modifications may be suggested to one skilled in the art. It is intended that the present disclosure encompass such changes and modifications as fall within the scope of the appended claims. None of the descriptions in this application should be read as implying that any particular element, step, or function is an essential element that must be included in the claims scope. The scope of subject matter is defined by the claims.

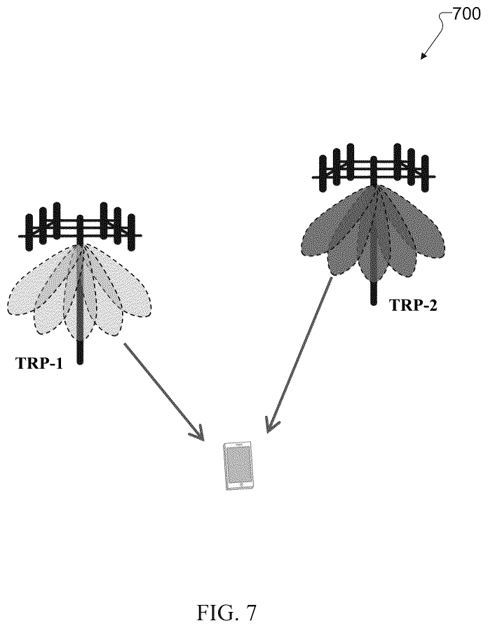

FIG. 7 illustrates an example system 700 for a multi-TRP according to embodiments of the present disclosure. For example, the system 700 may operate within the wireless network 100 in FIG. 1. This example is for illustration only and other embodiments can be used without departing from the scope of the present disclosure.

A UE could simultaneously receive from multiple physically non-co-located TRPs various channels/RSs such as physical downlink control channels (PDCCHs) and/or physical downlink shared channels (PDSCHs) using either a single receive (RX) panel or multiple RX panels. In this disclosure, a RX panel could correspond to a set of RX antenna elements/ports at the UE, a set of measurement RS resources such as sounding reference signal (SRS) resources, a spatial domain RX filter or etc. Furthermore, a TRP in the multi-TRP system can represent a collection of measurement antenna ports, measurement RS resources and/or control resource sets (CORESETs). For example, a TRP could be associated with one or more of:
A plurality of CSI-RS resources
A plurality of CRIs (CSI-RS resource indices/indicators)
A measurement RS resource set, for example, a CSI-RS resource set along with its indicator
A plurality of CORESETs associated with a CORESETPoolIndex
A plurality of CORESETs associated with a TRP-specific index/indicator/identity

A cell/TRP could be a non-serving cell/TRP. In this disclosure, the non-serving cell(s) or the non-serving cell TRP(s) could have/broadcast different physical cell IDs (PCIs) and/or other higher layer signaling index values from that of the serving cell or the serving cell TRP (i.e., the serving cell PCI). In one example, the serving cell or the serving cell TRP could be associated with the serving cell ID (SCI) and/or the serving cell PCI. That is, for the inter-cell operation provided in the present disclosure, different cells/TRPs could broadcast different PCIs and/or one or more cells/TRPs (referred to/defined as non-serving cells/TRPs in the present disclosure) could broadcast different PCIs from that of the serving cell/TRP (i.e., the serving cell PCI) and/or one or more cells/TRPs are not associated with valid SCI (e.g., provided by the higher layer parameter ServCellIndex). In the present disclosure, a non-serving cell PCI can also be referred to as an additional PCI, another PCI, or a different PCI (with respect to the serving cell PCI).

Embodiments of the present disclosure recognizes the need of various design aspects related to TCI state(s) indication/association for/to various channels/signals including periodic and/or semi-persistent CSI-RS(s); in particular, various design methods of applying TCI state(s) indicated in a group common downlink control information (DCI) for a group of UEs for receiving/transmitting various DL/UL channels/signals are provided. The corresponding UE behaviors are also specified in this disclosure.

In various embodiments of this disclosure, a beam is determined by either of:
A TCI state, that establishes a quasi-colocation (QCL) relationship between a source reference signal (e.g. synchronization signal block (SSB) and/or CSI-RS) and a target reference signal
A spatial relation information that establishes an association to a source reference signal, such as SSB or CSI-RS or SRS.

In either case, the ID of the source reference signal identifies the beam.

The TCI state and/or the spatial relation reference RS can determine a spatial Rx filter for reception of downlink channels at the UE, or a spatial TX filter for transmission of uplink channels from the UE.

Embodiments of the present disclosure provide various design aspects related to TCI state(s) indication, update, and application under unified TCI framework for single-TRP (STRP) and/or multi-TRP (MTRP) operation(s).

As specified in Rel-17, a unified TCI framework could indicate/include N≥1 DL TCI states and/or M≥1 UL TCI states, wherein the indicated TCI state could be at least one of:
A DL TCI state and/or its corresponding/associated TCI state ID
An UL TCI state and/or its corresponding/associated TCI state ID
A joint DL and UL TCI state and/or its corresponding/associated TCI state ID
Separate DL TCI state and UL TCI state and/or their corresponding/associated TCI state ID(s)

There could be various design options/channels to indicate to the UE (e.g., the UE 116) a beam (i.e., a TCI state) for the transmission/reception of a PDCCH or a PDSCH. As described in the 3GPP Rel-17:
In one example, a medium access control (MAC) control element (CE) could be used to indicate to the UE a beam (i.e., a TCI state and/or a TCI state ID) for the transmission/reception of a PDCCH or a PDSCH.
In another example, a downlink control information (DCI) could be used to indicate to the UE a beam (i.e., a TCI state and/or a TCI state ID) for the transmission/reception of a PDCCH or a PDSCH.
   For example, a DL related DCI (e.g., DCI format 10, DCI format 1_1 or DCI format 1_2) could be used to indicate to the UE a beam (i.e., a TCI state and/or a TCI state ID) for the transmission/reception of a PDCCH or a PDSCH, wherein the DL related DCI may or may not include a DL assignment.
   For another example, an UL related DCI (e.g., DCI format 00, DCI format 0_1, DCI format 0_2) could be used to indicate to the UE a beam (i.e., a TCI state and/or a TCI state ID) for the transmission/reception of a PDCCH or a PDSCH, wherein the UL related DCI may or may not include an UL scheduling grant.
   Yet for another example, a custom/purpose designed DCI format could be used to indicate to the UE a beam (i.e., a TCI state and/or a TCI state ID) for the transmission/reception of a PDCCH or a PDSCH.

Rel-17 introduced the unified TCI framework, where a unified or master or main TCI state is signaled to the UE. The unified or master or main TCI state can be one of:
In case of joint TCI state indication, wherein a same beam is used for DL and UL channels, a joint TCI state that can be used at least for UE-dedicated DL channels and UE-dedicated UL channels.
In case of separate TCI state indication, wherein different beams are used for DL and UL channels, a DL TCI state can be used at least for UE-dedicated DL channels.
In case of separate TCI state indication, wherein different beams are used for DL and UL channels, a UL TCI state can be used at least for UE-dedicated UL channels.

The unified (master or main) TCI state is TCI state of UE-dedicated reception on PDSCH/PDCCH or dynamic-grant/configured-grant based physical uplink shared channel (PUSCH) and dedicated physical uplink control channel (PUCCH) resources.

In a single-TRP system, a UE could be indicated/provided/configured by the network, e.g., via a beam indication MAC CE or a DCI (e.g., via one or more TCI codepoints of one or more TCI fields in the corresponding DCI 1_1/1_2 with or without DL assignment), a TCI state/pair of TCI states for at least UE-dedicated reception on PDSCH/PDCCH or dynamic-grant/configured-grant based PUSCH or dedicated PUCCH resources, wherein a TCI state could be a joint DL and UL TCI state or a separate DL TCI state provided by TCI-State/DLorJointTCI-State, or a separate UL TCI state provided by TCI-State/UL-TCIState, and a pair of TCI states could include/contain a separate DL TCI state provided by TCI-State/DLorJointTCI-State or a separate UL TCI State provided by TCI-State/UL-TCIState, under the unified TCI framework.

In a (single-DCI based) multi-TRP system, a UE could be indicated/provided/configured by the network, e.g., via a beam indication MAC CE or a DCI (e.g., via one or more TCI codepoints of one or more TCI fields in the corresponding DCI 1_1/1_2 with or without DL assignment), a set of one or more (e.g., N≥1) TCI states/pairs of TCI states for at least UE-dedicated reception on PDSCH/PDCCH or dynamic-grant/configured-grant based PUSCH dedicated PUCCH resources, wherein a TCI state could be a joint DL and UL TCI state or a separate DL TCI state provided by TCI-State/DLorJointTCI-State, or a separate UL TCI state provided by TCI-State/UL-TCIState, and a pair of TCI states could include/contain a separate DL TCI state provided by TCI-State/DLorJointTCI-State or a separate UL TCI State provided by TCI-State/UL-TCIState, under the unified TCI framework.

For PDCCH reception or PDCCH candidate monitoring in a (single-DCI based) multi-TRP system, a UE could be configured/provided/indicated by the network (e.g., the network 130) via higher layer RRC signaling/parameter and/or MAC CE command and/or dynamic DCI based L1 signaling—e.g., in higher layer RRC signaling/parameter ControlResourceSet that configures a CORESET—a first indicator to indicate which one or more of the set of TCI states/pairs of TCI states indicated, e.g., by a TCI codepoint, in a beam indication DCI or MAC CE as specified herein in the present disclosure, to use/apply for receiving/monitoring the PDCCH(s)/PDCCH candidate(s) in the corresponding CORESET. For instance, for N=2 (i.e., a set of two TCI states/pairs of TCI states are indicated), the first indicator could be a two-bit indicator with ‘00’ indicating that the first TCI state(s) among the set of TCI states/pairs of TCI states indicated, e.g., by a TCI codepoint, in a beam indication DCI or MAC CE as specified herein in the present disclosure, could be used/applied for receiving/monitoring the PDCCH(s)/PDCCH candidate(s) in the corresponding CORESET, ‘01’ indicating that the second TCI state(s) among the set of TCI states/pairs of TCI states indicated, e.g., by a TCI codepoint, in a beam indication DCI or MAC CE as specified herein in the present disclosure, could be used/applied for receiving/monitoring the PDCCH(s)/PDCCH candidate(s) in the corresponding CORESET, ‘10’ indicating that the first and second TCI states among the set of TCI states/pairs of TCI states indicated, e.g., by a TCI codepoint, in a beam indication DCI or MAC CE as specified herein in the present disclosure, could be respectively used/applied for receiving/monitoring the PDCCH(s)/PDCCH candidate(s)—e.g., first and second PDCCH candidates—in the corresponding CORESET(s), and ‘11’ indicating that the second and first TCI states among the set of TCI states/pairs of TCI states indicated, e.g., by a TCI codepoint, in a beam indication DCI or MAC CE as specified herein in the present disclosure, or none of the indicated TCI states, could be (respectively) used/applied for receiving/monitoring the PDCCH(s)/PDCCH candidate(s)—e.g., first and second PDCCH candidates—in the corresponding CORESET(s), wherein the first and second PDCCH candidates could be received in search space sets that are higher layer linked via SearchSpaceLinking and/or the first and second PDCCH candidates carry the same/identical DCI payload. Furthermore, throughout the present disclosure, the first TCI state(s) or the second TCI state(s)—specified herein in the present disclosure—could correspond to a joint DL and UL TCI state provided by TCI-State/DLorJointTCI-State, a separate DL TCI state provided by TCI-State/DLorJointTCI-State, a separate UL TCI state provided by TCI-State/UL-TCIState, or a pair of separate DL and separate UL TCI states.

For PDSCH reception in a (single-DCI based) multi-TRP system, a UE could be configured/provided/indicated by the network via higher layer RRC signaling/parameter and/or MAC CE command and/or dynamic DCI based L1 signaling—e.g., in a DL DCI (e.g., DCI format 1_0/1_1/1_2) that schedules the PDSCH—a second indicator to indicate which one or more of the set of TCI states/pairs of TCI states indicated, e.g., by a TCI codepoint, in a beam indication DCI or MAC CE as specified herein in the present disclosure, to use/apply for receiving the PDSCH(s). For instance, for N=2 (i.e., a set of two TCI states/pairs of TCI states are indicated), the second indicator could be a two-bit indicator with ‘00’ indicating that the first TCI state(s) among the set of TCI states/pairs of TCI states indicated, e.g., by a TCI codepoint, in a beam indication DCI or MAC CE as specified herein in the present disclosure, could be used/applied for receiving the corresponding PDSCH(s)—e.g., scheduled by the DL DCI/PDCCH, ‘01’ indicates that the second TCI state(s) among the set of TCI states/pairs of TCI states indicated, e.g., by a TCI codepoint, in a beam indication DCI or MAC CE as specified herein in the present disclosure, could be used/applied for receiving the corresponding PDSCH(s)—e.g., scheduled by the DL DCI/PDCCH. ‘10’ indicates that the first and second TCI states among the set of TCI states/pairs of TCI states indicated, e.g., by a TCI codepoint, in a beam indication DCI or MAC CE as specified herein in the present disclosure, could be respectively used/applied for receiving the corresponding PDSCH(s)—e.g., first and second PDSCHs—e.g., scheduled by the DL DCI/PDCCH. ‘11’ indicates that the second and first TCI states among the set of TCI states/pairs of TCI states indicated, e.g., by a TCI codepoint, in a beam indication DCI or MAC CE as specified herein in the present disclosure, could be respectively used/applied for receiving the corresponding PDSCH(s)—e.g., first and second PDSCHs—e.g., scheduled by the DL DCI/PDCCH, wherein the first and second PDSCHs could correspond to two PDSCH transmission occasions or repetition in space, time and/or frequency. Furthermore, throughout the present disclosure, the first TCI state(s) or the second TCI state(s)—specified herein in the present disclosure— could correspond to a joint DL and UL TCI state provided by TCI-State/DLorJointTCI-State, a separate DL TCI state provided by TCI-State/DLorJointTCI-State, a separate UL TCI state provided by TCI-State/UL-TCIState, or a pair of separate DL and separate UL TCI states.

For PUCCH transmission in a (single-DCI based) multi-TRP system, a UE could be configured/provided/indicated by the network via higher layer RRC signaling/parameter and/or MAC CE command and/or dynamic DCI based L1 signaling—e.g., in higher layer RRC signaling/parameter PUCCH-Config that configures PUCCH(s)/PUCCH resource(s)—a third indicator to indicate which one or more of the set of TCI states/pairs of TCI states indicated, e.g., by a TCI codepoint, in a beam indication DCI or MAC CE as specified herein in the present disclosure, to use/apply for transmitting the PUCCH(s)/PUCCH resource(s). For instance, for N=2 (i.e., a set of two TCI states/pairs of TCI states are indicated), the third indicator could be a two-bit indicator with ‘00’ indicating that the first TCI state(s) among the set of TCI states/pairs of TCI states indicated, e.g., by a TCI codepoint, in a beam indication DCI or MAC CE as specified herein in the present disclosure, could be used/applied for transmitting the PUCCH(s)/PUCCH resource(s). ‘01’ indicates that the second TCI state(s) among the set of TCI states/pairs of TCI states indicated, e.g., by a TCI codepoint, in a beam indication DCI or MAC CE as specified herein in the present disclosure, could be used/applied for transmitting the PUCCH(s)/PUCCH resource(s). ‘10’ indicates that the first and second TCI states among the set of TCI states/pairs of TCI states indicated, e.g., by a TCI codepoint, in a beam indication DCI or MAC CE as specified herein in the present disclosure, could be respectively used/applied for transmitting the PUCCH(s)/PUCCH resource(s)—e.g., first PUCCH/PUCCH resource and second PUCCH/PUCCH resource. ‘11’ indicates that the second and first TCI states among the set of TCI states/pairs of TCI states indicated, e.g., by a TCI codepoint, in a beam indication DCI or MAC CE as specified herein in the present disclosure, or none of the indicated TCI states, could be (respectively) used/applied for transmitting the PUCCH(s)/PUCCH resource(s)—e.g., first PUCCH/PUCCH resource and second PUCCH/PUCCH resource, wherein the first and second PUCCHs/PUCCH resources could correspond to two PUCCH transmission occasions or repetitions in space, time and/or frequency. Furthermore, throughout the present disclosure, the first TCI state(s) or the second TCI state(s)—specified herein in the present disclosure— could correspond to a joint DL and UL TCI state provided by TCI-State/DLorJointTCI-State, a separate DL TCI state provided by TCI-State/DLorJointTCI-State, a separate UL TCI state provided by TCI-State/UL-TCIState, or a pair of separate DL and separate UL TCI states.

For PUSCH transmission in a (single-DCI based) multi-TRP system, a UE could be configured/provided/indicated by the network via higher layer RRC signaling/parameter and/or MAC CE command and/or dynamic DCI based L1 signaling—e.g., in an UL DCI (e.g., DCI format 0_0/0_1/0_2) that schedules the PUSCH—a fourth indicator to indicate which one or more of the set of TCI states/pairs of TCI states indicated, e.g., by a TCI codepoint, in a beam indication DCI or MAC CE as specified herein in the present disclosure, to use/apply for transmitting the PUSCH(s). For instance, for N=2 (i.e., a set of two TCI states/pairs of TCI states are indicated), the fourth indicator could be a two-bit indicator with ‘00’ indicating that the first TCI state(s) among the set of TCI states/pairs of TCI states indicated, e.g., by a TCI codepoint, in a beam indication DCI or MAC CE as specified herein in the present disclosure, could be used/applied for transmitting the corresponding PUSCH(s)—e.g., scheduled by the UL DCI/PDCCH. ‘01’ indicates that the second TCI state(s) among the set of TCI states/pairs of TCI states indicated, e.g., by a TCI codepoint, in a beam indication DCI or MAC CE as specified herein in the present disclosure, could be used/applied for transmitting the corresponding PUSCH(s)—e.g., scheduled by the UL DCI/PDCCH. ‘10’ indicates that the first and second TCI states among the set of TCI states/pairs of TCI states indicated, e.g., by a TCI codepoint, in a beam indication DCI or MAC CE as specified herein in the present disclosure, could be respectively used/applied for transmitting the corresponding PUSCH(s)—e.g., first and second PUSCHs—e.g., scheduled by the UL DCI/PDCCH. ‘11’ indicates that the second and first TCI states among the set of TCI states/pairs of TCI states indicated, e.g., by a TCI codepoint, in a beam indication DCI or MAC CE as specified herein in the present disclosure, could be respectively used/applied for transmitting the corresponding PUSCH(s)—e.g., first and second PUSCHs—e.g., scheduled by the UL DCI/PDCCH, wherein the first and second PUSCHs could correspond to two PUSCH transmission occasions or repetition in space, time and/or frequency. Furthermore, throughout the present disclosure, the first TCI state(s) or the second TCI state(s)—specified herein in the present disclosure—could correspond to a joint DL and UL TCI state provided by TCI-State/DLorJointTCI-State, a separate DL TCI state provided by TCI-State/DLorJointTCI-State, a separate UL TCI state provided by TCI-State/UL-TCIState, or a pair of separate DL and separate UL TCI states.

In a (multi-DCI based) multi-TRP system, a UE could be indicated/provided/configured by the network, e.g., in PDCCH-Config, two values (i.e., 0 and 1) of CORESET pool index (denoted by CORESETPoolIndex), wherein each CORESET could be configured with a value of CORESETPoolIndex. Furthermore, a UE could be indicated/provided/configured by the network, e.g., via a beam indication MAC CE or a DCI (e.g., via one or more TCI codepoints of one or more TCI fields in the corresponding DCI format 1_1/1_2 with or without DL assignment) associated to a CORESET pool index value (e.g., 0 or 1), one or more TCI states/pairs of TCI states for the same (or different) CORESET pool index value, wherein a TCI state could be a joint DL and UL TCI state or a separate DL TCI state provided by TCI-State/DLorJointTCI-State or a separate UL TCI state provided by TCI-State/UL-TCIState indicated for or to transmit/receive channels/signals such as PDCCH, PDSCH, PUCCH and PUSCH associated to the same (or different) CORESET pool index value. A pair of TCI states could include/contain a separate DL TCI state provided by TCI-State/DLorJointTCI-State or a separate UL TCI State provided by TCI-State/UL-TCIState indicated for or to transmit/receive channels/signals such as PDCCH, PDSCH, PUCCH and PUSCH associated to the same (or different) CORESET pool index value, under the unified TCI framework.

A DCI (format) could be used to notify/indicate a group of UEs of the TCI state(s) to use at least for receiving DL channels/signals including PDCCH, PDSCH and/or P/SP/AP CSI-RS(s) and/or transmitting UL channels/signals including PUCCH, PUSCH and/or P/SP/AP SRS(s). The DCI format used to notify/indicate a group of UEs of the TCI state(s) to use could be one or more of the existing DCI formats for UE group common signaling such as DCI format 20, 21, 2_2, 2_3 and 2_4. Alternatively, the DCI format used to notify/indicate a group of UEs of the TCI state(s) to use could be a new/dedicated DCI format.

The DCI format used to notify/indicate a group of UEs of the TCI state(s) to use at least for receiving DL channels/signals including PDCCH, PDSCH and/or P/SP/AP CSI-RS(s) and/or transmitting UL channels/signals including PUCCH, PUSCH and/or P/SP/AP SRS(s)—denoted by group common DCI (format) for TCI state(s) indication— could be with cyclic redundancy check (CRC) scrambled by TCI-RNTI. One or more of the following information could be transmitted by means of the group common DCI format for TCI state(s) indication with CRC scrambled with TCI-radio network temporary identifier (RNTI).

N TCI fields or TCI field indications, e.g., denoted by TCI field/TCI field indication 1, TCI field/TCI field indication 2, . . . , TCI field/TCI field indication N, wherein each of the TCI fields/TCI field indications could be for a UE when/if, e.g., the UE is provided/configured by the network a/the higher layer parameter mtci-separateGroup (set to ‘enabled’). As specified herein in the present disclosure, the group common DCI format for TCI state(s) indication could correspond to one or more of the existing DCI formats for UE group common signaling. For this case, the N TCI fields/TCI field indications could correspond to new/dedicated DCI fields/DCI field indications in one or more of the existing DCI formats for UE group common signaling. Alternatively, the N TCI fields/TCI field indications could be realized by repurposing one or more bits/codepoints of one or more existing DCI fields/DCI field indications in one or more of the existing DCI formats for UE group common signaling. For instance, when/if the UE is provided/configured with a/the higher layer signaling mtci-separateGroup (set to ‘enabled’):
When/if the group common DCI format for TCI state(s) indication corresponds to DCI format 2_0, the N TCI fields/TCI field indications TCI field/TCI field indication 1, TCI field/TCI field indication 2, . . . , TCI field/TCI field indication N could respectively correspond to (i.e., via repurposing) one or more bits of one or more of the existing DCI fields Slot format indicator 1, Slot format indicator 2, . . . , Slot format indicator N (when/if the higher layer parameter slotFormatCombToAddModList is configured), and/or Available resource block (RB) set Indicator 1, Available RB set Indicator 2, . . . , Available RB set Indicator N1 (when/if the higher layer parameter availableRB-SetsToAddModList is configured), and/or COT duration indicator 1, COT duration indicator 2, . . . , COT duration indicator N2 (when/if the higher layer parameter co-DurationsPerCellToAddModList is configured), and/or Search space set group switching flag 1, Search space set group switching flag 2, . . . , Search space set group switching flag M (when/if the higher layer parameter switch TriggerToAddModList is configured).
When/if the group common DCI format for TCI state(s) indication corresponds to DCI format 2_1, the N TCI fields/TCI field indications TCI field/TCI field indication 1, TCI field/TCI field indication 2, . . . , TCI field/TCI field indication N could respectively correspond to (i.e., via repurposing) one or more bits of one or more of the existing DCI fields Pre-emption indication 1, Pre-emption indication 2, . . . , Pre-emption indication N.
When/if the group common DCI format for TCI state(s) indication corresponds to DCI format 2_2, the N TCI fields/TCI field indications TCI field/TCI field indication 1, TCI field/TCI field indication 2, . . . , TCI field/TCI field indication N could respectively correspond to (i.e., via repurposing) one or more bits of one or more of the existing DCI fields block number 1, block number 2, . . . , block number N, and/or closed loop indicator (0 or 1 bit), and/or TPC command (2 bits).
When/if the group common DCI format for TCI state(s) indication corresponds to DCI format 2_3, the NTCI fields/TCI field indications TCI field/TCI field indication 1, TCI field/TCI field indication 2, . . . , TCI field/TCI field indication N could respectively correspond to (i.e., via repurposing) one or more bits of one or more of the existing DCI fields block number 1, block number 2, . . . , block number B where the starting position of a block is determined by the parameter startingBitOfFormat2-3 or startingBitOfFormat2-3SUL-v0530 provided by higher layers for the UE configured with the block, and/or SRS request field(s) and/or TPC command number 1, TPC command number 2, . . . , TPC command number N (where each TPC command applies to a respective UL carrier provided by higher layer parameter cc-IndexInOneCC-Set) for one or more blocks configured/provided for the UE by higher layers if the UE is configured with higher layer parameter srs-TPC-PDCCH-Group=typeA for an UL without PUCCH and PUSCH or an UL on which the SRS power control is not tied with PUSCH power control, and/or SRS request field(s) and/or TPC command field(s) for one or more blocks configured/provided for the UE by higher layers where each block applies to an UL carrier if the UE is configured with higher layer parameter srs-TPC-PDCCH-Group=typeB for an UL without PUCCH and PUSCH or an UL on which the SRS power control is not tied with PUSCH power control.
When/if the group common DCI format for TCI state(s) indication corresponds to DCI format 2_4, the N TCI fields/TCI field indications TCI field/TCI field indication 1, TCI field/TCI field indication 2, . . . , TCI field/TCI field indication N could respectively correspond to (i.e., via repurposing) one or more bits of one or more of the existing DCI fields Availability indicator 1, Availability indicator 2, . . . , Availability indicator N.

The UE could be indicated/configured/provided by the network, e.g., via higher layer RRC signaling(s)/parameter(s) and/or MAC CE command(s) and/or dynamic DCI based L1 signaling, whether the group common DCI format for TCI state(s) indication could correspond to DCI format 20, DCI format 21, DCI format 2_2, DCI format 2_3 and/or DCI format 2_4 according to those specified herein in the present disclosure. Optionally, the UE could determine/identify, e.g., based on/according to one or more conditions, whether the group common DCI format for TCI state(s) indication could correspond to DCI format 2_0, DCI format 2_1, DCI format 2_2, DCI format 2_3 and/or DCI format 2_4 according to those specified herein in the present disclosure, wherein the one or more conditions could comprise (at least) payload size of the group common DCI format for TCI state(s) indication and/or their relation(s) to a threshold and/or their relation(s) to payload size(s) of DCI format 2_0, DCI format 2_1, DCI format 2_2, DCI format 2_3 and/or DCI format 2_4; the value of the threshold could be: (i) provided/indicated/configured by the network, e.g., via higher layer RRC signaling(s)/parameter(s) and/or MAC CE command(s) and/or dynamic DCI based L1 signaling(s), (ii) fixed value(s) in system specification(s), and/or (iii) autonomously determined by the UE, and/or reported to the network, e.g., in part of a CSI/beam report and/or via UE capability signaling(s). As specified herein in the present disclosure, the group common DCI format for TCI state(s) indication could correspond to a new/dedicated DCI format for UE group common signaling—denoted by DCI format 2_x. For this case, the N TCI fields/TCI field indications could correspond to new/dedicated DCI fields/DCI field indications in the DCI format 2_x for UE group common signaling. Furthermore, the size of the dedicated group common DCI format 2_x for TCI state(s) indication as specified herein the present disclosure could be configurable by higher layers up to a number of bits (e.g., up to 126 bits or up to 128 bits); alternatively, the number of information bits in the dedicated group common DCI format 2_x for TCI state(s) indication as specified herein in the present disclosure could be equal to or less than the payload size of format 1_0 monitored in common search space in the same serving cell; in this case, if the number of information bits in the dedicated group common DCI format 2_x for TCI state(s) indication is less than the payload size of format 1_0 monitored in common search space in the same serving cell, zeros shall be appended to the dedicated group common DCI format 2_x for TCI state(s) indication until the payload size equals that of format 1_0 monitored in common search space in the same serving cell.

The UE could receive an activation command, e.g., a (unified) TCI state(s) activation/deactivation MAC CE command, used to map up to M (e.g., 8) TCI states and/or pairs of TCI states, with one TCI state for DL channels/signals and/or one TCI state for UL channels/signals to the codepoints of a TCI field/TCI field indication in the group common DCI format for TCI state(s) indication as specified herein in the present disclosure for one or for a set of CCs/DL BWPs, and/or up to M (e.g., 8) pairs of TCI states or sets of TCI states, where each set is comprised of one or two TCI state(s) for DL channels/signals and/or one or two TCI state(s) for UL channels/signals to the codepoints of a TCI field/TCI field indication in the group common DCI format for TCI state(s) indication as specified herein in the present disclosure for one or for a set of CCs/DL BWPs and, if applicable, for one or for a set of CCs/UL BWPs, wherein the TCI field/TCI field indication could correspond to one or more of the TCI field/TCI field indication 1, TCI field/TCI field indication 2, . . . , TCI field/TCI field indication N in the group common DCI format for TCI state(s) indication as specified herein in the present disclosure. For this case:
When/if up to M (e.g., 8) pairs of TCI states or sets of TCI states, where each set is comprised of one or two TCI state(s) for DL channels/signals and/or one or two TCI state(s) for UL channels/signals to the codepoints of a TCI field/TCI field indication in the group common DCI format for TCI state(s) indication as specified herein in the present disclosure for one or for a set of CCs/DL BWPs and, if applicable, for one or for a set of CCs/UL BWPs, when/if provided/indicated by/in the group common DCI for TCI state(s) indication (or group common beam indication DCI), each or one or more of the TCI field/TCI field indication 1, TCI field/TCI field indication 2, . . . , TCI field/TCI field indication N could comprise/provide/indicate one or more TCI states/pairs of TCI states corresponding to/referring to as first (indicated) TCI state(s), and/or second (indicated) TCI state(s), and/or so on for the corresponding UE.
When/if up to M (e.g., 8) TCI states and/or pairs of TCI states, with one TCI state for DL channels/signals and/or one TCI state for UL channels/signals to the codepoints of a TCI field/TCI field indication in the group common DCI format for TCI state(s) indication as specified herein in the present disclosure for one or for a set of CCs/DL BWPs, and/or when/if up to M (e.g., 8) pairs of TCI states or sets of TCI states, where each set is comprised of one or two TCI state(s) for DL channels/signals and/or one or two TCI state(s) for UL channels/signals to the codepoints of a TCI field/TCI field indication in the group common DCI format for TCI state(s) indication as specified herein in the present disclosure for one or for a set of CCs/DL BWPs and, if applicable, for one or for a set of CCs/UL BWPs, when/if provided/indicated by/in the group common DCI for TCI state(s) indication (or group common beam indication DCI), the TCI state(s)/pair(s) of TCI states provided/indicated in the TCI field/TCI field indication 1 could correspond to or could be referred to as first (indicated) TCI state(s), the TCI state(s)/pair(s) of TCI states provided/indicated in the TCI field/TCI field indication 2 could correspond to or could be referred to as second (indicated) TCI state(s), and so on. The TCI state(s)/pair(s) of TCI states provided/indicated in the TCI field/TCI field indication N could correspond to or could be referred to as N-th (indicated) TCI state(s).

N TCI fields or TCI field indications, e.g., denoted by TCI field/TCI field indication 1, TCI field/TCI field indication 2, . . . , TCI field/TCI field indication N, wherein each of the TCI fields/TCI field indications could be for a group of UEs when/if, e.g., each of the UEs in the group is provided/configured by the network a/the higher layer parameter mtci-jointGroup (set to ‘enabled’). As specified herein in the present disclosure, the group common DCI format for TCI state(s) indication could correspond to one or more of the existing DCI formats for UE group common signaling. For this case, the N TCI fields/TCI field indications could correspond to new/dedicated DCI fields/DCI field indications in one or more of the existing DCI formats for UE group common signaling. Alternatively, the N TCI fields/TCI field indications could be realized by repurposing one or more bits/codepoints of one or more existing DCI fields/DCI field indications in one or more of the existing DCI formats for UE group common signaling. For instance, when/if the UE is provided/configured with a/the higher layer signaling mtci-jointGroup (set to ‘enabled’):
When/if the group common DCI format for TCI state(s) indication corresponds to DCI format 2_0, the N TCI fields/TCI field indications TCI field/TCI field indication 1, TCI field/TCI field indication 2, . . . , TCI field/TCI field indication N could respectively correspond to (i.e., via repurposing) one or more bits of one or more of the existing DCI fields Slot format indicator 1, Slot format indicator 2, . . . , Slot format indicator N (when/if the higher layer parameter slotFormatCombToAddModList is configured), and/or Available RB set Indicator 1, Available RB set Indicator 2, . . . , Available RB set Indicator N1 (when/if the higher layer parameter availableRB-SetsToAddModList is configured), and/or COT duration indicator 1, COT duration indicator 2, . . . , COT duration indicator N2 (when/if the higher layer parameter co-DurationsPerCellToAddModList is configured), and/or Search space set group switching flag 1, Search space set group switching flag 2, . . . , Search space set group switching flag M (when/if the higher layer parameter switch TriggerToAddModList is configured).
When/if the group common DCI format for TCI state(s) indication corresponds to DCI format 2_1, the N TCI fields/TCI field indications TCI field/TCI field indication 1, TCI field/TCI field indication 2, . . . , TCI field/TCI field indication N could respectively correspond to (i.e., via repurposing) one or more bits of one or more of the existing DCI fields Pre-emption indication 1, Pre-emption indication 2, . . . , Pre-emption indication N.
When/if the group common DCI format for TCI state(s) indication corresponds to DCI format 2_2, the N TCI fields/TCI field indications TCI field/TCI field indication 1, TCI field/TCI field indication 2, . . . , TCI field/TCI field indication N could respectively correspond to (i.e., via repurposing) one or more bits of one or more of the existing DCI fields block number 1, block number 2, . . . , block number N, and/or closed loop indicator (0 or 1 bit), and/or TPC command (2 bits).
When/if the group common DCI format for TCI state(s) indication corresponds to DCI format 2_3, the N TCI fields/TCI field indications TCI field/TCI field indication 1, TCI field/TCI field indication 2, . . . , TCI field/TCI field indication N could respectively correspond to (i.e., via repurposing) one or more bits of one or more of the existing DCI fields block number 1, block number 2, . . . , block number B where the starting position of a block is determined by the parameter startingBitOfFormat2-3 or startingBitOfFormat2-3SUL-v0530 provided by higher layers for the UE configured with the block, and/or SRS request field(s) and/or TPC command number 1, TPC command number 2, . . . , TPC command number N (where each TPC command applies to a respective UL carrier provided by higher layer parameter cc-IndexInOneCC-Set) for one or more blocks configured/provided for the UE by higher layers if the UE is configured with higher layer parameter srs-TPC-PDCCH-Group=typeA for an UL without PUCCH and PUSCH or an UL on which the SRS power control is not tied with PUSCH power control, and/or SRS request field(s) and/or TPC command field(s) for one or more blocks configured/provided for the UE by higher layers where each block applies to an UL carrier if the UE is configured with higher layer parameter srs-TPC-PDCCH-Group=typeB for an UL without PUCCH and PUSCH or an UL on which the SRS power control is not tied with PUSCH power control.
When/if the group common DCI format for TCI state(s) indication corresponds to DCI format 2_4, the N TCI fields/TCI field indications TCI field/TCI field indication 1, TCI field/TCI field indication 2, . . . , TCI field/TCI field indication N could respectively correspond to (i.e., via repurposing) one or more bits of one or more of the existing DCI fields Availability indicator 1, Availability indicator 2, . . . , Availability indicator N.

The UE could be indicated/configured/provided by the network, e.g., via higher layer RRC signaling(s)/parameter(s) and/or MAC CE command(s) and/or dynamic DCI based L1 signaling, whether the group common DCI format for TCI state(s) indication could correspond to DCI format 2_0, DCI format 2_1, DCI format 2_2, DCI format 2_3 and/or DCI format 2_4 according to those specified herein in the present disclosure. Optionally, the UE could determine/identify, e.g., based on/according to one or more conditions, whether the group common DCI format for TCI state(s) indication could correspond to DCI format 2_0, DCI format 2_1, DCI format 2_2, DCI format 2_3 and/or DCI format 2_4 according to those specified herein in the present disclosure, wherein the one or more conditions could comprise (at least) payload size of the group common DCI format for TCI state(s) indication and/or their relation(s) to a threshold and/or their relation(s) to payload size(s) of DCI format 2_0, DCI format 21, DCI format 2_2, DCI format 2_3 and/or DCI format 2_4; the value of the threshold could be: (i) provided/indicated/configured by the network, e.g., via higher layer RRC signaling(s)/parameter(s) and/or MAC CE command(s) and/or dynamic DCI based L1 signaling(s), (ii) fixed value(s) in system specification(s), and/or (iii) autonomously determined by the UE, and/or reported to the network, e.g., in part of a CSI/beam report and/or via UE capability signaling(s). As specified herein in the present disclosure, the group common DCI format for TCI state(s) indication could correspond to a new/dedicated DCI format for UE group common signaling—denoted by DCI format 2_x. For this case, the N TCI fields/TCI field indications could correspond to new/dedicated DCI fields/DCI field indications in the DCI format 2_x for UE group common signaling. Furthermore, the size of the dedicated group common DCI format 2_x for TCI state(s) indication as specified herein the present disclosure could be configurable by higher layers up to a number of bits (e.g., up to 126 bits or up to 128 bits); alternatively, the number of information bits in the dedicated group common DCI format 2_x for TCI state(s) indication as specified herein in the present disclosure could be equal to or less than the payload size of format 1_0 monitored in common search space in the same serving cell; in this case, if the number of information bits in the dedicated group common DCI format 2_x for TCI state(s) indication is less than the payload size of format 1_0 monitored in common search space in the same serving cell, zeros shall be appended to the dedicated group common DCI format 2_x for TCI state(s) indication until the payload size equals that of format 1_0 monitored in common search space in the same serving cell.

The UE could receive an activation command, e.g., a (unified) TCI state(s) activation/deactivation MAC CE command, used to map up to M (e.g., 8) TCI states and/or pairs of TCI states, with one TCI state for DL channels/signals and/or one TCI state for UL channels/signals to the codepoints of a TCI field/TCI field indication in the group common DCI format for TCI state(s) indication as specified herein in the present disclosure for one or for a set of CCs/DL BWPs, and/or up to M (e.g., 8) pairs of TCI states or sets of TCI states, where each set is comprised of one or two TCI state(s) for DL channels/signals and/or one or two TCI state(s) for UL channels/signals to the codepoints of a TCI field/TCI field indication in the group common DCI format for TCI state(s) indication as specified herein in the present disclosure for one or for a set of CCs/DL BWPs and, if applicable, for one or for a set of CCs/UL BWPs, wherein the TCI field/TCI field indication could correspond to one or more of the TCI field/TCI field indication 1, TCI field/TCI field indication 2, . . . , TCI field/TCI field indication N in the group common DCI format for TCI state(s) indication as specified herein in the present disclosure. For this case, when/if provided/indicated by/in the group common DCI for TCI state(s) indication (or group common beam indication DCI), the TCI state(s)/pair(s) of TCI states provided/indicated in the TCI field/TCI field indication 1 could correspond to or could be referred to as first (indicated) TCI state(s), the TCI state(s)/pair(s) of TCI states provided/indicated in the TCI field/TCI field indication 2 could correspond to or could be referred to as second (indicated) TCI state(s), and so on, and the TCI state(s)/pair(s) of TCI states provided/indicated in the TCI field/TCI field indication N could correspond to or could be referred to as N-th (indicated) TCI state(s), e.g., for a/the corresponding group of UEs.

A single TCI field or TCI field indication, e.g., denoted by group common TCI field/TCI field indication, for a group of UEs when/if, e.g., each of the UEs in the group is provided/configured by the network (e.g., the network 130) a/the higher layer parameter stci-jointGroup (set to ‘enabled’). As specified herein in the present disclosure, the group common DCI format for TCI state(s) indication could correspond to one or more of the existing DCI formats for UE group common signaling. For this case, group common TCI field/TCI field indication could correspond to a new/dedicated DCI field/DCI field indication in one or more of the existing DCI formats for UE group common signaling. Alternatively, the group common TCI field/TCI field indication could be realized by repurposing one or more bits/codepoints of one or more existing DCI fields/DCI field indications in one or more of the existing DCI formats for UE group common signaling. For instance, when/if the UE is provided/configured with a/the higher layer signaling stci-jointGroup (set to ‘enabled’):
When/if the group common DCI format for TCI state(s) indication corresponds to DCI format 2_0, the group common TCI field/TCI field indication could correspond to (i.e., via repurposing) one or more bits of one or more of the existing DCI fields Slot format indicator 1, Slot format indicator 2, . . . , Slot format indicator N (when/if the higher layer parameter slotFormatCombToAddModList is configured), and/or Available RB set Indicator 1, Available RB set Indicator 2, . . . , Available RB set Indicator N1 (when/if the higher layer parameter availableRB-SetsToAddModList is configured), and/or COT duration indicator 1, COT duration indicator 2, . . . , COT duration indicator N2 (when/if the higher layer parameter co-DurationsPerCellToAddModList is configured), and/or Search space set group switching flag 1, Search space set group switching flag 2, . . . , Search space set group switching flag M (when/if the higher layer parameter switch TriggerToAddModList is configured).
When/if the group common DCI format for TCI state(s) indication corresponds to DCI format 2_1, the group common TCI field/TCI field indication could correspond to (i.e., via repurposing) one or more bits of one or more of the existing DCI fields Pre-emption indication 1, Pre-emption indication 2, . . . , Pre-emption indication N.
When/if the group common DCI format for TCI state(s) indication corresponds to DCI format 2_2, the group common TCI field/TCI field indication could correspond to (i.e., via repurposing) one or more bits of one or more of the existing DCI fields block number 1, block number 2, . . . , block number N, and/or closed loop indicator (0 or 1 bit), and/or TPC command (2 bits).
When/if the group common DCI format for TCI state(s) indication corresponds to DCI format 2_3, the group common TCI field/TCI field indication could correspond to (i.e., via repurposing) one or more bits of one or more of the existing DCI fields block number 1, block number 2, . . . , block number B where the starting position of a block is determined by the parameter startingBitOfFormat2-3 or startingBitOfFormat2-3SUL-v0530 provided by higher layers for the UE configured with the block, and/or SRS request field(s) and/or TPC command number 1, TPC command number 2, . . . , TPC command number N (where each TPC command applies to a respective UL carrier provided by higher layer parameter cc-IndexInOneCC-Set) for one or more blocks configured/provided for the UE by higher layers if the UE is configured with higher layer parameter srs-TPC-PDCCH-Group=typeA for an UL without PUCCH and PUSCH or an UL on which the SRS power control is not tied with PUSCH power control, and/or SRS request field(s) and/or TPC command field(s) for one or more blocks configured/provided for the UE by higher layers where each block applies to an UL carrier if the UE is configured with higher layer parameter srs-TPC-PDCCH-Group=typeB for an UL without PUCCH and PUSCH or an UL on which the SRS power control is not tied with PUSCH power control.
When/if the group common DCI format for TCI state(s) indication corresponds to DCI format 2_4, the group common TCI field/TCI field indication could correspond to (i.e., via repurposing) one or more bits of one or more of the existing DCI fields Availability indicator 1, Availability indicator 2, . . . , Availability indicator N.

The UE (e.g., the UE 116) could be indicated/configured/provided by the network, e.g., via higher layer RRC signaling(s)/parameter(s) and/or MAC CE command(s) and/or dynamic DCI based L1 signaling, whether the group common DCI format for TCI state(s) indication could correspond to DCI format 2_0, DCI format 21, DCI format 2_2, DCI format 2_3 and/or DCI format 2_4 according to those specified herein in the present disclosure. Optionally, the UE could determine/identify, e.g., based on/according to one or more conditions, whether the group common DCI format for TCI state(s) indication could correspond to DCI format 2_0, DCI format 2_1, DCI format 2_2, DCI format 2_3 and/or DCI format 2_4 according to those specified herein in the present disclosure, wherein the one or more conditions could comprise (at least) payload size of the group common DCI format for TCI state(s) indication and/or their relation(s) to a threshold and/or their relation(s) to payload size(s) of DCI format 2_0, DCI format 2_1, DCI format 2_2, DCI format 2_3 and/or DCI format 2_4; the value of the threshold could be: (i) provided/indicated/configured by the network, e.g., via higher layer RRC signaling(s)/parameter(s) and/or MAC CE command(s) and/or dynamic DCI based L1 signaling(s), (ii) fixed value(s) in system specification(s), and/or (iii) autonomously determined by the UE, and/or reported to the network, e.g., in part of a CSI/beam report and/or via UE capability signaling(s). As specified herein in the present disclosure, the group common DCI format for TCI state(s) indication could correspond to a new/dedicated DCI format for UE group common signaling—denoted by DCI format 2_x. For this case, the group common TCI field/TCI field indication could correspond to a new/dedicated DCI field/DCI field indication in the DCI format 2_x for UE group common signaling. Furthermore, the size of the dedicated group common DCI format 2_x for TCI state(s) indication as specified herein the present disclosure could be configurable by higher layers up to a number of bits (e.g., up to 126 bits or up to 128 bits); alternatively, the number of information bits in the dedicated group common DCI format 2_x for TCI state(s) indication as specified herein in the present disclosure could be equal to or less than the payload size of format 1_0 monitored in common search space in the same serving cell; in this case, if the number of information bits in the dedicated group common DCI format 2_x for TCI state(s) indication is less than the payload size of format 1_0 monitored in common search space in the same serving cell, zeros shall be appended to the dedicated group common DCI format 2_x for TCI state(s) indication until the payload size equals that of format 1_0 monitored in common search space in the same serving cell.

The UE could receive an activation command, e.g., a (unified) TCI state(s) activation/deactivation MAC CE command, used to map up to M (e.g., 8) TCI states and/or pairs of TCI states, with one TCI state for DL channels/signals and/or one TCI state for UL channels/signals to the codepoints of the group common TCI field/TCI field indication in the group common DCI format for TCI state(s) indication as specified herein in the present disclosure for one or for a set of CCs/DL BWPs, and/or up to M (e.g., 8) pairs of TCI states or sets of TCI states, where each set is comprised of one or two TCI state(s) for DL channels/signals and/or one or two TCI state(s) for UL channels/signals to the codepoints of the group common TCI field/TCI field indication in the group common DCI format for TCI state(s) indication as specified herein in the present disclosure for one or for a set of CCs/DL BWPs and, if applicable, for one or for a set of CCs/UL BWPs. For this case, when/if provided/indicated by/in the group common DCI for TCI state(s) indication (or group common beam indication DCI), the group common TCI field/TCI field indication could comprise/provide/indicate one or more TCI states/pairs of TCI states corresponding to/referring to as first (indicated) TCI state(s), and/or second (indicated) TCI state(s), and/or so on for a/the corresponding group of UEs.

In one example, when a UE is configured with dl-OrJointTCI-StateList and is having two indicated TCI states—e.g., the first (indicated) TCI state(s) and the second (indicated) TCI state(s) indicated/provided by/in the group common DCI for TCI state(s) indication according to those specified herein in the present disclosure, a higher layer configuration—e.g., denoted by applyGroupUnifiedTCI—can be provided to a periodic/semi-persistent (P/SP) CSI resource set or a CSI-RS resource in a P/SP CSI resource set to inform that the UE could apply the first or the second indicated TCI state(s)—indicated/provided by/in the group common DCI for TCI state(s) indication according to those specified herein in the present disclosure—to the P/SP CSI resource set (and therefore, the CSI-RS resource(s) provided/configured/indicated therein) or to the CSI-RS resource in the P/SP CSI resource set, when/if, e.g., the P/SP CSI resource set for CSI or BM is configured with followUnifiedTCI-State. That is:
When/if the higher layer configuration applyGroupUnifiedTCI provided to a P/SP CSI resource set or a CSI-RS resource in a P/SP CSI resource set is set to ‘0’ (or ‘1’) or ‘00’ (or ‘01’ or ‘10’ or ‘11’) or ‘first’, the UE could apply the first TCI state(s) indicated/provided in the group common beam indication DCI according to those specified herein in the present disclosure for receiving the P/SP CSI resource set (and therefore, the CSI-RS resource(s) provided/configured/indicated therein) or the CSI-RS resource in the P/SP CSI resource set, when/if, e.g., the P/SP CSI resource set for CSI or BM is configured with follow UnifiedTCI-State.
When/if the higher layer configuration applyGroupUnifiedTCI provided to a P/SP CSI resource set or a CSI-RS resource in a P/SP CSI resource set is set to ‘1’ (or ‘0’) or ‘01’ (or ‘00’ or ‘10’ or ‘11’) or ‘second’, the UE could apply the second TCI state(s) indicated/provided in the group common beam indication DCI according to those specified herein in the present disclosure for receiving the P/SP CSI resource set (and therefore, the CSI-RS resource(s) provided/configured/indicated therein) or the CSI-RS resource in the P/SP CSI resource set, when/if, e.g., the P/SP CSI resource set for CSI or BM is configured with follow UnifiedTCI-State.
When/if the higher layer configuration applyGroupUnifiedTCI provided to a P/SP CSI resource set or a CSI-RS resource in a P/SP CSI resource set is set to ‘1’/‘0’ or ‘10’/‘11’ (or ‘00’ or ‘01’) or ‘both’, the UE could apply the first and/or the second TCI state(s) indicated/provided in the group common beam indication DCI according to those specified herein in the present disclosure for receiving the P/SP CSI resource set (and therefore, the CSI-RS resource(s) provided/configured/indicated therein) or the CSI-RS resource in the P/SP CSI resource set, when/if, e.g., the P/SP CSI resource set for CSI or BM is configured withfollowUnifiedTCI-State.

When/if the UE is configured by higher layer parameter PDCCH-Config that contains two different values of CORESETPoolIndex in different ControlResourceSets, the first and the second indicated TCI states could correspond to the TCI states indicated/provided in the group common DCIs for TCI state(s) indication according to those specified herein in the present disclosure specific to coresetPoolIndex value 0 and value 1, respectively.

In one example, for P/SP CSI resource setting(s), when a UE is configured with groupBasedBeamReporting-r17 and/or groupBasedBeamReporting-r18, a P/SP CSI resource setting/configuration (e.g., provided by CSI-ResourceConfig) could comprise/contain/include/provide/configure two CSI resource sets—denoted by first (P/SP) CSI resource set and second (P/SP) CSI resource set in the present disclosure. When the UE is configured with dl-OrJointTCJ-StateList and is having two indicated TCI states—e.g., the first (indicated) TCI state(s) and the second (indicated) TCI state(s) indicated/provided by/in the group common DCI for TCI state(s) indication according to those specified herein in the present disclosure, the UE could apply the first indicated TCI state(s)—indicated/provided by/in the group common DCI for TCI state(s) indication according to those specified herein in the present disclosure—to the first P/SP CSI resource set (and therefore, the CSI-RS resource(s) provided/configured/indicated therein), and the second indicated TCI state(s)—indicated/provided by/in the group common DCI for TCI state(s) indication according to those specified herein in the present disclosure—to the second P/SP CSI resource set (and therefore, the CSI-RS resource(s) provided/configured/indicated therein), when/if, e.g., the first and/or second P/SP CSI resource set(s) for CSI or BM is configured with followUnifiedTCI-State.

In one example, for P/SP CSI resource setting(s), when a UE is configured with two CSI resource groups—denoted by first (P/SP) CSI resource group comprising one or more non-zero power (NZP) CSI-RS resources and second (P/SP) CSI resource group comprising one or more NZP CSI-RS resources—in a (P/SP) CSI resource set for non-CJT (NCJT) CSI measurement, reporting and/or acquisition, and when the UE is configured with dl-OrJointTCI-StateList and is having two indicated TCI states—e.g., the first (indicated) TCI state(s) and the second (indicated) TCI state(s) indicated/provided by/in the group common DCI for TCI state(s) indication according to those specified herein in the present disclosure, the UE could apply the first indicated TCI state(s)—indicated/provided by/in the group common DCI for TCI state(s) indication according to those specified herein in the present disclosure—to the first P/SP CSI resource group (and therefore, the CSI-RS resource(s) provided/configured/indicated therein), and the second indicated TCI state(s)—indicated/provided by/in the group common DCI for TCI state(s) indication according to those specified herein in the present disclosure—to the second P/SP CSI resource group (and therefore, the CSI-RS resource(s) provided/configured/indicated therein), when/if, e.g., the first and/or second P/SP CSI resource group(s) for CSI or BM is configured with followUnifiedTCI-State.

The described/specified TCI state(s) indication/application via group common beam indication DCI (or group common DCI for TCI state(s) indication) as specified herein in the present disclosure for P/SP CSI-RS reception(s) can be extended/applied to P/SP SRS transmission(s), e.g., by replacing P/SP CSI resource set(s) with P/SP SRS resource set(s), P/SP CSI-RS resource(s) with P/SP SRS resource(s), adding UL-TCI state(s) in addition to DL and/or joint TCI state(s), and/or etc.

For PDSCH reception in a (single-DCI based) multi-TRP system, a UE could be configured/provided/indicated by the network, e.g., in a group common DCI for TCI state(s) indication according to those specified herein in the present disclosure—the second indicator (or a TCI selection field indicator) as specified herein in the present disclosure to indicate which one or more of the first and the second TCI states indicated by/in the group common DCI for TCI state(s) indication as specified herein in the present disclosure, to use/apply for receiving the PDSCH(s). For instance, the second indicator/TCI selection field indicator could be a (two-bit) indicator with ‘00’ or ‘first’ indicating that the first indicated TCI state(s) among the set of TCI states/pairs of TCI states indicated/provided in/by the group common DCI for TCI state(s) indication as specified herein in the present disclosure, could be used/applied for receiving the corresponding PDSCH(s), ‘01’ or ‘second’ indicating that the second indicated TCI state(s) among the set of TCI states/pairs of TCI states indicated by/in the group common DCI for TCI state(s) indication as specified herein in the present disclosure, could be used/applied for receiving the corresponding PDSCH(s), ‘10’ or ‘both’ indicating that the first and the second indicated TCI states among the set of TCI states/pairs of TCI states indicated in/by the group common DCI for TCI state(s) indication as specified herein in the present disclosure, could be respectively used/applied for receiving the corresponding PDSCH(s)—e.g., first and second PDSCHs, and/or ‘11’ or ‘both’ indicating that the second and the first indicated TCI states among the set of TCI states/pairs of TCI states indicated in/by the group common DCI for TCI state(s) indication as specified herein in the present disclosure, could be respectively used/applied for receiving the corresponding PDSCH(s)—e.g., first and second PDSCHs, wherein the first and second PDSCHs could correspond to two PDSCH transmission occasions or repetition in space, time and/or frequency. Furthermore, throughout the present disclosure, the first TCI state(s) or the second TCI state(s)—specified herein in the present disclosure— could correspond to a joint DL and UL TCI state provided by TCI-State/DLorJointTCI-State, a separate DL TCI state provided by TCI-State/DLorJointTCI-State, a separate UL TCI state provided by TCI-State/UL-TCIState, or a pair of separate DL and separate UL TCI states. In addition, the PDSCH(s) reception could correspond to UE-dedicated PDSCH reception(s) and/or non-UE-dedicated PDSCH reception(s), wherein the non-UE-dedicated PDSCH(s) could be scheduled by non-UE-dedicated PDCCH(s)/DCI(s) received in non-UE-dedicated CORESET(s) on non-UE-dedicated search space(s)/search space set(s).

For PUSCH transmission in a (single-DCI based) multi-TRP system, a UE could be configured/provided/indicated by the network, e.g., in a group common DCI for TCI state(s) indication according to those specified herein in the present disclosure—the fourth indicator (or a SRS resource set indicator) as specified herein in the present disclosure to indicate which one or more of the first and the second TCI states indicated by/in the group common DCI for TCI state(s) indication as specified herein in the present disclosure, to use/apply for transmitting the PUSCH(s). For instance, the fourth indicator/SRS resource set indicator field could be a (two-bit) indicator with ‘00’ or ‘first’ indicating that the first indicated TCI state(s) among the set of TCI states/pairs of TCI states indicated/provided in/by the group common DCI for TCI state(s) indication as specified herein in the present disclosure could be used/applied for transmitting the corresponding PUSCH(s), ‘01’ or ‘second’ indicating that the second indicated TCI state(s) among the set of TCI states/pairs of TCI states indicated/provided in/by the group common DCI for TCI state(s) indication as specified herein in the present disclosure could be used/applied for transmitting the corresponding PUSCH(s), ‘10’ or ‘both’ indicating that the first and the second indicated TCI states among the set of TCI states/pairs of TCI states indicated/provided in/by the group common DCI for TCI state(s) indication as specified herein in the present disclosure could be respectively used/applied for transmitting the corresponding PUSCH(s)—e.g., first and second PUSCHs, and/or ‘11’ or ‘both’ indicating that the second and the first indicated TCI states among the set of TCI states/pairs of TCI states indicated/provided in/by the group common DCI for TCI state(s) indication as specified herein in the present disclosure could be respectively used/applied for transmitting the corresponding PUSCH(s)—e.g., first and second PUSCHs, wherein the first and second PUSCHs could correspond to two PUSCH transmission occasions or repetition in space, time and/or frequency. Furthermore, throughout the present disclosure, the first TCI state(s) or the second TCI state(s)—specified herein in the present disclosure—could correspond to a joint DL and UL TCI state provided by TCI-State/DLorJointTCI-State, a separate DL TCI state provided by TCI-State/DLorJointTCI-State, a separate UL TCI state provided by TCI-State/UL-TCIState, or a pair of separate DL and separate UL TCI states. In addition, the PUSCH(s) transmission could correspond to UE-dedicated PUSCH transmission(s) and/or non-UE-dedicated PUSCH transmission(s), wherein the non-UE-dedicated PUSCH(s) could be scheduled by non-UE-dedicated PDCCH(s)/DCI(s) received in non-UE-dedicated CORESET(s) on non-UE-dedicated search space(s)/search space set(s).

In a wireless communications system, e.g., for coherent joint transmission (CJT), a UE could be configured/provided/indicated/activated/triggered by the network, e.g., via higher layer RRC signaling(s)/parameter(s) and/or MAC CE command(s) and/or dynamic DCI based L1 signaling(s), up to M (e.g., M=4) periodic (P), semi-persistent (SP) and/or aperiodic (AP) CSI-RS(s) for channel measurement—i.e., up to M (e.g., M=4) P/SP/AP CSI-RS(s) used as channel measurement resource(s) (CMR(s)). Furthermore, the UE could be indicated/provided by the network, e.g., via (unified) TCI state(s) activation/deactivation MAC CE and/or beam indication DCI (e.g., DCI format 1_1/1_2 with or without DL assignment), up to N (e.g., N=2) joint/DL/UL TCI state(s) for at least PDSCH reception(s)—e.g., for CJT operation(s), wherein if the beam indication DCI is signaled and applied, the joint/DL/UL TCI state(s) could be indicated/provided by one or more TCI codepoints in one or more TCI fields of the beam indication DCI. However, there may exist mismatch(es) between the QCL assumption(s) for receiving the CSI-RS(s) configured/provided/activated/triggered by the network and the QCL assumption(s) for receiving at least the PDSCH(s), e.g., for CJT operation(s).

This disclosure provides various design aspects related to aligning the QCL assumptions for receiving CSI-RS(s) and at least PDSCH(s) in a wireless communications system, e.g., for CJT operation, especially when the QCL assumption(s) for receiving the CSI-RS(s) is configured via RRC and the QCL assumption(s) for receiving the PDSCH(s) is indicated via MAC CE/DCI. The corresponding UE behaviors are also specified in this disclosure.

In one embodiment, in a wireless communications system, e.g., for CJT operation (e.g., when/if a UE is configured by higher layer parameter cjtSchemePDSCH), under the unified TCI framework (e.g., when/if the UE is configured by higher layer parameter dl-OrJointTCI-StateList), the UE could be indicated with—e.g., via beam indication MAC CE/DCI as specified herein in the present disclosure— one TCI-State (e.g., one indicated joint/DL TCI state) applied for PDSCH reception(s). As specified herein in the present disclosure, the one indicated TCI-State or the one indicated joint/DL TCI state applied for PDSCH reception(s) could correspond to the first indicated TCI-State or the first indicated joint/DL TCI state of a TCI codepoint as specified herein in the present disclosure, or the second indicated TCI-State or the second indicated joint/DL TCI state of a TCI codepoint as specified herein in the present disclosure. For instance, when/if the second indicator or a TCI selection field in DCI format 1_1/1_2 as specified herein in the present disclosure is present and set to ‘0’ (or ‘1’) or ‘first’ or ‘enabled’, the one indicated TCI-State or the one indicated joint/DL TCI state applied for PDSCH reception(s) could correspond to the first indicated TCI-State or the first indicated joint/DL TCI state of a TCI codepoint as specified herein in the present disclosure; and/or when/if the second indicator or the TCI selection field in DCI format 1_1/1_2 as specified herein in the present disclosure is present and set to ‘1’ (or ‘0’) or ‘second’ or ‘enabled’, the one indicated TCI-State or the one indicated joint/DL TCI state applied for PDSCH reception(s) could correspond to the second indicated TCI-State or the second indicated joint/DL TCI state of a TCI codepoint as specified herein in the present disclosure. In this case, see the following.

In one example, the UE could be configured/indicated/provided/activated/triggered by the network, e.g., via/in higher layer RRC signaling(s)/parameter(s)—e.g., via/in CSI-ResourceConfig, CSI-ReportConfig, CSI-AssociatedReportConfigInfo, and/or CSI-AperiodicTriggerState—and/or MAC CE command(s) and/or dynamic DCI based L1 signaling(s), a single P/SP/AP CSI-RS for channel measurement (i.e., a single CMR). The UE could be configured with—e.g., via higher layer RRC signaling(s)/parameter(s)—one TCI-State (e.g., one configured joint/DL TCI state) applied for receiving the P/SP/AP CSI-RS (i.e., the CMR).

For example, the UE could expect that the QCL assumption(s) of the one indicated joint/DL TCI state for the PDSCH reception(s) is identical to/the same as the QCL assumption(s) of the one configured joint/DL TCI state for the P/SP/AP CSI-RS reception(s). That is, the UE could expect that the RS(s) provided/indicated in the one indicated joint/DL TCI state for the PDSCH reception(s) and the RS(s) provided/indicated in the one configured joint/DL TCI state for the P/SP/AP CSI-RS reception(s) are QCL'ed. In this case, the UE could use/apply the one indicated or configured joint/DL TCI state to the P/SP/AP CSI-RS and/or the PDSCH.

For another example, an RRC configuration could be provided to the P/SP/AP CSI-RS resource and/or a CSI resource set that configures/provides the P/SP/AP CSI-RS resource. In this case, when/if the UE is configured with the RRC configuration (e.g., set to ‘enabled’), and/or when/if the RRC configuration is set to ‘0’ (or ‘1’) or ‘00’ (or ‘01’ or ‘10’ or ‘11’) or ‘first’ or ‘second’ or ‘both’, the UE could use/apply the one indicated joint/DL TCI state to the P/SP/AP CSI-RS and/or the PDSCH; otherwise—e.g., one or more of the RRC configuration settings/values herein are not provided/configured/indicated/set, the UE could use/apply the one configured joint/DL TCI state to the P/SP/AP CSI-RS.

In another example, the UE could be configured/indicated/provided/activated/triggered by the network, e.g., via/in higher layer RRC signaling(s)/parameter(s)—e.g., via/in CSI-ResourceConfig, CSI-ReportConfig, CSI-AssociatedReportConfigInfo, and/or CSI-AperiodicTriggerState—and/or MAC CE command(s) and/or dynamic DCI based L1 signaling(s), a first P/SP/AP CSI-RS and a second P/SP/AP CSI-RS for channel measurement (i.e., a first CMR and a second CMR). The UE could be configured with—e.g., via higher layer RRC signaling(s)/parameter(s)—a first TCI-State (e.g., a first configured joint/DL TCI state) applied for receiving the first P/SP/AP CSI-RS (i.e., the first CMR) and a second TCI-State (e.g., a second configured joint/DL TCI state) applied for receiving the second P/SP/AP CSI-RS (i.e., the second CMR). The first TCI-State (e.g., the first configured joint/DL TCI state)—and therefore, the RS(s) provided/indicated therein— could be identical to/the same as the second TCI-State (e.g., the second configured joint/DL TCI state)—and therefore, the RS(s) provided/indicated therein.

For example, the UE could expect that the QCL assumption(s) of the one indicated joint/DL TCI state for the PDSCH reception(s) is identical to/the same as the QCL assumption(s) of the first configured joint/DL TCI state for receiving the first P/SP/AP CSI-RS. That is, the UE could expect that the RS(s) provided/indicated in the one indicated joint/DL TCI state for the PDSCH reception(s) and the RS(s) provided/indicated in the first configured joint/DL TCI state for receiving the first P/SP/AP CSI-RS are QCL'ed. In this case, the UE could use/apply the one indicated joint/DL TCI state to the first P/SP/AP CSI-RS and/or the PDSCH, and/or the UE could use/apply the second configured joint/DL TCI state to the second P/SP/AP CSI-RS.

For another example, the UE could expect that the QCL assumption(s) of the one indicated joint/DL TCI state for the PDSCH reception(s) is identical to/the same as the QCL assumption(s) of the second configured joint/DL TCI state for receiving the second P/SP/AP CSI-RS. That is, the UE could expect that the RS(s) provided/indicated in the one indicated joint/DL TCI state for the PDSCH reception(s) and the RS(s) provided/indicated in the second configured joint/DL TCI state for receiving the second P/SP/AP CSI-RS are QCL'ed. In this case, the UE could use/apply the one indicated joint/DL TCI state to the second P/SP/AP CSI-RS and/or the PDSCH, and/or the UE could use/apply the first configured joint/DL TCI state to the first P/SP/AP CSI-RS.

Yet for another example, the UE could expect that the QCL assumption(s) of the one indicated joint/DL TCI state for the PDSCH reception(s) is identical to/the same as the QCL assumption(s) of the first configured joint/DL TCI state for receiving the first P/SP/AP CSI-RS and the QCL assumption(s) of the second configured joint/DL TCI state for receiving the second P/SP/AP CSI-RS. That is, the UE could expect that the RS(s) provided/indicated in the one indicated joint/DL TCI state for the PDSCH reception(s) and the RS(s) provided/indicated in the first configured joint/DL TCI state for receiving the first P/SP/AP CSI-RS and the second configured joint/DL TCI state for receiving the second P/SP/AP CSI-RS are QCL'ed. In this case, the UE could use/apply the one indicated joint/DL TCI state to the first P/SP/AP CSI-RS and the second P/SP/AP CSI-RS and/or the PDSCH.

Yet for another example, the association/mapping between the one indicated joint/DL TCI state for the PDSCH reception(s) and the first/second configured joint/DL TCI state(s) for receiving the first/second P/SP/AP CSI-RS(s), i.e., whether the UE could follow those specified herein in the present disclosure, e.g., according to one or more examples described herein, to expect that the RS(s) provided/indicated in the one indicated joint/DL TCI state is QCL'ed with the RS(s) provided/indicated in the first configured joint/DL TCI state, and/or follow one or more examples described herein to expect that the RS(s) provided/indicated in the one indicated joint/DL TCI state is QCL'ed with the RS(s) provided/indicated in the second configured joint/DL TCI state, and/or follow one or more examples described herein, to expect that the RS(s) provided/indicated in the one indicated joint/DL TCI state is QCL'ed with the RSs provided/indicated in both of the first and the second configured joint/DL TCI states, could be determined according to: (i) fixed rule(s)/value(s) specified/provided in system specification(s), (ii) network's configuration(s)/indication(s), e.g., via/in higher layer RRC signaling(s)/parameter(s) and/or MAC CE command(s) and/or dynamic DCI based L1 signaling(s), and/or (iii) UE's autonomous determination/selection, which could be further sent to the network, e.g., in/by part of a beam/CSI report and/or UE's capability signaling(s). For instance, the UE could be indicated/provided/configured by the network, e.g., via higher layer RRC signaling(s)/parameter(s) and/or MAC CE command(s) and/or dynamic DCI based L1 signaling(s), a bitmap with the first entry/bit position of the bitmap corresponding/associated to the first P/SP/AP CSI-RS (i.e., the first CMR) and the second entry/bit position of the bitmap corresponding/associated to the second P/SP/AP CSI-RS (i.e., the second CMR); in this case, when/if the first entry/bit position of the bitmap is set to ‘1’ (or ‘0’), the UE could follow one or more examples described herein, to expect that the RS(s) provided/indicated in the one indicated joint/DL TCI state is QCL'ed with the RS(s) provided/indicated in the first configured joint/DL TCI state, and/or when/if the second entry/bit position of the bitmap is set to ‘1’ (or ‘0’), the UE could follow those provided/specified in one or more examples described herein to expect that the RS(s) provided/indicated in the one indicated joint/DL TCI state is QCL'ed with the RS(s) provided/indicated in the second configured joint/DL TCI state, and/or when/if the first entry/bit position of the bitmap is set to ‘1’ (or ‘0’) and the second entry/bit position of the bitmap is set to ‘1’ (or ‘0’), the UE could follow those provided/specified in one or more examples described herein to expect that the RS(s) provided/indicated in the one indicated joint/DL TCI state is QCL'ed with the RS(s) provided/indicated in the first configured joint/DL TCI state and the RS(s) provided/indicated in the second configured joint/DL TCI state.

Yet for another example, an RRC configuration could be provided to the first P/SP/AP CSI-RS resource and/or a CSI resource set that configures/provides the first P/SP/AP CSI-RS resource. In this case, when/if the UE is configured with the RRC configuration (e.g., set to ‘enabled’), and/or when/if the RRC configuration is set to ‘0’ (or ‘1’) or ‘00’ (or ‘01’ or ‘10’ or ‘11’) or ‘first’ or ‘second’ or ‘both’, the UE could use/apply the one indicated joint/DL TCI state to the first P/SP/AP CSI-RS and/or the PDSCH, and/or the UE could use/apply the second configured joint/DL TCI state to the second P/SP/AP CSI-RS; otherwise—e.g., one or more of the RRC configuration settings/values herein are not provided/configured/indicated/set, the UE could use/apply the first and the second configured joint/DL TCI states respectively to the first and the second P/SP/AP CSI-RSs.

Yet for another example, an RRC configuration could be provided to the second P/SP/AP CSI-RS resource and/or a CSI resource set that configures/provides the second P/SP/AP CSI-RS resource. In this case, when/if the UE is configured with the RRC configuration (e.g., set to ‘enabled’), and/or when/if the RRC configuration is set to ‘0’ (or ‘1’) or ‘00’ (or ‘01’ or ‘10’ or ‘11’) or ‘first’ or ‘second’ or ‘both’, the UE could use/apply the one indicated joint/DL TCI state to the second P/SP/AP CSI-RS and/or the PDSCH, and/or the UE could use/apply the first configured joint/DL TCI state to the first P/SP/AP CSI-RS; otherwise—e.g., one or more of the RRC configuration settings/values herein are not provided/configured/indicated/set, the UE could use/apply the first and the second configured joint/DL TCI states respectively to the first and the second P/SP/AP CSI-RSs.

Yet for another example, a first RRC configuration could be provided to the first P/SP/AP CSI-RS resource and/or a CSI resource set that configures/provides the first P/SP/AP CSI-RS resource, and a second RRC configuration could be provided to the second P/SP/AP CSI-RS resource and/or a CSI resource set that configures/provides the second P/SP/AP CSI-RS resource. In this case, when/if the UE is configured with the first RRC configuration (e.g., set to ‘enabled’), and/or when/if the UE is configured with the second RRC configuration (e.g., set to ‘enabled’), and/or when/if the first RRC configuration is set to ‘0’ (or ‘1’) or ‘00’ (or ‘01’ or ‘10’ or ‘11’) or ‘first’ or ‘second’ or ‘both’, and/or when/if the second RRC configuration is set to ‘0’ (or ‘1’) or ‘00’ (or ‘01’ or ‘10’ or ‘11’) or ‘first’ or ‘second’ or ‘both’, the UE could use/apply the one indicated joint/DL TCI state to the first and/or the second P/SP/AP CSI-RS(s) and/or the PDSCH; otherwise—e.g., one or more of the RRC configuration settings/values herein are not provided/configured/indicated/set, the UE could use/apply the first and the second configured joint/DL TCI states respectively to the first and the second P/SP/AP CSI-RSs.

In yet another example, the UE (e.g., the UE 116) could be configured/indicated/provided/activated/triggered by the network, e.g., via/in higher layer RRC signaling(s)/parameter(s)—e.g., via/in CSI-ResourceConfig, CSI-ReportConfig, CSI-AssociatedReportConfigInfo, and/or CSI-AperiodicTriggerState—and/or MAC CE command(s) and/or dynamic DCI based L1 signaling(s), a first P/SP/AP CSI-RS, a second P/SP/AP CSI-RS and a third P/SP/AP CSI-RS for channel measurement (i.e., a first CMR, a second CMR and a third CMR). The UE could be configured with—e.g., via higher layer RRC signaling(s)/parameter(s)—a first TCI-State (e.g., a first configured joint/DL TCI state) applied for receiving the first P/SP/AP CSI-RS (i.e., the first CMR), a second TCI-State (e.g., a second configured joint/DL TCI state) applied for receiving the second P/SP/AP CSI-RS (i.e., the second CMR), and a third TCI-State (e.g., a third configured joint/DL TCI state) applied for receiving the third P/SP/AP CSI-RS (i.e., the third CMR). The first TCI-State (e.g., the first configured joint/DL TCI state)—and therefore, the RS(s) provided/indicated therein, the second TCI-State (e.g., the second configured joint/DL TCI state)—and therefore, the RS(s) provided/indicated therein, and/or the third TCI-State (e.g., the third configured joint/DL TCI state)—and therefore, the RS(s) provided/indicated therein, could be identical/the same. The UE could be indicated/configured/provided by the network, e.g., via higher layer RRC signaling(s)/parameter(s) and/or MAC CE command(s) and/or dynamic DCI based L1 signaling(s), a group of P/SP/AP CSI-RS(s) comprising the first P/SP/AP CSI-RS and/or the second P/SP/AP CSI-RS and/or the third P/SP/AP CSI-RS as specified herein in the present disclosure. In particular, the group of P/SP/AP CSI-RS(s) could comprise at least one of:
The first P/SP/AP CSI-RS
The second P/SP/AP CSI-RS
The third P/SP/AP CSI-RS
The first and the second P/SP/AP CSI-RSs
The first and the third P/SP/AP CSI-RSs
The second and the third P/SP/AP CSI-RSs
The first, second and third P/SP/AP CSI-RSs

As specified herein in the present disclosure, the group of P/SP/AP CSI-RS(s) could be: (i) determined according to fixed rule(s)/value(s) in system specification(s), (ii) provided/indicated/updated/configured by the network, e.g., via higher layer RRC signaling(s)/parameter(s) and/or MAC CE command(s) and/or dynamic DCI based L1 signaling(s), and/or (iii) autonomously determined by the UE, which could be further sent to the network, e.g., via/in part of a CSI/beam report and/or UE's capability signaling(s). For instance, the UE could be indicated/provided/configured by the network, e.g., via higher layer RRC signaling(s)/parameter(s) and/or MAC CE command(s) and/or dynamic DCI based L1 signaling(s), a bitmap with the first entry/bit position of the bitmap corresponding/associated to the first P/SP/AP CSI-RS (i.e., the first CMR), the second entry/bit position of the bitmap corresponding/associated to the second P/SP/AP CSI-RS (i.e., the second CMR), and the third entry/bit position of the bitmap corresponding/associated to the third P/SP/AP CSI-RS (i.e., the third CMR). In this case, when/if an entry/bit position of the bitmap is set to ‘1’ (or ‘0’), the corresponding/associated P/SP/AP CSI-RS (i.e., the corresponding/associated CMR) is in the group of P/SP/AP CSI-RS(s) as specified herein in the present disclosure.

For example, the UE could expect that the QCL assumption(s) of the one indicated joint/DL TCI state for the PDSCH reception(s) is identical to/the same as the QCL assumption(s) of the configured joint/DL TCI state(s) for receiving the P/SP/AP CSI-RS(s) in the group of P/SP/AP CSI-RS(s) as specified herein in the present disclosure. That is, the UE could expect that the RS(s) provided/indicated in the one indicated joint/DL TCI state for the PDSCH reception(s) and the RS(s) provided/indicated in the configured joint/DL TCI state(s) for receiving the P/SP/AP CSI-RS(s) in the group of P/SP/AP CSI-RS(s) as specified herein in the present disclosure are QCL'ed. In this case, the UE could use/apply the one indicated joint/DL TCI state to the P/SP/AP CSI-RS(s) in the group and/or the PDSCH, and/or the UE could use/apply the configured joint/DL TCI state(s) to the corresponding first, second and/or third P/SP/AP CSI-RS(s) not in the group.

In one example, the group of P/SP/AP CSI-RS(s) as specified herein in the present disclosure could only comprise the first P/SP/AP CSI-RS. For this design example, the UE could expect that the QCL assumption(s) of the one indicated joint/DL TCI state for the PDSCH reception(s) is identical to/the same as the QCL assumption(s) of the first configured joint/DL TCI state for receiving the first P/SP/AP CSI-RS in the group as specified herein in the present disclosure. That is, the UE could expect that the RS(s) provided/indicated in the one indicated joint/DL TCI state for the PDSCH reception(s) and the RS(s) provided/indicated in the first configured joint/DL TCI state for receiving the first P/SP/AP CSI-RS in the group as specified herein in the present disclosure are QCL'ed. In this case, the UE could use/apply the one indicated joint/DL TCI state to the first P/SP/AP CSI-RS in the group and/or the PDSCH, and/or the UE could use/apply the second configured joint/DL TCI state to the second P/SP/AP CSI-RS, and/or the UE could use/apply the third configured joint/DL TCI state to the third P/SP/AP CSI-RS, wherein the second and the third P/SP/SP CSI-RSs are not in the group.

In another example, the group of P/SP/AP CSI-RS(s) as specified herein in the present disclosure could only comprise the first and the second P/SP/AP CSI-RSs. For this design example, the UE could expect that the QCL assumption(s) of the one indicated joint/DL TCI state for the PDSCH reception(s) is identical to/the same as the QCL assumption(s) of the first configured joint/DL TCI state for receiving the first P/SP/AP CSI-RS in the group and the QCL assumption(s) of the second configured joint/DL TCI state for receiving the second P/SP/AP CSI-RS in the group as specified herein in the present disclosure. That is, the UE could expect that the RS(s) provided/indicated in the one indicated joint/DL TCI state for the PDSCH reception(s) could be QCL'ed with the RS(s) provided/indicated in the first configured joint/DL TCI state for receiving the first P/SP/AP CSI-RS in the group as specified herein in the present disclosure and the RS(s) provided/indicated in the second configured joint/DL TCI state for receiving the second P/SP/AP CSI-RS in the group as specified herein in the present disclosure. In this case, the UE could use/apply the one indicated joint/DL TCI state to the first and the second P/SP/AP CSI-RSs in the group and/or the PDSCH, and/or the UE could use/apply the third configured joint/DL TCI state to the third P/SP/AP CSI-RS, wherein the third P/SP/SP CSI-RS is not in the group.

In yet another example, the group of P/SP/AP CSI-RS(s) as specified herein in the present disclosure could comprise the first, the second and the third P/SP/AP CSI-RSs. For this design example, the UE could expect that the QCL assumption(s) of the one indicated joint/DL TCI state for the PDSCH reception(s) is identical to/the same as the QCL assumption(s) of the first configured joint/DL TCI state for receiving the first P/SP/AP CSI-RS in the group and the QCL assumption(s) of the second configured joint/DL TCI state for receiving the second P/SP/AP CSI-RS in the group and the QCL assumption(s) of the third configured joint/DL TCI state for receiving the third P/SP/AP CSI-RS in the group as specified herein in the present disclosure. That is, the UE could expect that the RS(s) provided/indicated in the one indicated joint/DL TCI state for the PDSCH reception(s) could be QCL'ed with the RS(s) provided/indicated in the first configured joint/DL TCI state for receiving the first P/SP/AP CSI-RS in the group as specified herein in the present disclosure and the RS(s) provided/indicated in the second configured joint/DL TCI state for receiving the second P/SP/AP CSI-RS in the group as specified herein in the present disclosure and the RS(s) provided/indicated in the third configured joint/DL TCI state for receiving the third P/SP/AP CSI-RS in the group as specified herein in the present disclosure. In this case, the UE could use/apply the one indicated joint/DL TCI state to the first, the second and the third P/SP/AP CSI-RSs in the group and/or the PDSCH.

For another example, the association/mapping between the one indicated joint/DL TCI state for the PDSCH reception(s) and the first/second/third configured joint/DL TCI state(s) for receiving the first/second/third P/SP/AP CSI-RS(s), i.e., whether the UE could follow those specified herein in the present disclosure, e.g., follow those provided/specified in one or more examples described herein (and the corresponding sub-examples provided/described therein) to expect that the RS(s) provided/indicated in the one indicated joint/DL TCI state is QCL'ed with the RS(s) provided/indicated in the first configured joint/DL TCI state, and/or the RS(s) provided/indicated in the one indicated joint/DL TCI state is QCL'ed with the RS(s) provided/indicated in the second configured joint/DL TCI state, and/or the RS(s) provided/indicated in the one indicated joint/DL TCI state is QCL'ed with the RSs provided/indicated in the third configured joint/DL TCI state, could be determined according to: (i) fixed rule(s)/value(s) specified/provided in system specification(s), (ii) network's configuration(s)/indication(s), e.g., via/in higher layer RRC signaling(s)/parameter(s) and/or MAC CE command(s) and/or dynamic DCI based L1 signaling(s), and/or (iii) UE's autonomous determination/selection, which could be further sent to the network, e.g., in/by part of a beam/CSI report and/or UE's capability signaling(s).

Yet for another example, RRC configuration(s) could be provided to the first, second and/or third P/SP/AP CSI-RS resource(s) in the group as specified herein in the present disclosure and/or a CSI resource set that configures/provides the first, second and/or third P/SP/AP CSI-RS resource(s) in the group. In this case, when/if the UE is configured with the RRC configuration(s) (e.g., set to ‘enabled’), and/or when/if the RRC configuration(s) is set to ‘0’ (or ‘1’) or ‘00’ (or ‘01’ or ‘10’ or ‘11’) or ‘first’ or ‘second’ or ‘both’, the UE could use/apply the one indicated joint/DL TCI state to the first, second and/or third P/SP/AP CSI-RS(s) in the group as specified herein in the present disclosure and/or the PDSCH, and/or the UE could use/apply the configured joint/DL TCI state(s) to the corresponding first, second and/or third P/SP/AP CSI-RS(s) not in the group; otherwise—e.g., one or more of the RRC configuration settings/values herein are not provided/configured/indicated/set, the UE could use/apply the first, the second and the third configured joint/DL TCI states respectively to the first, the second and the third P/SP/AP CSI-RSs.

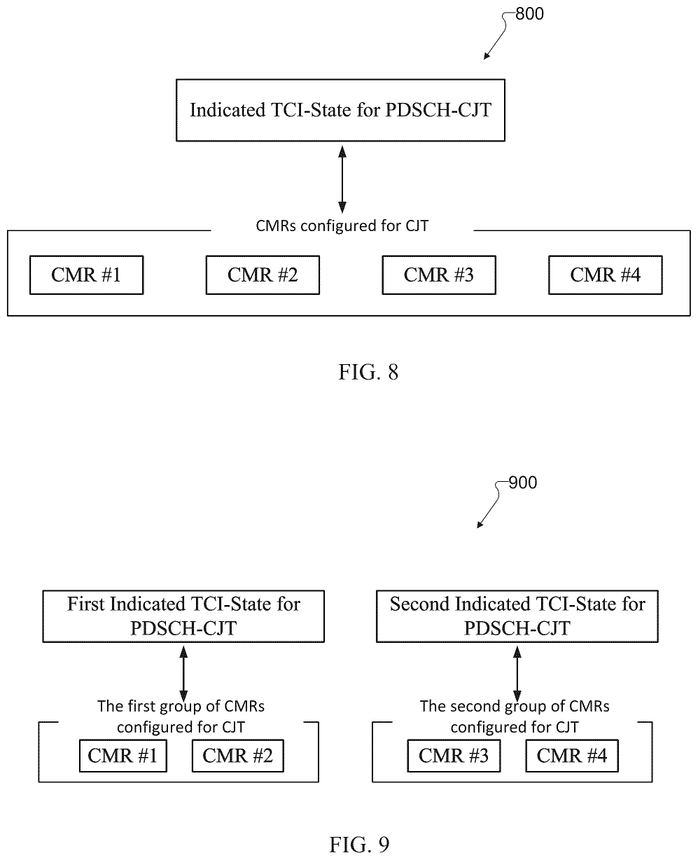

FIG. 8 illustrates a diagram of an example association/mapping 800 between indicated transmission configuration indication (TCI) state for physical downlink shared channel-coherent joint transmission (PDSCH-CJT) and channel measurement resources (CMRs) configured for CJT according to embodiments of the present disclosure. For example, association/mapping 800 may be utilized by any of the UEs 111-116 of FIG. 1, such as the UE 111. This example is for illustration only and other embodiments can be used without departing from the scope of the present disclosure.

In yet another example, the UE could be configured/indicated/provided/activated/triggered by the network, e.g., via/in higher layer RRC signaling(s)/parameter(s)—e.g., via/in CSI-ResourceConfig, CSI-ReportConfig, CSI-AssociatedReportConfigInfo, and/or CSI-AperiodicTriggerState—and/or MAC CE command(s) and/or dynamic DCI based L1 signaling(s), a first P/SP/AP CSI-RS, a second P/SP/AP CSI-RS, a third P/SP/AP CSI-RS and a fourth P/SP/AP CSI-RS for channel measurement (i.e., a first CMR, a second CMR, a third CMR and a fourth CMR). The UE could be configured with—e.g., via higher layer RRC signaling(s)/parameter(s)—a first TCI-State (e.g., a first configured joint/DL TCI state) applied for receiving the first P/SP/AP CSI-RS (i.e., the first CMR), a second TCI-State (e.g., a second configured joint/DL TCI state) applied for receiving the second P/SP/AP CSI-RS (i.e., the second CMR), a third TCI-State (e.g., a third configured joint/DL TCI state) applied for receiving the third P/SP/AP CSI-RS (i.e., the third CMR), and a fourth TCI-State (e.g., a fourth configured joint/DL TCI state) applied for receiving the fourth P/SP/AP CSI-RS (i.e., the fourth CMR). The first TCI-State (e.g., the first configured joint/DL TCI state)—and therefore, the RS(s) provided/indicated therein, the second TCI-State (e.g., the second configured joint/DL TCI state)—and therefore, the RS(s) provided/indicated therein, the third TCI-State (e.g., the third configured joint/DL TCI state)—and therefore, the RS(s) provided/indicated therein, and/or the fourth TCI-State (e.g., the fourth configured joint/DL TCI state)—and therefore, the RS(s) provided/indicated therein, could be identical/the same. The UE could be indicated/configured/provided by the network, e.g., via higher layer RRC signaling(s)/parameter(s) and/or MAC CE command(s) and/or dynamic DCI based L1 signaling(s), a group of P/SP/AP CSI-RS(s) comprising the first P/SP/AP CSI-RS and/or the second P/SP/AP CSI-RS and/or the third P/SP/AP CSI-RS and/or the fourth P/SP/AP CSI-RS as specified herein in the present disclosure. In particular, the group of P/SP/AP CSI-RS(s) could comprise at least one of:
The first P/SP/AP CSI-RS
The second P/SP/AP CSI-RS
The third P/SP/AP CSI-RS
The fourth P/SP/AP CSI-RS
The first and the second P/SP/AP CSI-RSs
The first and the third P/SP/AP CSI-RSs
The first and the fourth P/SP/AP CSI-RSs
The first, second and third P/SP/AP CSI-RSs
The first, second and fourth P/SP/AP CSI-RSs
The first, third and fourth P/SP/AP CSI-RSs
The second and the third P/SP/AP CSI-RSs
The second and the fourth P/SP/AP CSI-RSs
The second, third and fourth P/SP/AP CSI-RSs
The third and fourth P/SP/AP CSI-RSs
The first, second, third and fourth P/SP/AP CSI-RSs

As specified herein in the present disclosure, the group of P/SP/AP CSI-RS(s) could be: (i) determined according to fixed rule(s)/value(s) in system specification(s), (ii) provided/indicated/updated/configured by the network, e.g., via higher layer RRC signaling(s)/parameter(s) and/or MAC CE command(s) and/or dynamic DCI based L1 signaling(s), and/or (iii) autonomously determined by the UE, which could be further sent to the network, e.g., via/in part of a CSI/beam report and/or UE's capability signaling(s). For instance, the UE could be indicated/provided/configured by the network, e.g., via higher layer RRC signaling(s)/parameter(s) and/or MAC CE command(s) and/or dynamic DCI based L1 signaling(s), a bitmap with the first entry/bit position of the bitmap corresponding/associated to the first P/SP/AP CSI-RS (i.e., the first CMR), the second entry/bit position of the bitmap corresponding/associated to the second P/SP/AP CSI-RS (i.e., the second CMR), the third entry/bit position of the bitmap corresponding/associated to the third P/SP/AP CSI-RS (i.e., the third CMR), and the fourth entry/bit position of the bitmap corresponding/associated to the fourth P/SP/AP CSI-RS (i.e., the fourth CMR). In this case, when/if an entry/bit position of the bitmap is set to ‘1’ (or ‘0’), the corresponding/associated P/SP/AP CSI-RS (i.e., the corresponding/associated CMR) is in the group of P/SP/AP CSI-RS(s) as specified herein in the present disclosure.

For example, the UE could expect that the QCL assumption(s) of the one indicated joint/DL TCI state for the PDSCH reception(s) is identical to/the same as the QCL assumption(s) of the configured joint/DL TCI state(s) for receiving the P/SP/AP CSI-RS(s) in the group of P/SP/AP CSI-RS(s) as specified herein in the present disclosure. That is, the UE could expect that the RS(s) provided/indicated in the one indicated joint/DL TCI state for the PDSCH reception(s) and the RS(s) provided/indicated in the configured joint/DL TCI state(s) for receiving the P/SP/AP CSI-RS(s) in the group of P/SP/AP CSI-RS(s) as specified herein in the present disclosure are QCL'ed. In this case, the UE could use/apply the one indicated joint/DL TCI state to the P/SP/AP CSI-RS(s) in the group and/or the PDSCH, and/or the UE could use/apply the configured joint/DL TCI state(s) to the corresponding first, second, third and/or fourth P/SP/AP CSI-RS(s) not in the group.

In one example, the group of P/SP/AP CSI-RS(s) as specified herein in the present disclosure could only comprise the first P/SP/AP CSI-RS. For this design example, the UE could expect that the QCL assumption(s) of the one indicated joint/DL TCI state for the PDSCH reception(s) is identical to/the same as the QCL assumption(s) of the first configured joint/DL TCI state for receiving the first P/SP/AP CSI-RS in the group as specified herein in the present disclosure. That is, the UE could expect that the RS(s) provided/indicated in the one indicated joint/DL TCI state for the PDSCH reception(s) and the RS(s) provided/indicated in the first configured joint/DL TCI state for receiving the first P/SP/AP CSI-RS in the group as specified herein in the present disclosure are QCL'ed. In this case, the UE could use/apply the one indicated joint/DL TCI state to the first P/SP/AP CSI-RS in the group and/or the PDSCH, and/or the UE could use/apply the second configured joint/DL TCI state to the second P/SP/AP CSI-RS, and/or the UE could use/apply the third configured joint/DL TCI state to the third P/SP/AP CSI-RS, and/or the UE could use/apply the fourth configured joint/DL TCI state to the fourth P/SP/AP CSI-RS, wherein the second, the third and the fourth P/SP/SP CSI-RSs are not in the group.

In another example, the group of P/SP/AP CSI-RS(s) as specified herein in the present disclosure could only comprise the first and the second P/SP/AP CSI-RSs. For this design example, the UE could expect that the QCL assumption(s) of the one indicated joint/DL TCI state for the PDSCH reception(s) is identical to/the same as the QCL assumption(s) of the first configured joint/DL TCI state for receiving the first P/SP/AP CSI-RS in the group and the QCL assumption(s) of the second configured joint/DL TCI state for receiving the second P/SP/AP CSI-RS in the group as specified herein in the present disclosure. That is, the UE could expect that the RS(s) provided/indicated in the one indicated joint/DL TCI state for the PDSCH reception(s) could be QCL'ed with the RS(s) provided/indicated in the first configured joint/DL TCI state for receiving the first P/SP/AP CSI-RS in the group as specified herein in the present disclosure and the RS(s) provided/indicated in the second configured joint/DL TCI state for receiving the second P/SP/AP CSI-RS in the group as specified herein in the present disclosure. In this case, the UE could use/apply the one indicated joint/DL TCI state to the first and the second P/SP/AP CSI-RSs in the group and/or the PDSCH, and/or the UE could use/apply the third configured joint/DL TCI state to the third P/SP/AP CSI-RS, and/or the UE could use/apply the fourth configured joint/DL TCI state to the fourth P/SP/AP CSI-RS, wherein the third and the fourth P/SP/SP CSI-RSs are not in the group.

In yet another example, with reference to FIG. 8, the group of P/SP/AP CSI-RS(s) as specified herein in the present disclosure could comprise the first, the second, the third and the fourth P/SP/AP CSI-RSs. For this design example, the UE could expect that the QCL assumption(s) of the one indicated joint/DL TCI state for the PDSCH reception(s) is identical to/the same as the QCL assumption(s) of the first configured joint/DL TCI state for receiving the first P/SP/AP CSI-RS in the group and the QCL assumption(s) of the second configured joint/DL TCI state for receiving the second P/SP/AP CSI-RS in the group and the QCL assumption(s) of the third configured joint/DL TCI state for receiving the third P/SP/AP CSI-RS in the group and the QCL assumption(s) of the fourth configured joint/DL TCI state for receiving the fourth P/SP/AP CSI-RS in the group as specified herein in the present disclosure. That is, the UE could expect that the RS(s) provided/indicated in the one indicated joint/DL TCI state for the PDSCH reception(s) could be QCL'ed with the RS(s) provided/indicated in the first configured joint/DL TCI state for receiving the first P/SP/AP CSI-RS in the group as specified herein in the present disclosure and the RS(s) provided/indicated in the second configured joint/DL TCI state for receiving the second P/SP/AP CSI-RS in the group as specified herein in the present disclosure and the RS(s) provided/indicated in the third configured joint/DL TCI state for receiving the third P/SP/AP CSI-RS in the group as specified herein in the present disclosure and the RS(s) provided/indicated in the fourth configured joint/DL TCI state for receiving the fourth P/SP/AP CSI-RS in the group as specified herein in the present disclosure. In this case, the UE could use/apply the one indicated joint/DL TCI state to the first, the second, the third and the fourth P/SP/AP CSI-RSs in the group and/or the PDSCH.

For another example, the association/mapping between the one indicated joint/DL TCI state for the PDSCH reception(s) and the first/second/third/fourth configured joint/DL TCI state(s) for receiving the first/second/third/fourth P/SP/AP CSI-RS(s), i.e., whether the UE could follow those specified herein in the present disclosure, e.g., follow those provided/specified in one or more examples described herein (and the corresponding sub-examples provided/described therein) to expect that the RS(s) provided/indicated in the one indicated joint/DL TCI state is QCL'ed with the RS(s) provided/indicated in the first configured joint/DL TCI state, and/or the RS(s) provided/indicated in the one indicated joint/DL TCI state is QCL'ed with the RS(s) provided/indicated in the second configured joint/DL TCI state, and/or the RS(s) provided/indicated in the one indicated joint/DL TCI state is QCL'ed with the RSs provided/indicated in the third configured joint/DL TCI state, and/or the RS(s) provided/indicated in the one indicated joint/DL TCI state is QCL'ed with the RSs provided/indicated in the fourth configured joint/DL TCI state, could be determined according to: (i) fixed rule(s)/value(s) specified/provided in system specification(s), (ii) network's configuration(s)/indication(s), e.g., via/in higher layer RRC signaling(s)/parameter(s) and/or MAC CE command(s) and/or dynamic DCI based L1 signaling(s), and/or (iii) UE's autonomous determination/selection, which could be further sent to the network, e.g., in/by part of a beam/CSI report and/or UE's capability signaling(s).

Yet for another example, RRC configuration(s) could be provided to the first, second, third and/or fourth P/SP/AP CSI-RS resource(s) in the group as specified herein in the present disclosure and/or a CSI resource set that configures/provides the first, second, third and/or fourth P/SP/AP CSI-RS resource(s) in the group. In this case, when/if the UE is configured with the RRC configuration(s) (e.g., set to ‘enabled’), and/or when/if the RRC configuration(s) is set to ‘0’ (or ‘1’) or ‘00’ (or ‘01’ or ‘10’ or ‘11’) or ‘first’ or ‘second’ or ‘both’, the UE could use/apply the one indicated joint/DL TCI state to the first, second, third and/or fourth P/SP/AP CSI-RS(s) in the group as specified herein in the present disclosure and/or the PDSCH, and/or the UE could use/apply the configured joint/DL TCI state(s) to the corresponding first, second, third and/or fourth P/SP/AP CSI-RS(s) not in the group; otherwise—e.g., one or more of the RRC configuration settings/values herein are not provided/configured/indicated/set, the UE could use/apply the first, the second, the third and the fourth configured joint/DL TCI states respectively to the first, the second, the third and the fourth P/SP/AP CSI-RSs.

In yet another example, the association/mapping between the one indicated joint/DL TCI state for the PDSCH reception(s) and the first and/or the second and/or the third and/or the fourth configured joint/DL TCI state(s) for receiving the first and/or the second and/or the third and/or the fourth P/SP/AP CSI-RS(s) as specified herein in the present disclosure—e.g., follow those specified in one or more examples described herein and their corresponding sub-examples in the present disclosure— could be applied/extended to M≥4 P/SP/AP CSI-RS(s) (or equivalently, M≥4 CMRs) in the group as specified herein in the present disclosure. In this case, the group of P/SP/AP CSI-RS(s)—or CMR(s)— could comprise any combination(s) of one, two, three, four, . . . , M out of the M≥4 P/SP/AP CSI-RS(s) (or equivalently, M≥4 CMRs).

In one embodiment, in a wireless communications system, e.g., for CJT operation (e.g., when/if a UE is configured by higher layer parameter cjtSchemePDSCH), under the unified TCI framework (e.g., when/if the UE is configured by higher layer parameter dl-OrJointTCI-StateList), the UE could be indicated with—e.g., via beam indication MAC CE/DCI as specified herein in the present disclosure—a first indicated TCI-State (e.g., a first indicated joint/DL TCI state) applied for first PDSCH reception(s) and a second indicated TCI-State (e.g., a second indicated joint/DL TCI state) applied for second PDSCH reception(s)—the first PDSCH reception(s) (or the first PDSCH(s)) and the second PDSCH reception(s) (or the second PDSCH(s)) could be the same/identical or different. In this case, see the following.

In one example, the UE could be configured/indicated/provided/activated/triggered by the network, e.g., via/in higher layer RRC signaling(s)/parameter(s)—e.g., via/in CSI-ResourceConfig, CSI-ReportConfig, CSI-AssociatedReportConfigInfo, and/or CSI-AperiodicTriggerState—and/or MAC CE command(s) and/or dynamic DCI based L1 signaling(s), a single P/SP/AP CSI-RS for channel measurement (i.e., a single CMR). The UE could be configured with—e.g., via higher layer RRC signaling(s)/parameter(s)—one TCI-State (e.g., one configured joint/DL TCI state) applied for receiving the P/SP/AP CSI-RS (i.e., the CMR).

For example, the UE could expect that the QCL assumption(s) of the first indicated joint/DL TCI state for the first PDSCH reception(s) is identical to/the same as the QCL assumption(s) of the one configured joint/DL TCI state for the P/SP/AP CSI-RS reception(s). That is, the UE could expect that the RS(s) provided/indicated in the first indicated joint/DL TCI state for the first PDSCH reception(s) and the RS(s) provided/indicated in the one configured joint/DL TCI state for the P/SP/AP CSI-RS reception(s) are QCL'ed. In this case, the UE could use/apply the first indicated joint/DL TCI state or the configured joint/DL TCI state to the P/SP/AP CSI-RS and/or the first PDSCH.

For another example, the UE could expect that the QCL assumption(s) of the second indicated joint/DL TCI state for the second PDSCH reception(s) is identical to/the same as the QCL assumption(s) of the one configured joint/DL TCI state for the P/SP/AP CSI-RS reception(s). That is, the UE could expect that the RS(s) provided/indicated in the second indicated joint/DL TCI state for the second PDSCH reception(s) and the RS(s) provided/indicated in the one configured joint/DL TCI state for the P/SP/AP CSI-RS reception(s) are QCL'ed. In this case, the UE could use/apply the second indicated joint/DL TCI state or the configured joint/DL TCI state to the P/SP/AP CSI-RS and/or the second PDSCH.

Yet for another example, the association/mapping between the first/second indicated joint/DL TCI state(s) for the first/second PDSCH reception(s) and the one configured joint/DL TCI state for receiving the P/SP/AP CSI-RS, i.e., whether the UE could follow those specified herein in the present disclosure, e.g., follow those provided/specified in one or more examples described herein to expect that the RS(s) provided/indicated in the first indicated joint/DL TCI state is QCL'ed with the RS(s) provided/indicated in the configured joint/DL TCI state, and/or follow those provided/specified in one or more examples described herein to expect that the RS(s) provided/indicated in the second indicated joint/DL TCI state is QCL'ed with the RS(s) provided/indicated in the configured joint/DL TCI state, could be determined according to: (i) fixed rule(s)/value(s) specified/provided in system specification(s), (ii) network's configuration(s)/indication(s), e.g., via/in higher layer RRC signaling(s)/parameter(s) and/or MAC CE command(s) and/or dynamic DCI based L1 signaling(s), and/or (iii) UE's autonomous determination/selection, which could be further sent to the network, e.g., in/by part of a beam/CSI report and/or UE's capability signaling(s). For instance, the UE could be indicated/provided/configured by the network, e.g., via higher layer RRC signaling(s)/parameter(s) and/or MAC CE command(s) and/or dynamic DCI based L1 signaling(s), a bitmap with the first entry/bit position of the bitmap corresponding/associated to the first indicated joint/DL TCI state for receiving the first PDSCH(s) and the second entry/bit position of the bitmap corresponding/associated to the second indicated joint/DL TCI state for receiving the second PDSCH(s); in this case, when/if the first entry/bit position of the bitmap is set to ‘1’ (or ‘0’), the UE could follow those provided/specified in one or more examples described herein to expect that the RS(s) provided/indicated in the first indicated joint/DL TCI state is QCL'ed with the RS(s) provided/indicated in the configured joint/DL TCI state, and/or when/if the second entry/bit position of the bitmap is set to ‘1’ (or ‘0’), the UE could follow those provided/specified in one or more examples described herein to expect that the RS(s) provided/indicated in the second indicated joint/DL TCI state is QCL'ed with the RS(s) provided/indicated in the configured joint/DL TCI state.

Yet for another example, an RRC configuration could be provided to the P/SP/AP CSI-RS resource and/or a CSI resource set that configures/provides the P/SP/AP CSI-RS resource. In this case, when/if the UE is configured with the RRC configuration (e.g., set to ‘enabled’), and/or when/if the RRC configuration is set to ‘0’ (or ‘1’) or ‘00’ (or ‘01’ or ‘10’ or ‘11’) or ‘first’ (or ‘both’), the UE could use/apply the first indicated joint/DL TCI state to the P/SP/AP CSI-RS and/or the first PDSCH; otherwise—e.g., one or more of the RRC configuration settings/values herein are not provided/configured/indicated/set, the UE could use/apply the configured joint/DL TCI state to the P/SP/AP CSI-RS.

Yet for another example, an RRC configuration could be provided to the P/SP/AP CSI-RS resource and/or a CSI resource set that configures/provides the P/SP/AP CSI-RS resource. In this case, when/if the UE is configured with the RRC configuration (e.g., set to ‘enabled’), and/or when/if the RRC configuration is set to ‘1’ (or ‘0’) or ‘01’ (or ‘00’ or ‘10’ or ‘11’) or ‘second’ (or ‘both’), the UE could use/apply the second indicated joint/DL TCI state to the P/SP/AP CSI-RS and/or the second PDSCH; otherwise—e.g., one or more of the RRC configuration settings/values herein are not provided/configured/indicated/set, the UE could use/apply the configured joint/DL TCI state to the P/SP/AP CSI-RS.

In another example, the UE could be configured/indicated/provided/activated/triggered by the network, e.g., via/in higher layer RRC signaling(s)/parameter(s)—e.g., via/in CSI-ResourceConfig, CSI-ReportConfig, CSI-AssociatedReportConfigInfo, and/or CSI-AperiodicTriggerState—and/or MAC CE command(s) and/or dynamic DCI based L1 signaling(s), a first P/SP/AP CSI-RS and a second P/SP/AP CSI-RS for channel measurement (i.e., a first CMR and a second CMR). The UE could be configured with—e.g., via higher layer RRC signaling(s)/parameter(s)—a first TCI-State (e.g., a first configured joint/DL TCI state) applied for receiving the first P/SP/AP CSI-RS (i.e., the first CMR) and a second TCI-State (e.g., a second configured joint/DL TCI state) applied for receiving the second P/SP/AP CSI-RS (i.e., the second CMR). The first TCI-State (e.g., the first configured joint/DL TCI state)—and therefore, the RS(s) provided/indicated therein— could be identical to/the same as the second TCI-State (e.g., the second configured joint/DL TCI state)—and therefore, the RS(s) provided/indicated therein.

For example, the UE could expect that the QCL assumption(s) of the first indicated joint/DL TCI state for the first PDSCH reception(s) is identical to/the same as the QCL assumption(s) of the first configured joint/DL TCI state for receiving the first P/SP/AP CSI-RS. That is, the UE could expect that the RS(s) provided/indicated in the first indicated joint/DL TCI state for the first PDSCH reception(s) and the RS(s) provided/indicated in the first configured joint/DL TCI state for receiving the first P/SP/AP CSI-RS are QCL'ed. In this case, the UE could use/apply the first indicated joint/DL TCI state to the first P/SP/AP CSI-RS and/or the first PDSCH, and/or the UE could use/apply the second configured joint/DL TCI state to the second P/SP/AP CSI-RS.

For another example, the UE could expect that the QCL assumption(s) of the first indicated joint/DL TCI state for the first PDSCH reception(s) is identical to/the same as the QCL assumption(s) of the second configured joint/DL TCI state for receiving the second P/SP/AP CSI-RS. That is, the UE could expect that the RS(s) provided/indicated in the first indicated joint/DL TCI state for the first PDSCH reception(s) and the RS(s) provided/indicated in the second configured joint/DL TCI state for receiving the second P/SP/AP CSI-RS are QCL'ed. In this case, the UE could use/apply the first indicated joint/DL TCI state to the second P/SP/AP CSI-RS and/or the first PDSCH, and/or the UE could use/apply the first configured joint/DL TCI state to the first P/SP/AP CSI-RS.

Yet for another example, the UE could expect that the QCL assumption(s) of the first indicated joint/DL TCI state for the first PDSCH reception(s) is identical to/the same as the QCL assumption(s) of the first configured joint/DL TCI state for receiving the first P/SP/AP CSI-RS and the QCL assumption(s) of the second configured joint/DL TCI state for receiving the second P/SP/AP CSI-RS. That is, the UE could expect that the RS(s) provided/indicated in the first indicated joint/DL TCI state for the first PDSCH reception(s) and the RS(s) provided/indicated in the first configured joint/DL TCI state for receiving the first P/SP/AP CSI-RS and the second configured joint/DL TCI state for receiving the second P/SP/AP CSI-RS are QCL'ed. In this case, the UE could use/apply the first indicated joint/DL TCI state to the first P/SP/AP CSI-RS and the second P/SP/AP CSI-RS and/or the PDSCH.

For the described/specified design examples herein (e.g., according to one or more examples described herein) in the present disclosure, when/if a P/SP/SP CSI-RS (a CMR)—e.g., the first or the second P/SP/AP CSI-RS (the first or the second CMR)—is not applied with the first indicated joint/DL TCI state, the UE could expect that the QCL assumption(s) of the second indicated joint/DL TCI state for the second PDSCH reception(s) is identical to/the same as the QCL assumption(s) of the (first or second) configured joint/DL TCI state for receiving the (first or second) P/SP/AP CSI-RS. That is, the UE could expect that the RS(s) provided/indicated in the second indicated joint/DL TCI state for the second PDSCH reception(s) and the RS(s) provided/indicated in the (first or second) configured joint/DL TCI state for receiving the (first or second) P/SP/AP CSI-RS are QCL'ed. In this case, the UE could use/apply the second indicated joint/DL TCI state to the (first or second) P/SP/AP CSI-RS and/or the second PDSCH.

Yet for another example, the UE could expect that the QCL assumption(s) of the second indicated joint/DL TCI state for the second PDSCH reception(s) is identical to/the same as the QCL assumption(s) of the first configured joint/DL TCI state for receiving the first P/SP/AP CSI-RS. That is, the UE could expect that the RS(s) provided/indicated in the second indicated joint/DL TCI state for the second PDSCH reception(s) and the RS(s) provided/indicated in the first configured joint/DL TCI state for receiving the first P/SP/AP CSI-RS are QCL'ed. In this case, the UE could use/apply the second indicated joint/DL TCI state to the first P/SP/AP CSI-RS and/or the second PDSCH, and/or the UE could use/apply the second configured joint/DL TCI state to the second P/SP/AP CSI-RS.

For another example, the UE could expect that the QCL assumption(s) of the second indicated joint/DL TCI state for the second PDSCH reception(s) is identical to/the same as the QCL assumption(s) of the second configured joint/DL TCI state for receiving the second P/SP/AP CSI-RS. That is, the UE could expect that the RS(s) provided/indicated in the second indicated joint/DL TCI state for the second PDSCH reception(s) and the RS(s) provided/indicated in the second configured joint/DL TCI state for receiving the second P/SP/AP CSI-RS are QCL'ed. In this case, the UE could use/apply the second indicated joint/DL TCI state to the second P/SP/AP CSI-RS and/or the second PDSCH, and/or the UE could use/apply the first configured joint/DL TCI state to the first P/SP/AP CSI-RS.

Yet for another example, the UE could expect that the QCL assumption(s) of the second indicated joint/DL TCI state for the second PDSCH reception(s) is identical to/the same as the QCL assumption(s) of the first configured joint/DL TCI state for receiving the first P/SP/AP CSI-RS and the QCL assumption(s) of the second configured joint/DL TCI state for receiving the second P/SP/AP CSI-RS. That is, the UE could expect that the RS(s) provided/indicated in the second indicated joint/DL TCI state for the second PDSCH reception(s) and the RS(s) provided/indicated in the first configured joint/DL TCI state for receiving the first P/SP/AP CSI-RS and the second configured joint/DL TCI state for receiving the second P/SP/AP CSI-RS are QCL'ed. In this case, the UE could use/apply the second indicated joint/DL TCI state to the first P/SP/AP CSI-RS and the second P/SP/AP CSI-RS and/or the PDSCH.

For the described/specified design examples herein (e.g., according to one or more examples described herein) in the present disclosure, when/if a P/SP/SP CSI-RS (a CMR)—e.g., the first or the second P/SP/AP CSI-RS (the first or the second CMR)—is not applied with the second indicated joint/DL TCI state, the UE could expect that the QCL assumption(s) of the first indicated joint/DL TCI state for the first PDSCH reception(s) is identical to/the same as the QCL assumption(s) of the (first or second) configured joint/DL TCI state for receiving the (first or second) P/SP/AP CSI-RS. That is, the UE could expect that the RS(s) provided/indicated in the first indicated joint/DL TCI state for the first PDSCH reception(s) and the RS(s) provided/indicated in the (first or second) configured joint/DL TCI state for receiving the (first or second) P/SP/AP CSI-RS are QCL'ed. In this case, the UE could use/apply the first indicated joint/DL TCI state to the (first or second) P/SP/AP CSI-RS and/or the first PDSCH.

Yet for another example, the association/mapping between the first/second indicated joint/DL TCI state(s) for the first/second PDSCH reception(s) and the first/second configured joint/DL TCI state(s) for receiving the first/second P/SP/AP CSI-RS(s), i.e., whether the UE could follow those specified herein in the present disclosure, e.g., follow those provided/specified in one or more examples described herein to expect that the RS(s) provided/indicated in the first/second indicated joint/DL TCI state is QCL'ed with the RS(s) provided/indicated in the first configured joint/DL TCI state, and/or follow those provided/specified in one or more examples described herein to expect that the RS(s) provided/indicated in the first/second indicated joint/DL TCI state is QCL'ed with the RS(s) provided/indicated in the second configured joint/DL TCI state, and/or follow those provided/specified in one or more examples described herein to expect that the RS(s) provided/indicated in the first/second indicated joint/DL TCI state is QCL'ed with the RSs provided/indicated in both of the first and the second configured joint/DL TCI states, could be determined according to: (i) fixed rule(s)/value(s) specified/provided in system specification(s), (ii) network's configuration(s)/indication(s), e.g., via/in higher layer RRC signaling(s)/parameter(s) and/or MAC CE command(s) and/or dynamic DCI based L1 signaling(s), and/or (iii) UE's autonomous determination/selection, which could be further sent to the network, e.g., in/by part of a beam/CSI report and/or UE's capability signaling(s). For instance, the UE (e.g., the UE 116) could be indicated/provided/configured by the network, e.g., via higher layer RRC signaling(s)/parameter(s) and/or MAC CE command(s) and/or dynamic DCI based L1 signaling(s), a first bitmap with the first entry/bit position of the first bitmap corresponding/associated to the first P/SP/AP CSI-RS (i.e., the first CMR), and the second entry/bit position of the first bitmap corresponding/associated to the second P/SP/AP CSI-RS (i.e., the second CMR); in this case, when/if the first entry/bit position of the first bitmap is set to ‘1’ (or ‘0’), the UE could follow those provided/specified in one or more examples described herein to expect that the RS(s) provided/indicated in the first indicated joint/DL TCI state is QCL'ed with the RS(s) provided/indicated in the first configured joint/DL TCI state, and/or when/if the second entry/bit position of the first bitmap is set to ‘1’ (or ‘0’), the UE could follow those provided/specified in one or more examples described herein to expect that the RS(s) provided/indicated in the first indicated joint/DL TCI state is QCL'ed with the RS(s) provided/indicated in the second configured joint/DL TCI state, and/or when/if the first entry/bit position of the first bitmap is set to ‘1’ (or ‘0’) and the second entry/bit position of the first bitmap is set to ‘1’ (or ‘0’), the UE could follow those provided/specified in one or more examples described herein to expect that the RS(s) provided/indicated in the first indicated joint/DL TCI state is QCL'ed with the RS(s) provided/indicated in the first configured joint/DL TCI state and the RS(s) provided/indicated in the second configured joint/DL TCI state. Furthermore, the UE could be indicated/provided/configured by the network, e.g., via higher layer RRC signaling(s)/parameter(s) and/or MAC CE command(s) and/or dynamic DCI based L1 signaling(s), a second bitmap with the first entry/bit position of the second bitmap corresponding/associated to the first P/SP/AP CSI-RS (i.e., the first CMR), and the second entry/bit position of the second bitmap corresponding/associated to the second P/SP/AP CSI-RS (i.e., the second CMR); in this case, when/if the first entry/bit position of the second bitmap is set to ‘1’ (or ‘0’), the UE could follow those provided/specified in one or more examples described herein to expect that the RS(s) provided/indicated in the second indicated joint/DL TCI state is QCL'ed with the RS(s) provided/indicated in the first configured joint/DL TCI state, and/or when/if the second entry/bit position of the second bitmap is set to ‘1’ (or ‘0’), the UE could follow those provided/specified in one or more examples described herein to expect that the RS(s) provided/indicated in the second indicated joint/DL TCI state is QCL'ed with the RS(s) provided/indicated in the second configured joint/DL TCI state, and/or when/if the first entry/bit position of the second bitmap is set to ‘1’ (or ‘0’) and the second entry/bit position of the second bitmap is set to ‘1’ (or ‘0’), the UE could follow those provided/specified in one or more examples described herein to expect that the RS(s) provided/indicated in the second indicated joint/DL TCI state is QCL'ed with the RS(s) provided/indicated in the first configured joint/DL TCI state and the RS(s) provided/indicated in the second configured joint/DL TCI state.

Yet for another example, an RRC configuration could be provided to the first P/SP/AP CSI-RS resource and/or a CSI resource set that configures/provides the first P/SP/AP CSI-RS resource. In this case, when/if the UE is configured with the RRC configuration (e.g., set to ‘enabled’), and/or when/if the RRC configuration is set to ‘0’ (or ‘1’) or ‘00’ (or ‘01’ or ‘10’ or ‘11’) or ‘first’ (or ‘both’), the UE could use/apply the first indicated joint/DL TCI state to the first P/SP/AP CSI-RS and/or the first PDSCH; otherwise—e.g., one or more of the RRC configuration settings/values herein are not provided/configured/indicated/set, the UE could use/apply the configured joint/DL TCI state or the second indicated joint/DL TCI state to the first P/SP/AP CSI-RS. And/or, when/if the UE is configured with the RRC configuration (e.g., set to ‘enabled’), and/or when/if the RRC configuration is set to ‘1’ (or ‘0’) or ‘01’ (or ‘00’ or ‘10’ or ‘11’) or ‘second’ (or ‘both’), the UE could use/apply the second indicated joint/DL TCI state to the first P/SP/AP CSI-RS and/or the second PDSCH; otherwise—e.g., one or more of the RRC configuration settings/values herein are not provided/configured/indicated/set, the UE could use/apply the configured joint/DL TCI state or the first indicated joint/DL TCI state to the first P/SP/AP CSI-RS.

Yet for another example, an RRC configuration could be provided to the second P/SP/AP CSI-RS resource and/or a CSI resource set that configures/provides the second P/SP/AP CSI-RS resource. In this case, when/if the UE is configured with the RRC configuration (e.g., set to ‘enabled’), and/or when/if the RRC configuration is set to ‘0’ (or ‘1’) or ‘00’ (or ‘01’ or ‘10’ or ‘11’) or ‘first’ (or ‘both’), the UE could use/apply the first indicated joint/DL TCI state to the second P/SP/AP CSI-RS and/or the first PDSCH; otherwise—e.g., one or more of the RRC configuration settings/values herein are not provided/configured/indicated/set, the UE could use/apply the configured joint/DL TCI state or the second indicated joint/DL TCI state to the second P/SP/AP CSI-RS. And/or, when/if the UE is configured with the RRC configuration (e.g., set to ‘enabled’), and/or when/if the RRC configuration is set to ‘1’ (or ‘0’) or ‘01’ (or ‘00’ or ‘10’ or ‘11’) or ‘second’ (or ‘both’), the UE could use/apply the second indicated joint/DL TCI state to the second P/SP/AP CSI-RS and/or the second PDSCH; otherwise—e.g., one or more of the RRC configuration settings/values herein are not provided/configured/indicated/set, the UE could use/apply the configured joint/DL TCI state or the first indicated joint/DL TCI state to the second P/SP/AP CSI-RS.

Yet for another example, a first RRC configuration could be provided to the first P/SP/AP CSI-RS resource and/or a CSI resource set that configures/provides the first P/SP/AP CSI-RS resource, and a second RRC configuration could be provided to the second P/SP/AP CSI-RS resource and/or a CSI resource set that configures/provides the second P/SP/AP CSI-RS resource. In this case, when/if the UE is configured with the first RRC configuration (e.g., set to ‘enabled’), and/or when/if the UE is configured with the second RRC configuration (e.g., set to ‘enabled’), and/or when/if the first RRC configuration is set to ‘0’ (or ‘1’) or ‘00’ (or ‘01’ or ‘10’ or ‘11’) or ‘first’ (or ‘both’), and/or when/if the second RRC configuration is set to ‘0’ (or ‘1’) or ‘00’ (or ‘01’ or ‘10’ or ‘11’) or ‘first’ (or ‘both’), the UE could use/apply the first indicated joint/DL TCI state to the first and/or the second P/SP/AP CSI-RS(s) and/or the first PDSCH(s); otherwise—e.g., one or more of the RRC configuration settings/values herein are not provided/configured/indicated/set, the UE could use/apply the first and the second configured joint/DL TCI states respectively to the first and the second P/SP/AP CSI-RSs. And/or, when/if the UE is configured with the first RRC configuration (e.g., set to ‘enabled’), and/or when/if the UE is configured with the second RRC configuration (e.g., set to ‘enabled’), and/or when/if the first RRC configuration is set to ‘1’ (or ‘0’) or ‘01’ (or ‘00’ or ‘10’ or ‘11’) or ‘second’ (or ‘both’), and/or when/if the second RRC configuration is set to ‘1’ (or ‘0’) or ‘01’ (or ‘00’ or ‘10’ or ‘11’) or ‘second’ (or ‘both’), the UE could use/apply the second indicated joint/DL TCI state to the first and/or the second P/SP/AP CSI-RS(s) and/or the second PDSCH(s); otherwise—e.g., one or more of the RRC configuration settings/values herein are not provided/configured/indicated/set, the UE could use/apply the first and the second configured joint/DL TCI states respectively to the first and the second P/SP/AP CSI-RSs.

In yet another example, the UE could be configured/indicated/provided/activated/triggered by the network, e.g., via/in higher layer RRC signaling(s)/parameter(s)—e.g., via/in CSI-ResourceConfig, CSI-ReportConfig, CSI-AssociatedReportConfigInfo, and/or CSI-AperiodicTriggerState—and/or MAC CE command(s) and/or dynamic DCI based L1 signaling(s), a first P/SP/AP CSI-RS, a second P/SP/AP CSI-RS and a third P/SP/AP CSI-RS for channel measurement (i.e., a first CMR, a second CMR and a third CMR). The ULE could be configured with—e.g., via higher layer RRC signaling(s)/parameter(s)—a first TCI-State (e.g., a first configured joint/DL TCI state) applied for receiving the first P/SP/AP CSI-RS (i.e., the first CMR), a second TCI-State (e.g., a second configured joint/DL TCI state) applied for receiving the second P/SP/AP CSI-RS (i.e., the second CMR), and a third TCI-State (e.g., a third configured joint/DL TCI state) applied for receiving the third P/SP/AP CSI-RS (i.e., the third CMR). The first TCI-State (e.g., the first configured joint/DL TCI state)—and therefore, the RS(s) provided/indicated therein, the second TCI-State (e.g., the second configured joint/DL TCI state)—and therefore, the RS(s) provided/indicated therein, and/or the third TCI-State (e.g., the third configured joint/DL TCI state)—and therefore, the RS(s) provided/indicated therein, could be identical/the same. The UE could be indicated/configured/provided by the network, e.g., via higher layer RRC signaling(s)/parameter(s) and/or MAC CE command(s) and/or dynamic DCI based L1 signaling(s), a first group of P/SP/AP CSI-RS(s) comprising the first P/SP/AP CSI-RS and/or the second P/SP/AP CSI-RS and/or the third P/SP/AP CSI-RS as specified herein in the present disclosure. In particular, the first group of P/SP/AP CSI-RS(s) could comprise at least one of:
The first P/SP/AP CSI-RS
The second P/SP/AP CSI-RS
The third P/SP/AP CSI-RS
The first and the second P/SP/AP CSI-RSs
The first and the third P/SP/AP CSI-RSs
The second and the third P/SP/AP CSI-RSs
The first, second and third P/SP/AP CSI-RSs

For this design example/case, the first P/SP/AP CSI-RS (i.e., the first CMR) and/or the second P/SP/AP CSI-RS (i.e., the second CMR) and/or the third P/SP/AP CSI-RS (i.e., the third CMR) that is/are not in the first group could be in a second group of P/SP/AP CSI-RS(s). As specified herein in the present disclosure, the first group and/or the second group of P/SP/AP CSI-RSs (or CMRs) could be: (i) determined according to fixed rule(s)/value(s) in system specification(s), (ii) provided/indicated/updated/configured by the network, e.g., via higher layer RRC signaling(s)/parameter(s) and/or MAC CE command(s) and/or dynamic DCI based L1 signaling(s), and/or (iii) autonomously determined by the UE, which could be further sent to the network, e.g., via/in part of a CSI/beam report and/or UE's capability signaling(s). For instance, the UE could be indicated/provided/configured by the network, e.g., via higher layer RRC signaling(s)/parameter(s) and/or MAC CE command(s) and/or dynamic DCI based L1 signaling(s), a bitmap with the first entry/bit position of the bitmap corresponding/associated to the first P/SP/AP CSI-RS (i.e., the first CMR), the second entry/bit position of the bitmap corresponding/associated to the second P/SP/AP CSI-RS (i.e., the second CMR), and the third entry/bit position of the bitmap corresponding/associated to the third P/SP/AP CSI-RS (i.e., the third CMR). In this case, when/if an entry/bit position of the bitmap is set to ‘1’ (or ‘0’), the corresponding/associated P/SP/AP CSI-RS (i.e., the corresponding/associated CMR) is in the first (or second) group of P/SP/AP CSI-RS(s) as specified herein in the present disclosure, and/or when/if an entry/bit position of the bitmap is set to ‘0’ (or ‘1’), the corresponding/associated P/SP/AP CSI-RS (i.e., the corresponding/associated CMR) is in the second (or first) group of P/SP/AP CSI-RS(s).

For example, the UE could expect that the QCL assumption(s) of the first indicated joint/DL TCI state for the first PDSCH reception(s) is identical to/the same as the QCL assumption(s) of the configured joint/DL TCI state(s) for receiving the P/SP/AP CSI-RS(s) in the first group of P/SP/AP CSI-RS(s) as specified herein in the present disclosure; that is, the UE could expect that the RS(s) provided/indicated in the first indicated joint/DL TCI state for the first PDSCH reception(s) and the RS(s) provided/indicated in the configured joint/DL TCI state(s) for receiving the P/SP/AP CSI-RS(s) in the first group of P/SP/AP CSI-RS(s) as specified herein in the present disclosure are QCL'ed; in this case, the UE could use/apply the first indicated joint/DL TCI state to the P/SP/AP CSI-RS(s) in the first group and/or the first PDSCH, and/or the UE could use/apply the configured joint/DL TCI state(s) to the corresponding first, second and/or third P/SP/AP CSI-RS(s) not in the first group or in the second group as specified herein in the present disclosure, and/or the UE could expect that the QCL assumption(s) of the second indicated joint/DL TCI state for the second PDSCH reception(s) is identical to/the same as the QCL assumption(s) of the configured joint/DL TCI state(s) for receiving the P/SP/AP CSI-RS(s) in the second group of P/SP/AP CSI-RS(s); that is, the UE could expect that the RS(s) provided/indicated in the second indicated joint/DL TCI state for the second PDSCH reception(s) and the RS(s) provided/indicated in the configured joint/DL TCI state(s) for receiving the P/SP/AP CSI-RS(s) in the second group of P/SP/AP CSI-RS(s) as specified herein in the present disclosure are QCL'ed; in this case, the UE could use/apply the second indicated joint/DL TCI state to the P/SP/AP CSI-RS(s) in the second group and/or the second PDSCH.

In one example, the first group of P/SP/AP CSI-RS(s) as specified herein in the present disclosure could only comprise the first P/SP/AP CSI-RS. In this case, the second group of P/SP/AP CSI-RS(s) as specified herein in the present disclosure could comprise the second and the third P/SP/AP CSI-RSs. For this design example, the UE could expect that the QCL assumption(s) of the first indicated joint/DL TCI state for the first PDSCH reception(s) is identical to/the same as the QCL assumption(s) of the first configured joint/DL TCI state for receiving the first P/SP/AP CSI-RS in the first group as specified herein in the present disclosure. That is, the UE could expect that the RS(s) provided/indicated in the first indicated joint/DL TCI state for the first PDSCH reception(s) and the RS(s) provided/indicated in the first configured joint/DL TCI state for receiving the first P/SP/AP CSI-RS in the first group as specified herein in the present disclosure are QCL'ed. In this case, the UE could use/apply the first indicated joint/DL TCI state to the first P/SP/AP CSI-RS in the first group and/or the first PDSCH. Furthermore, the UE could expect that the QCL assumption(s) of the second indicated joint/DL TCI state for the second PDSCH reception(s) is identical to/the same as the QCL assumption(s) of the second configured joint/DL TCI state for receiving the second P/SP/AP CSI-RS in the second group and the QCL assumption(s) of the third configured joint/DL TCI state for receiving the third P/SP/AP CSI-RS in the second group as specified herein in the present disclosure. That is, the UE could expect that the RS(s) provided/indicated in the second indicated joint/DL TCI state for the second PDSCH reception(s) could be QCL'ed with the RS(s) provided/indicated in the second configured joint/DL TCI state for receiving the second P/SP/AP CSI-RS in the second group as specified herein in the present disclosure and the RS(s) provided/indicated in the third configured joint/DL TCI state for receiving the third P/SP/AP CSI-RS in the second group as specified herein in the present disclosure. In this case, the UE could use/apply the second indicated joint/DL TCI state to the second and the third P/SP/AP CSI-RSs in the second group and/or the second PDSCH.

In another example, the first group of P/SP/AP CSI-RS(s) as specified herein in the present disclosure could only comprise the first and the second P/SP/AP CSI-RSs. In this case, the second group of P/SP/AP CSI-RS(s) as specified herein in the present disclosure could only comprise the third P/SP/AP CSI-RS. For this design example, the UE could expect that the QCL assumption(s) of the first indicated joint/DL TCI state for the first PDSCH reception(s) is identical to/the same as the QCL assumption(s) of the first configured joint/DL TCI state for receiving the first P/SP/AP CSI-RS in the first group and the QCL assumption(s) of the second configured joint/DL TCI state for receiving the second P/SP/AP CSI-RS in the first group as specified herein in the present disclosure. That is, the UE could expect that the RS(s) provided/indicated in the first indicated joint/DL TCI state for the first PDSCH reception(s) could be QCL'ed with the RS(s) provided/indicated in the first configured joint/DL TCI state for receiving the first P/SP/AP CSI-RS in the first group as specified herein in the present disclosure and the RS(s) provided/indicated in the second configured joint/DL TCI state for receiving the second P/SP/AP CSI-RS in the first group as specified herein in the present disclosure. In this case, the UE could use/apply the first indicated joint/DL TCI state to the first and the second P/SP/AP CSI-RSs in the first group and/or the first PDSCH. Furthermore, the UE could expect that the QCL assumption(s) of the second indicated joint/DL TCI state for the second PDSCH reception(s) is identical to/the same as the QCL assumption(s) of the third configured joint/DL TCI state for receiving the third P/SP/AP CSI-RS in the second group as specified herein in the present disclosure. That is, the UE could expect that the RS(s) provided/indicated in the second indicated joint/DL TCI state for the second PDSCH reception(s) could be QCL'ed with the RS(s) provided/indicated in the third configured joint/DL TCI state for receiving the third P/SP/AP CSI-RS in the second group as specified herein in the present disclosure. In this case, the UE could use/apply the second indicated joint/DL TCI state to the third P/SP/AP CSI-RS in the second group and/or the second PDSCH.

In yet another example, the first group of P/SP/AP CSI-RS(s) as specified herein in the present disclosure could comprise the first, the second and the third P/SP/AP CSI-RSs. For this design example, the UE could expect that the QCL assumption(s) of the first indicated joint/DL TCI state for the first PDSCH reception(s) is identical to/the same as the QCL assumption(s) of the first configured joint/DL TCI state for receiving the first P/SP/AP CSI-RS in the first group and the QCL assumption(s) of the second configured joint/DL TCI state for receiving the second P/SP/AP CSI-RS in the first group and the QCL assumption(s) of the third configured joint/DL TCI state for receiving the third P/SP/AP CSI-RS in the first group as specified herein in the present disclosure. That is, the UE could expect that the RS(s) provided/indicated in the first indicated joint/DL TCI state for the first PDSCH reception(s) could be QCL'ed with the RS(s) provided/indicated in the first configured joint/DL TCI state for receiving the first P/SP/AP CSI-RS in the first group as specified herein in the present disclosure and the RS(s) provided/indicated in the second configured joint/DL TCI state for receiving the second P/SP/AP CSI-RS in the first group as specified herein in the present disclosure and the RS(s) provided/indicated in the third configured joint/DL TCI state for receiving the third P/SP/AP CSI-RS in the first group as specified herein in the present disclosure. In this case, the UE could use/apply the first indicated joint/DL TCI state to the first, the second and the third P/SP/AP CSI-RSs in the first group and/or the first PDSCH.

For another example, the UE could expect that the QCL assumption(s) of the second indicated joint/DL TCI state for the second PDSCH reception(s) is identical to/the same as the QCL assumption(s) of the configured joint/DL TCI state(s) for receiving the P/SP/AP CSI-RS(s) in the first group of P/SP/AP CSI-RS(s) as specified herein in the present disclosure; that is, the UE could expect that the RS(s) provided/indicated in the second indicated joint/DL TCI state for the second PDSCH reception(s) and the RS(s) provided/indicated in the configured joint/DL TCI state(s) for receiving the P/SP/AP CSI-RS(s) in the first group of P/SP/AP CSI-RS(s) as specified herein in the present disclosure are QCL'ed; in this case, the UE could use/apply the second indicated joint/DL TCI state to the P/SP/AP CSI-RS(s) in the first group and/or the second PDSCH, and/or the UE could use/apply the configured joint/DL TCI state(s) to the corresponding first, second and/or third P/SP/AP CSI-RS(s) not in the first group or in the second group as specified herein in the present disclosure, and/or the UE could expect that the QCL assumption(s) of the first indicated joint/DL TCI state for the first PDSCH reception(s) is identical to/the same as the QCL assumption(s) of the configured joint/DL TCI state(s) for receiving the P/SP/AP CSI-RS(s) in the second group of P/SP/AP CSI-RS(s); that is, the UE could expect that the RS(s) provided/indicated in the first indicated joint/DL TCI state for the first PDSCH reception(s) and the RS(s) provided/indicated in the configured joint/DL TCI state(s) for receiving the P/SP/AP CSI-RS(s) in the second group of P/SP/AP CSI-RS(s) as specified herein in the present disclosure are QCL'ed; in this case, the UE could use/apply the first indicated joint/DL TCI state to the P/SP/AP CSI-RS(s) in the second group and/or the first PDSCH.

In one example, the first group of P/SP/AP CSI-RS(s) as specified herein in the present disclosure could only comprise the first P/SP/AP CSI-RS—in this case, the second group of P/SP/AP CSI-RS(s) as specified herein in the present disclosure could comprise the second and the third P/SP/AP CSI-RSs. For this design example, the UE could expect that the QCL assumption(s) of the second indicated joint/DL TCI state for the second PDSCH reception(s) is identical to/the same as the QCL assumption(s) of the first configured joint/DL TCI state for receiving the first P/SP/AP CSI-RS in the first group as specified herein in the present disclosure. That is, the UE could expect that the RS(s) provided/indicated in the second indicated joint/DL TCI state for the second PDSCH reception(s) and the RS(s) provided/indicated in the first configured joint/DL TCI state for receiving the first P/SP/AP CSI-RS in the first group as specified herein in the present disclosure are QCL'ed. In this case, the UE could use/apply the second indicated joint/DL TCI state to the first P/SP/AP CSI-RS in the first group and/or the second PDSCH. Furthermore, the UE could expect that the QCL assumption(s) of the first indicated joint/DL TCI state for the first PDSCH reception(s) is identical to/the same as the QCL assumption(s) of the second configured joint/DL TCI state for receiving the second P/SP/AP CSI-RS in the second group and the QCL assumption(s) of the third configured joint/DL TCI state for receiving the third P/SP/AP CSI-RS in the second group as specified herein in the present disclosure. That is, the UE could expect that the RS(s) provided/indicated in the first indicated joint/DL TCI state for the first PDSCH reception(s) could be QCL'ed with the RS(s) provided/indicated in the second configured joint/DL TCI state for receiving the second P/SP/AP CSI-RS in the second group as specified herein in the present disclosure and the RS(s) provided/indicated in the third configured joint/DL TCI state for receiving the third P/SP/AP CSI-RS in the second group as specified herein in the present disclosure. In this case, the UE could use/apply the first indicated joint/DL TCI state to the second and the third P/SP/AP CSI-RSs in the second group and/or the first PDSCH.

In another example, the first group of P/SP/AP CSI-RS(s) as specified herein in the present disclosure could only comprise the first and the second P/SP/AP CSI-RSs. In this case, the second group of P/SP/AP CSI-RS(s) as specified herein in the present disclosure could only comprise the third P/SP/AP CSI-RS. For this design example, the UE could expect that the QCL assumption(s) of the second indicated joint/DL TCI state for the second PDSCH reception(s) is identical to/the same as the QCL assumption(s) of the first configured joint/DL TCI state for receiving the first P/SP/AP CSI-RS in the first group and the QCL assumption(s) of the second configured joint/DL TCI state for receiving the second P/SP/AP CSI-RS in the first group as specified herein in the present disclosure. That is, the UE could expect that the RS(s) provided/indicated in the second indicated joint/DL TCI state for the second PDSCH reception(s) could be QCL'ed with the RS(s) provided/indicated in the first configured joint/DL TCI state for receiving the first P/SP/AP CSI-RS in the first group as specified herein in the present disclosure and the RS(s) provided/indicated in the second configured joint/DL TCI state for receiving the second P/SP/AP CSI-RS in the first group as specified herein in the present disclosure. In this case, the UE could use/apply the second indicated joint/DL TCI state to the first and the second P/SP/AP CSI-RSs in the first group and/or the second PDSCH. Furthermore, the UE could expect that the QCL assumption(s) of the first indicated joint/DL TCI state for the first PDSCH reception(s) is identical to/the same as the QCL assumption(s) of the third configured joint/DL TCI state for receiving the third P/SP/AP CSI-RS in the second group as specified herein in the present disclosure. That is, the UE could expect that the RS(s) provided/indicated in the first indicated joint/DL TCI state for the first PDSCH reception(s) could be QCL'ed with the RS(s) provided/indicated in the third configured joint/DL TCI state for receiving the third P/SP/AP CSI-RS in the second group as specified herein in the present disclosure. In this case, the UE could use/apply the first indicated joint/DL TCI state to the third P/SP/AP CSI-RS in the second group and/or the first PDSCH.

In yet another example, the first group of P/SP/AP CSI-RS(s) as specified herein in the present disclosure could comprise the first, the second and the third P/SP/AP CSI-RSs. For this design example, the UE could expect that the QCL assumption(s) of the second indicated joint/DL TCI state for the second PDSCH reception(s) is identical to/the same as the QCL assumption(s) of the first configured joint/DL TCI state for receiving the first P/SP/AP CSI-RS in the first group and the QCL assumption(s) of the second configured joint/DL TCI state for receiving the second P/SP/AP CSI-RS in the first group and the QCL assumption(s) of the third configured joint/DL TCI state for receiving the third P/SP/AP CSI-RS in the first group as specified herein in the present disclosure. That is, the UE could expect that the RS(s) provided/indicated in the second indicated joint/DL TCI state for the second PDSCH reception(s) could be QCL'ed with the RS(s) provided/indicated in the first configured joint/DL TCI state for receiving the first P/SP/AP CSI-RS in the first group as specified herein in the present disclosure and the RS(s) provided/indicated in the second configured joint/DL TCI state for receiving the second P/SP/AP CSI-RS in the first group as specified herein in the present disclosure and the RS(s) provided/indicated in the third configured joint/DL TCI state for receiving the third P/SP/AP CSI-RS in the first group as specified herein in the present disclosure. In this case, the UE could use/apply the second indicated joint/DL TCI state to the first, the second and the third P/SP/AP CSI-RSs in the first group and/or the second PDSCH.

Yet for another example, the association/mapping between the first/second indicated joint/DL TCI state(s) for the first/second PDSCH reception(s) and the first/second/third configured joint/DL TCI state(s) for receiving the first/second/third P/SP/AP CSI-RS(s) in the first/second group as specified herein in the present disclosure, i.e., whether the UE could follow those specified herein in the present disclosure, e.g., follow those provided/specified in one or more examples described herein (and the corresponding sub-examples provided/indicated therein) to expect that the RS(s) provided/indicated in the first (or second) indicated joint/DL TCI state is QCL'ed with the RS(s) provided/indicated in the configured joint/DL TCI state(s) for the P/AP/SP CSI-RS(s) in the first (or second) group as specified herein in the present disclosure, and/or follow those provided/specified in one or more examples described herein (and the corresponding sub-examples provided/indicated therein) to expect that the RS(s) provided/indicated in the second (or first) indicated joint/DL TCI state is QCL'ed with the RS(s) provided/indicated in the configured joint/DL TCI state(s) for the P/AP/SP CSI-RS(s) in the first (or second) group as specified herein in the present disclosure, could be determined according to: (i) fixed rule(s)/value(s) specified/provided in system specification(s), (ii) network's configuration(s)/indication(s), e.g., via/in higher layer RRC signaling(s)/parameter(s) and/or MAC CE command(s) and/or dynamic DCI based L1 signaling(s), and/or (iii) UE's autonomous determination/selection, which could be further sent to the network, e.g., in/by part of a beam/CSI report and/or UE's capability signaling(s). For instance, the UE could be indicated/provided/configured by the network, e.g., via higher layer RRC signaling(s)/parameter(s) and/or MAC CE command(s) and/or dynamic DCI based L1 signaling(s), a first bitmap with the first entry/bit position of the first bitmap corresponding/associated to the first group of P/SP/AP CSI-RS(s) (i.e., the first group of CMR(s)), and the second entry/bit position of the first bitmap corresponding/associated to the second group of P/SP/AP CSI-RS(s) (i.e., the second group of CMR(s)); in this case, when/if the first entry/bit position of the first bitmap is set to ‘1’ (or ‘0’), the UE could follow those provided/specified in one or more examples described herein to expect that the RS(s) provided/indicated in the first indicated joint/DL TCI state is QCL'ed with the RS(s) provided/indicated in the configured joint/DL TCI state(s) for the first group of P/SP/AP CSI-RS(s), and/or when/if the second entry/bit position of the first bitmap is set to ‘1’ (or ‘0’), the UE could follow those provided/specified in one or more examples described herein to expect that the RS(s) provided/indicated in the first indicated joint/DL TCI state is QCL'ed with the RS(s) provided/indicated in the configured joint/DL TCI state(s) for the second group of P/SP/AP CSI-RS(s), and/or when/if the first entry/bit position of the first bitmap is set to ‘1’ (or ‘0’) and the second entry/bit position of the first bitmap is set to ‘1’ (or ‘0’), the UE could follow those provided/specified in one or more examples described herein to expect that the RS(s) provided/indicated in the first indicated joint/DL TCI state is QCL'ed with the RS(s) provided/indicated in the configured joint/DL TCI state(s) for the first group of P/SP/AP CSI-RS(s) and the RS(s) provided/indicated in the configured joint/DL TCI state(s) for the second group of P/SP/AP CSI-RS(s). Furthermore, the UE could be indicated/provided/configured by the network, e.g., via higher layer RRC signaling(s)/parameter(s) and/or MAC CE command(s) and/or dynamic DCI based L1 signaling(s), a second bitmap with the first entry/bit position of the second bitmap corresponding/associated to the first group of P/SP/AP CSI-RS(s) (i.e., the first group of CMR(s)), and the second entry/bit position of the second bitmap corresponding/associated to the second group of P/SP/AP CSI-RS(s) (i.e., the second group of CMR(s)); in this case, when/if the first entry/bit position of the second bitmap is set to ‘1’ (or ‘0’), the UE could follow those provided/specified in the one or more examples described herein to expect that the RS(s) provided/indicated in the second indicated joint/DL TCI state is QCL'ed with the RS(s) provided/indicated in the configured joint/DL TCI state(s) for the first group of P/SP/AP CSI-RS(s), and/or when/if the second entry/bit position of the second bitmap is set to ‘1’ (or ‘0’), the UE could follow those provided/specified in one or more examples described herein to expect that the RS(s) provided/indicated in the second indicated joint/DL TCI state is QCL'ed with the RS(s) provided/indicated in the configured joint/DL TCI state(s) for the second group of P/SP/AP CSI-RS(s), and/or when/if the first entry/bit position of the second bitmap is set to ‘1’ (or ‘0’) and the second entry/bit position of the second bitmap is set to ‘1’ (or ‘0’), the UE could follow those provided/specified in one or more examples described herein to expect that the RS(s) provided/indicated in the second indicated joint/DL TCI state is QCL'ed with the RS(s) provided/indicated in the configured joint/DL TCI state(s) for the first group of P/SP/AP CSI-RS(s) and the RS(s) provided/indicated in the configured joint/DL TCI state(s) for the second group of P/SP/AP CSI-RS(s).

Yet for another example, an RRC configuration could be provided to the first and/or second and/or third P/SP/AP CSI-RS resource(s) in the first group and/or a CSI resource set that configures/provides the first and/or second and/or third P/SP/AP CSI-RS resource(s) in the first group as specified herein in the present disclosure. In this case, when/if the UE is configured with the RRC configuration (e.g., set to ‘enabled’), and/or when/if the RRC configuration is set to ‘0’ (or ‘1’) or ‘00’ (or ‘01’ or ‘10’ or ‘11’) or ‘first’ (or ‘both’), the UE could use/apply the first indicated joint/DL TCI state to the first and/or second and/or third P/SP/AP CSI-RS(s) in the first group and/or the first PDSCH; otherwise—e.g., one or more of the RRC configuration settings/values herein are not provided/configured/indicated/set, the UE could use/apply the configured joint/DL TCI state(s) or the second indicated joint/DL TCI state to the first and/or second and/or third P/SP/AP CSI-RS(s) in the first group. And/or, when/if the UE is configured with the RRC configuration (e.g., set to ‘enabled’), and/or when/if the RRC configuration is set to ‘1’ (or ‘O’) or ‘01’ (or ‘00’ or ‘10’ or ‘11’) or ‘second’ (or ‘both’), the UE could use/apply the second indicated joint/DL TCI state to the first and/or second and/or third P/SP/AP CSI-RS(s) in the first group and/or the second PDSCH; otherwise—e.g., one or more of the RRC configuration settings/values herein are not provided/configured/indicated/set, the UE could use/apply the configured joint/DL TCI state(s) or the first indicated joint/DL TCI state to the first and/or second and/or third P/SP/AP CSI-RS(s) in the first group.

Yet for another example, an RRC configuration could be provided to the first and/or second and/or third P/SP/AP CSI-RS resource(s) in the second group and/or a CSI resource set that configures/provides the first and/or second and/or third P/SP/AP CSI-RS resource(s) in the second group as specified herein in the present disclosure. In this case, when/if the UE is configured with the RRC configuration (e.g., set to ‘enabled’), and/or when/if the RRC configuration is set to ‘0’ (or ‘1’) or ‘00’ (or ‘01’ or ‘10’ or ‘11’) or ‘first’ (or ‘both’), the UE could use/apply the first indicated joint/DL TCI state to the first and/or second and/or third P/SP/AP CSI-RS(s) in the second group and/or the first PDSCH; otherwise—e.g., one or more of the RRC configuration settings/values herein are not provided/configured/indicated/set, the UE could use/apply the configured joint/DL TCI state(s) or the second indicated joint/DL TCI state to the first and/or second and/or third P/SP/AP CSI-RS(s) in the second group. And/or, when/if the UE is configured with the RRC configuration (e.g., set to ‘enabled’), and/or when/if the RRC configuration is set to ‘1’ (or ‘0’) or ‘01’ (or ‘00’ or ‘10’ or ‘11’) or ‘second’ (or ‘both’), the UE could use/apply the second indicated joint/DL TCI state to the first and/or second and/or third P/SP/AP CSI-RS(s) in the second group and/or the second PDSCH; otherwise—e.g., one or more of the RRC configuration settings/values herein are not provided/configured/indicated/set, the UE could use/apply the configured joint/DL TCI state(s) or the first indicated joint/DL TCI state to the first and/or second and/or third P/SP/AP CSI-RS(s) in the second group.

Yet for another example, a first RRC configuration could be provided to the first and/or second and/or third P/SP/AP CSI-RS resource(s) in the first group and/or a CSI resource set that configures/provides the first and/or second and/or third P/SP/AP CSI-RS resource(s) in the first group, and a second RRC configuration could be provided to the first and/or second and/or third P/SP/AP CSI-RS resource(s) in the second group and/or a CSI resource set that configures/provides the first and/or second and/or third P/SP/AP CSI-RS resource(s) in the second group. In this case, when/if the UE is configured with the first RRC configuration (e.g., set to ‘enabled’), and/or when/if the UE is configured with the second RRC configuration (e.g., set to ‘enabled’), and/or when/if the first RRC configuration is set to ‘0’ (or ‘1’) or ‘00’ (or ‘01’ or ‘10’ or ‘11’) or ‘first’ (or ‘both’), and/or when/if the second RRC configuration is set to ‘0’ (or ‘1’) or ‘00’ (or ‘01’ or ‘10’ or ‘11’) or ‘first’ (or ‘both’), the UE could use/apply the first indicated joint/DL TCI state to the P/SP/AP CSI-RS(s) in the first and/or second group(s) as specified herein in the present disclosure and/or the first PDSCH(s); otherwise—e.g., one or more of the RRC configuration settings/values herein are not provided/configured/indicated/set, the UE could use/apply the configured joint/DL TCI state(s) for the P/SP/AP CSI-RSs in the first and/or second group(s) as specified herein in the present disclosure. And/or, when/if the UE is configured with the first RRC configuration (e.g., set to ‘enabled’), and/or when/if the UE is configured with the second RRC configuration (e.g., set to ‘enabled’), and/or when/if the first RRC configuration is set to ‘1’ (or ‘0’) or ‘01’ (or ‘00’ or ‘10’ or ‘11’) or ‘second’ (or ‘both’), and/or when/if the second RRC configuration is set to ‘1’ (or ‘0’) or ‘01’ (or ‘00’ or ‘10’ or ‘11’) or ‘second’ (or ‘both’), the UE could use/apply the second indicated joint/DL TCI state to the P/SP/AP CSI-RS(s) in the first and/or second group(s) as specified herein in the present disclosure and/or the second PDSCH(s); otherwise—e.g., one or more of the RRC configuration settings/values herein are not provided/configured/indicated/set, the UE could use/apply the configured joint/DL TCI state(s) for the P/SP/AP CSI-RSs in the first and/or second group(s) as specified herein in the present disclosure.

FIG. 9 illustrates a diagram of an example association/mapping 900 between first/second indicated TCI states for PDSCH-CJT and first/second CMR group configured for CJT according to embodiments of the present disclosure. For example, association/mapping 900 may be referenced by any of the UEs 111-116 of FIG. 1, such as the UE 116 of FIG. 3. This example is for illustration only and other embodiments can be used without departing from the scope of the present disclosure.

In yet another example, the association/mapping between the first/second indicated joint/DL TCI state(s) for the first/second PDSCH reception(s) and the first and/or the second and/or the third configured joint/DL TCI state(s) for receiving the first and/or the second and/or the third P/SP/AP CSI-RS(s) in the first/second group(s) as specified herein in the present disclosure—e.g., follow those specified in one or more examples described herein and their corresponding sub-examples in the present disclosure— could be applied/extended to M=4 P/SP/AP CSI-RSs (or equivalently, M=4 CMRs) in the first and/or second group(s) as specified herein in the present disclosure. In this case, the first group of P/SP/AP CSI-RS(s)—or CMR(s)— could comprise any combination(s) of one, two, three, four out of the M=4 P/SP/AP CSI-RSs (or equivalently, M=4 CMRs), and the second group of P/SP/AP CSI-RS(s)—or CMR(s)— could comprise the first and/or second and/or third and/or fourth P/SP/AP CSI-RS(s) not in the first group. More specifically, the UE (e.g., the UE 116) could be configured/indicated/provided/activated/triggered by the network, e.g., via/in higher layer RRC signaling(s)/parameter(s)—e.g., via/in CSI-ResourceConfig, CSI-ReportConfig, CSI-AssociatedReportConfigInfo, and/or CSI-AperiodicTriggerState—and/or MAC CE command(s) and/or dynamic DCI based L1 signaling(s), a first P/SP/AP CSI-RS, a second P/SP/AP CSI-RS, a third P/SP/AP CSI-RS, and a fourth P/SP/AP CSI-RS for channel measurement (i.e., a first CMR, a second CMR, a third CMR and a fourth CMR). The UE could be configured with—e.g., via higher layer RRC signaling(s)/parameter(s)—a first TCI-State (e.g., a first configured joint/DL TCI state) applied for receiving the first P/SP/AP CSI-RS (i.e., the first CMR), a second TCI-State (e.g., a second configured joint/DL TCI state) applied for receiving the second P/SP/AP CSI-RS (i.e., the second CMR), a third TCI-State (e.g., a third configured joint/DL TCI state) applied for receiving the third P/SP/AP CSI-RS (i.e., the third CMR), and a fourth TCI-State (e.g., a fourth configured joint/DL TCI state) applied for receiving the fourth P/SP/AP CSI-RS (i.e., the fourth CMR). The first TCI-State (e.g., the first configured joint/DL TCI state)—and therefore, the RS(s) provided/indicated therein, the second TCI-State (e.g., the second configured joint/DL TCI state)—and therefore, the RS(s) provided/indicated therein, the third TCI-State (e.g., the third configured joint/DL TCI state)—and therefore, the RS(s) provided/indicated therein, and/or the fourth TCI-State (e.g., the fourth configured joint/DL TCI state)—and therefore, the RS(s) provided/indicated therein, could be identical/the same. The UE could be indicated/configured/provided by the network, e.g., via higher layer RRC signaling(s)/parameter(s) and/or MAC CE command(s) and/or dynamic DCI based L1 signaling(s), a first group of P/SP/AP CSI-RS(s) comprising the first P/SP/AP CSI-RS and/or the second P/SP/AP CSI-RS and/or the third P/SP/AP CSI-RS and/or the fourth P/SP/AP CSI-RS as specified herein in the present disclosure. In particular, the first group of P/SP/AP CSI-RS(s) could comprise at least one of:
The first P/SP/AP CSI-RS
The second P/SP/AP CSI-RS
The third P/SP/AP CSI-RS
The fourth P/SP/AP CSI-RS
The first and the second P/SP/AP CSI-RSs
The first and the third P/SP/AP CSI-RSs
The first and the fourth P/SP/AP CSI-RSs
The first, second and third P/SP/AP CSI-RSs
The first, second and fourth P/SP/AP CSI-RSs
The first, third and fourth P/SP/AP CSI-RSs
The second and the third P/SP/AP CSI-RSs
The second and the fourth P/SP/AP CSI-RSs
The second, third and fourth P/SP/AP CSI-RSs
The third and fourth P/SP/AP CSI-RSs
The first, second, third and fourth P/SP/AP CSI-RSs

For this design example/case, the first P/SP/AP CSI-RS (i.e., the first CMR) and/or the second P/SP/AP CSI-RS (i.e., the second CMR) and/or the third P/SP/AP CSI-RS (i.e., the third CMR) and/or the fourth P/SP/AP CSI-RS (i.e., the fourth CMR) that is/are not in the first group could be in a second group of P/SP/AP CSI-RS(s). As specified herein in the present disclosure, the first group and/or the second group of P/SP/AP CSI-RSs (or CMRs) could be: (i) determined according to fixed rule(s)/value(s) in system specification(s), (ii) provided/indicated/updated/configured by the network, e.g., via higher layer RRC signaling(s)/parameter(s) and/or MAC CE command(s) and/or dynamic DCI based L1 signaling(s), and/or (iii) autonomously determined by the UE, which could be further sent to the network, e.g., via/in part of a CSI/beam report and/or UE's capability signaling(s). For instance, the UE could be indicated/provided/configured by the network, e.g., via higher layer RRC signaling(s)/parameter(s) and/or MAC CE command(s) and/or dynamic DCI based L1 signaling(s), a bitmap with the first entry/bit position of the bitmap corresponding/associated to the first P/SP/AP CSI-RS (i.e., the first CMR), the second entry/bit position of the bitmap corresponding/associated to the second P/SP/AP CSI-RS (i.e., the second CMR), the third entry/bit position of the bitmap corresponding/associated to the third P/SP/AP CSI-RS (i.e., the third CMR), and the fourth entry/bit position of the bitmap corresponding/associated to the fourth P/SP/AP CSI-RS (i.e., the fourth CMR). In this case, when/if an entry/bit position of the bitmap is set to ‘1’ (or ‘0’), the corresponding/associated P/SP/AP CSI-RS (i.e., the corresponding/associated CMR) is in the first (or second) group of P/SP/AP CSI-RS(s) as specified herein in the present disclosure, and/or when/if an entry/bit position of the bitmap is set to ‘0’ (or ‘1’), the corresponding/associated P/SP/AP CSI-RS (i.e., the corresponding/associated CMR) is in the second (or first) group of P/SP/AP CSI-RS(s).

For example, the UE could expect that the QCL assumption(s) of the first indicated joint/DL TCI state for the first PDSCH reception(s) is identical to/the same as the QCL assumption(s) of the configured joint/DL TCI state(s) for receiving the P/SP/AP CSI-RS(s) in the first group of P/SP/AP CSI-RS(s) as specified herein in the present disclosure; that is, the UE could expect that the RS(s) provided/indicated in the first indicated joint/DL TCI state for the first PDSCH reception(s) and the RS(s) provided/indicated in the configured joint/DL TCI state(s) for receiving the P/SP/AP CSI-RS(s) in the first group of P/SP/AP CSI-RS(s) as specified herein in the present disclosure are QCL'ed; in this case, the UE could use/apply the first indicated joint/DL TCI state to the P/SP/AP CSI-RS(s) in the first group and/or the first PDSCH, and/or the UE could use/apply the configured joint/DL TCI state(s) to the corresponding first, second, third and/or fourth P/SP/AP CSI-RS(s) not in the first group or in the second group as specified herein in the present disclosure, and/or the UE could expect that the QCL assumption(s) of the second indicated joint/DL TCI state for the second PDSCH reception(s) is identical to/the same as the QCL assumption(s) of the configured joint/DL TCI state(s) for receiving the P/SP/AP CSI-RS(s) in the second group of P/SP/AP CSI-RS(s); that is, the UE could expect that the RS(s) provided/indicated in the second indicated joint/DL TCI state for the second PDSCH reception(s) and the RS(s) provided/indicated in the configured joint/DL TCI state(s) for receiving the P/SP/AP CSI-RS(s) in the second group of P/SP/AP CSI-RS(s) as specified herein in the present disclosure are QCL'ed; in this case, the UE could use/apply the second indicated joint/DL TCI state to the P/SP/AP CSI-RS(s) in the second group and/or the second PDSCH.

In one example, the first group of P/SP/AP CSI-RS(s) as specified herein in the present disclosure could only comprise the first P/SP/AP CSI-RS—in this case, the second group of P/SP/AP CSI-RS(s) as specified herein in the present disclosure could comprise the second, the third and the fourth P/SP/AP CSI-RSs. For this design example, the UE could expect that the QCL assumption(s) of the first indicated joint/DL TCI state for the first PDSCH reception(s) is identical to/the same as the QCL assumption(s) of the first configured joint/DL TCI state for receiving the first P/SP/AP CSI-RS in the first group as specified herein in the present disclosure. That is, the UE could expect that the RS(s) provided/indicated in the first indicated joint/DL TCI state for the first PDSCH reception(s) and the RS(s) provided/indicated in the first configured joint/DL TCI state for receiving the first P/SP/AP CSI-RS in the first group as specified herein in the present disclosure are QCL'ed. In this case, the UE could use/apply the first indicated joint/DL TCI state to the first P/SP/AP CSI-RS in the first group and/or the first PDSCH. Furthermore, the UE could expect that the QCL assumption(s) of the second indicated joint/DL TCI state for the second PDSCH reception(s) is identical to/the same as the QCL assumption(s) of the second configured joint/DL TCI state for receiving the second P/SP/AP CSI-RS in the second group and the QCL assumption(s) of the third configured joint/DL TCI state for receiving the third P/SP/AP CSI-RS in the second group as specified herein in the present disclosure and the QCL assumption(s) of the fourth configured joint/DL TCI state for receiving the fourth P/SP/AP CSI-RS in the second group as specified herein in the present disclosure. That is, the UE could expect that the RS(s) provided/indicated in the second indicated joint/DL TCI state for the second PDSCH reception(s) could be QCL'ed with the RS(s) provided/indicated in the second configured joint/DL TCI state for receiving the second P/SP/AP CSI-RS in the second group as specified herein in the present disclosure and the RS(s) provided/indicated in the third configured joint/DL TCI state for receiving the third P/SP/AP CSI-RS in the second group as specified herein in the present disclosure and the RS(s) provided/indicated in the fourth configured joint/DL TCI state for receiving the fourth P/SP/AP CSI-RS in the second group as specified herein in the present disclosure. In this case, the UE could use/apply the second indicated joint/DL TCI state to the second, the third and the fourth P/SP/AP CSI-RSs in the second group and/or the second PDSCH.

In another example, with reference to FIG. 9, the first group of P/SP/AP CSI-RS(s) as specified herein in the present disclosure could only comprise the first and the second P/SP/AP CSI-RSs—in this case, the second group of P/SP/AP CSI-RS(s) as specified herein in the present disclosure could comprise the third and the fourth P/SP/AP CSI-RSs. For this design example, the UE could expect that the QCL assumption(s) of the first indicated joint/DL TCI state for the first PDSCH reception(s) is identical to/the same as the QCL assumption(s) of the first configured joint/DL TCI state for receiving the first P/SP/AP CSI-RS in the first group and the QCL assumption(s) of the second configured joint/DL TCI state for receiving the second P/SP/AP CSI-RS in the first group as specified herein in the present disclosure. That is, the UE could expect that the RS(s) provided/indicated in the first indicated joint/DL TCI state for the first PDSCH reception(s) could be QCL'ed with the RS(s) provided/indicated in the first configured joint/DL TCI state for receiving the first P/SP/AP CSI-RS in the first group as specified herein in the present disclosure and the RS(s) provided/indicated in the second configured joint/DL TCI state for receiving the second P/SP/AP CSI-RS in the first group as specified herein in the present disclosure. In this case, the UE could use/apply the first indicated joint/DL TCI state to the first and the second P/SP/AP CSI-RSs in the first group and/or the first PDSCH. Furthermore, the UE could expect that the QCL assumption(s) of the second indicated joint/DL TCI state for the second PDSCH reception(s) is identical to/the same as the QCL assumption(s) of the third configured joint/DL TCI state for receiving the third P/SP/AP CSI-RS in the second group as specified herein in the present disclosure and the QCL assumption(s) of the fourth configured joint/DL TCI state for receiving the fourth P/SP/AP CSI-RS in the second group as specified herein in the present disclosure. That is, the UE could expect that the RS(s) provided/indicated in the second indicated joint/DL TCI state for the second PDSCH reception(s) could be QCL'ed with the RS(s) provided/indicated in the third configured joint/DL TCI state for receiving the third P/SP/AP CSI-RS in the second group as specified herein in the present disclosure and the RS(s) provided/indicated in the fourth configured joint/DL TCI state for receiving the fourth P/SP/AP CSI-RS in the second group as specified herein in the present disclosure. In this case, the UE could use/apply the second indicated joint/DL TCI state to the third and the fourth P/SP/AP CSI-RSs in the second group and/or the second PDSCH.

In yet another example, the first group of P/SP/AP CSI-RS(s) as specified herein in the present disclosure could comprise the first, the second, the third and the fourth P/SP/AP CSI-RSs. For this design example, the UE could expect that the QCL assumption(s) of the first indicated joint/DL TCI state for the first PDSCH reception(s) is identical to/the same as the QCL assumption(s) of the first configured joint/DL TCI state for receiving the first P/SP/AP CSI-RS in the first group and the QCL assumption(s) of the second configured joint/DL TCI state for receiving the second P/SP/AP CSI-RS in the first group and the QCL assumption(s) of the third configured joint/DL TCI state for receiving the third P/SP/AP CSI-RS in the first group and the QCL assumption(s) of the fourth configured joint/DL TCI state for receiving the fourth P/SP/AP CSI-RS in the first group as specified herein in the present disclosure. That is, the UE could expect that the RS(s) provided/indicated in the first indicated joint/DL TCI state for the first PDSCH reception(s) could be QCL'ed with the RS(s) provided/indicated in the first configured joint/DL TCI state for receiving the first P/SP/AP CSI-RS in the first group as specified herein in the present disclosure and the RS(s) provided/indicated in the second configured joint/DL TCI state for receiving the second P/SP/AP CSI-RS in the first group as specified herein in the present disclosure and the RS(s) provided/indicated in the third configured joint/DL TCI state for receiving the third P/SP/AP CSI-RS in the first group as specified herein in the present disclosure and the RS(s) provided/indicated in the fourth configured joint/DL TCI state for receiving the fourth P/SP/AP CSI-RS in the first group as specified herein in the present disclosure. In this case, the UE could use/apply the first indicated joint/DL TCI state to the first, the second, the third and the fourth P/SP/AP CSI-RSs in the first group and/or the first PDSCH.

For another example, the UE could expect that the QCL assumption(s) of the second indicated joint/DL TCI state for the second PDSCH reception(s) is identical to/the same as the QCL assumption(s) of the configured joint/DL TCI state(s) for receiving the P/SP/AP CSI-RS(s) in the first group of P/SP/AP CSI-RS(s) as specified herein in the present disclosure; that is, the UE could expect that the RS(s) provided/indicated in the second indicated joint/DL TCI state for the second PDSCH reception(s) and the RS(s) provided/indicated in the configured joint/DL TCI state(s) for receiving the P/SP/AP CSI-RS(s) in the first group of P/SP/AP CSI-RS(s) as specified herein in the present disclosure are QCL'ed; in this case, the UE could use/apply the second indicated joint/DL TCI state to the P/SP/AP CSI-RS(s) in the first group and/or the second PDSCH, and/or the UE could use/apply the configured joint/DL TCI state(s) to the corresponding first, second, third and/or fourth P/SP/AP CSI-RS(s) not in the first group or in the second group as specified herein in the present disclosure, and/or the UE could expect that the QCL assumption(s) of the first indicated joint/DL TCI state for the first PDSCH reception(s) is identical to/the same as the QCL assumption(s) of the configured joint/DL TCI state(s) for receiving the P/SP/AP CSI-RS(s) in the second group of P/SP/AP CSI-RS(s); that is, the UE could expect that the RS(s) provided/indicated in the first indicated joint/DL TCI state for the first PDSCH reception(s) and the RS(s) provided/indicated in the configured joint/DL TCI state(s) for receiving the P/SP/AP CSI-RS(s) in the second group of P/SP/AP CSI-RS(s) as specified herein in the present disclosure are QCL'ed; in this case, the UE could use/apply the first indicated joint/DL TCI state to the P/SP/AP CSI-RS(s) in the second group and/or the first PDSCH.

In one example, the first group of P/SP/AP CSI-RS(s) as specified herein in the present disclosure could only comprise the first P/SP/AP CSI-RS. In this case, the second group of P/SP/AP CSI-RS(s) as specified herein in the present disclosure could comprise the second, the third and the fourth P/SP/AP CSI-RSs. For this design example, the UE could expect that the QCL assumption(s) of the second indicated joint/DL TCI state for the second PDSCH reception(s) is identical to/the same as the QCL assumption(s) of the first configured joint/DL TCI state for receiving the first P/SP/AP CSI-RS in the first group as specified herein in the present disclosure. That is, the UE could expect that the RS(s) provided/indicated in the second indicated joint/DL TCI state for the second PDSCH reception(s) and the RS(s) provided/indicated in the first configured joint/DL TCI state for receiving the first P/SP/AP CSI-RS in the first group as specified herein in the present disclosure are QCL'ed. In this case, the UE could use/apply the second indicated joint/DL TCI state to the first P/SP/AP CSI-RS in the first group and/or the second PDSCH. Furthermore, the UE could expect that the QCL assumption(s) of the first indicated joint/DL TCI state for the first PDSCH reception(s) is identical to/the same as the QCL assumption(s) of the second configured joint/DL TCI state for receiving the second P/SP/AP CSI-RS in the second group and the QCL assumption(s) of the third configured joint/DL TCI state for receiving the third P/SP/AP CSI-RS in the second group and the QCL assumption(s) of the fourth configured joint/DL TCI state for receiving the fourth P/SP/AP CSI-RS in the second group as specified herein in the present disclosure. That is, the UE could expect that the RS(s) provided/indicated in the first indicated joint/DL TCI state for the first PDSCH reception(s) could be QCL'ed with the RS(s) provided/indicated in the second configured joint/DL TCI state for receiving the second P/SP/AP CSI-RS in the second group as specified herein in the present disclosure and the RS(s) provided/indicated in the third configured joint/DL TCI state for receiving the third P/SP/AP CSI-RS in the second group as specified herein in the present disclosure and the RS(s) provided/indicated in the fourth configured joint/DL TCI state for receiving the fourth P/SP/AP CSI-RS in the second group as specified herein in the present disclosure. In this case, the UE could use/apply the first indicated joint/DL TCI state to the second, the third and the fourth P/SP/AP CSI-RSs in the second group and/or the first PDSCH.

In another example, the first group of P/SP/AP CSI-RS(s) as specified herein in the present disclosure could only comprise the first and the second P/SP/AP CSI-RSs—in this case, the second group of P/SP/AP CSI-RS(s) as specified herein in the present disclosure could comprise the third and the fourth P/SP/AP CSI-RSs. For this design example, the UE could expect that the QCL assumption(s) of the second indicated joint/DL TCI state for the second PDSCH reception(s) is identical to/the same as the QCL assumption(s) of the first configured joint/DL TCI state for receiving the first P/SP/AP CSI-RS in the first group and the QCL assumption(s) of the second configured joint/DL TCI state for receiving the second P/SP/AP CSI-RS in the first group as specified herein in the present disclosure. That is, the UE could expect that the RS(s) provided/indicated in the second indicated joint/DL TCI state for the second PDSCH reception(s) could be QCL'ed with the RS(s) provided/indicated in the first configured joint/DL TCI state for receiving the first P/SP/AP CSI-RS in the first group as specified herein in the present disclosure and the RS(s) provided/indicated in the second configured joint/DL TCI state for receiving the second P/SP/AP CSI-RS in the first group as specified herein in the present disclosure. In this case, the UE could use/apply the second indicated joint/DL TCI state to the first and the second P/SP/AP CSI-RSs in the first group and/or the second PDSCH. Furthermore, the UE could expect that the QCL assumption(s) of the first indicated joint/DL TCI state for the first PDSCH reception(s) is identical to/the same as the QCL assumption(s) of the third configured joint/DL TCI state for receiving the third P/SP/AP CSI-RS in the second group and the QCL assumption(s) of the fourth configured joint/DL TCI state for receiving the fourth P/SP/AP CSI-RS in the second group as specified herein in the present disclosure. That is, the UE could expect that the RS(s) provided/indicated in the first indicated joint/DL TCI state for the first PDSCH reception(s) could be QCL'ed with the RS(s) provided/indicated in the third configured joint/DL TCI state for receiving the third P/SP/AP CSI-RS in the second group as specified herein in the present disclosure and the RS(s) provided/indicated in the fourth configured joint/DL TCI state for receiving the fourth P/SP/AP CSI-RS in the second group as specified herein in the present disclosure. In this case, the UE could use/apply the first indicated joint/DL TCI state to the third and the fourth P/SP/AP CSI-RSs in the second group and/or the first PDSCH.

In yet another example, the first group of P/SP/AP CSI-RS(s) as specified herein in the present disclosure could comprise the first, the second, the third and the fourth P/SP/AP CSI-RSs. For this design example, the UE could expect that the QCL assumption(s) of the second indicated joint/DL TCI state for the second PDSCH reception(s) is identical to/the same as the QCL assumption(s) of the first configured joint/DL TCI state for receiving the first P/SP/AP CSI-RS in the first group and the QCL assumption(s) of the second configured joint/DL TCI state for receiving the second P/SP/AP CSI-RS in the first group and the QCL assumption(s) of the third configured joint/DL TCI state for receiving the third P/SP/AP CSI-RS in the first group and the QCL assumption(s) of the fourth configured joint/DL TCI state for receiving the fourth P/SP/AP CSI-RS in the first group as specified herein in the present disclosure. That is, the UE could expect that the RS(s) provided/indicated in the second indicated joint/DL TCI state for the second PDSCH reception(s) could be QCL'ed with the RS(s) provided/indicated in the first configured joint/DL TCI state for receiving the first P/SP/AP CSI-RS in the first group as specified herein in the present disclosure and the RS(s) provided/indicated in the second configured joint/DL TCI state for receiving the second P/SP/AP CSI-RS in the first group as specified herein in the present disclosure and the RS(s) provided/indicated in the third configured joint/DL TCI state for receiving the third P/SP/AP CSI-RS in the first group as specified herein in the present disclosure and the RS(s) provided/indicated in the fourth configured joint/DL TCI state for receiving the fourth P/SP/AP CSI-RS in the first group as specified herein in the present disclosure. In this case, the UE could use/apply the second indicated joint/DL TCI state to the first, the second, the third and the fourth P/SP/AP CSI-RSs in the first group and/or the second PDSCH.

Yet for another example, the association/mapping between the first/second indicated joint/DL TCI state(s) for the first/second PDSCH reception(s) and the first/second/third/fourth configured joint/DL TCI state(s) for receiving the first/second/third/fourth P/SP/AP CSI-RS(s) in the first/second group as specified herein in the present disclosure, i.e., whether the UE could follow those specified herein in the present disclosure, e.g., follow those provided/specified in one or more examples described herein (and the corresponding sub-examples provided/indicated therein) to expect that the RS(s) provided/indicated in the first (or second) indicated joint/DL TCI state is QCL'ed with the RS(s) provided/indicated in the configured joint/DL TCI state(s) for the P/AP/SP CSI-RS(s) in the first (or second) group as specified herein in the present disclosure, and/or follow those provided/specified in one or more examples described herein (and the corresponding sub-examples provided/indicated therein) to expect that the RS(s) provided/indicated in the second (or first) indicated joint/DL TCI state is QCL'ed with the RS(s) provided/indicated in the configured joint/DL TCI state(s) for the P/AP/SP CSI-RS(s) in the first (or second) group as specified herein in the present disclosure, could be determined according to: (i) fixed rule(s)/value(s) specified/provided in system specification(s), (ii) network's configuration(s)/indication(s), e.g., via/in higher layer RRC signaling(s)/parameter(s) and/or MAC CE command(s) and/or dynamic DCI based L1 signaling(s), and/or (iii) UE's autonomous determination/selection, which could be further sent to the network, e.g., in/by part of a beam/CSI report and/or UE's capability signaling(s). For instance, the UE could be indicated/provided/configured by the network, e.g., via higher layer RRC signaling(s)/parameter(s) and/or MAC CE command(s) and/or dynamic DCI based L1 signaling(s), a first bitmap with the first entry/bit position of the first bitmap corresponding/associated to the first group of P/SP/AP CSI-RS(s) (i.e., the first group of CMR(s)), and the second entry/bit position of the first bitmap corresponding/associated to the second group of P/SP/AP CSI-RS(s) (i.e., the second group of CMR(s)); in this case, when/if the first entry/bit position of the first bitmap is set to ‘1’ (or ‘0’), the UE could follow those provided/specified in one or more examples described herein to expect that the RS(s) provided/indicated in the first indicated joint/DL TCI state is QCL'ed with the RS(s) provided/indicated in the configured joint/DL TCI state(s) for the first group of P/SP/AP CSI-RS(s), and/or when/if the second entry/bit position of the first bitmap is set to ‘1’ (or ‘0’), the UE could follow those provided/specified in one or more examples described herein to expect that the RS(s) provided/indicated in the first indicated joint/DL TCI state is QCL'ed with the RS(s) provided/indicated in the configured joint/DL TCI state(s) for the second group of P/SP/AP CSI-RS(s), and/or when/if the first entry/bit position of the first bitmap is set to ‘1’ (or ‘0’) and the second entry/bit position of the first bitmap is set to ‘1’ (or ‘0’), the UE could follow those provided/specified in one or more examples described herein to expect that the RS(s) provided/indicated in the first indicated joint/DL TCI state is QCL'ed with the RS(s) provided/indicated in the configured joint/DL TCI state(s) for the first group of P/SP/AP CSI-RS(s) and the RS(s) provided/indicated in the configured joint/DL TCI state(s) for the second group of P/SP/AP CSI-RS(s). Furthermore, the UE could be indicated/provided/configured by the network, e.g., via higher layer RRC signaling(s)/parameter(s) and/or MAC CE command(s) and/or dynamic DCI based L1 signaling(s), a second bitmap with the first entry/bit position of the second bitmap corresponding/associated to the first group of P/SP/AP CSI-RS(s) (i.e., the first group of CMR(s)), and the second entry/bit position of the second bitmap corresponding/associated to the second group of P/SP/AP CSI-RS(s) (i.e., the second group of CMR(s)); in this case, when/if the first entry/bit position of the second bitmap is set to ‘1’ (or ‘0’), the UE could follow those provided/specified in one or more examples described herein to expect that the RS(s) provided/indicated in the second indicated joint/DL TCI state is QCL'ed with the RS(s) provided/indicated in the configured joint/DL TCI state(s) for the first group of P/SP/AP CSI-RS(s), and/or when/if the second entry/bit position of the second bitmap is set to ‘1’ (or ‘0’), the UE could follow those provided/specified in one or more examples described herein to expect that the RS(s) provided/indicated in the second indicated joint/DL TCI state is QCL'ed with the RS(s) provided/indicated in the configured joint/DL TCI state(s) for the second group of P/SP/AP CSI-RS(s), and/or when/if the first entry/bit position of the second bitmap is set to ‘1’ (or ‘0’) and the second entry/bit position of the second bitmap is set to ‘1’ (or ‘0’), the UE could follow those provided/specified in one or more examples described herein to expect that the RS(s) provided/indicated in the second indicated joint/DL TCI state is QCL'ed with the RS(s) provided/indicated in the configured joint/DL TCI state(s) for the first group of P/SP/AP CSI-RS(s) and the RS(s) provided/indicated in the configured joint/DL TCI state(s) for the second group of P/SP/AP CSI-RS(s).

Yet for another example, an RRC configuration could be provided to the first and/or second and/or third and/or fourth P/SP/AP CSI-RS resource(s) in the first group and/or a CSI resource set that configures/provides the first and/or second and/or third and/or fourth P/SP/AP CSI-RS resource(s) in the first group as specified herein in the present disclosure. In this case, when/if the UE is configured with the RRC configuration (e.g., set to ‘enabled’), and/or when/if the RRC configuration is set to ‘0’ (or ‘1’) or ‘00’ (or ‘01’ or ‘10’ or ‘11’) or ‘first’ (or ‘both’), the UE could use/apply the first indicated joint/DL TCI state to the first and/or second and/or third and/or fourth P/SP/AP CSI-RS(s) in the first group and/or the first PDSCH; otherwise—e.g., one or more of the RRC configuration settings/values herein are not provided/configured/indicated/set, the UE could use/apply the configured joint/DL TCI state(s) or the second indicated joint/DL TCI state to the first and/or second and/or third and/or fourth P/SP/AP CSI-RS(s) in the first group. And/or, when/if the UE is configured with the RRC configuration (e.g., set to ‘enabled’), and/or when/if the RRC configuration is set to ‘1’ (or ‘O’) or ‘01’ (or ‘00’ or ‘10’ or ‘11’) or ‘second’ (or ‘both’), the UE could use/apply the second indicated joint/DL TCI state to the first and/or second and/or third and/or fourth P/SP/AP CSI-RS(s) in the first group and/or the second PDSCH; otherwise—e.g., one or more of the RRC configuration settings/values herein are not provided/configured/indicated/set, the UE could use/apply the configured joint/DL TCI state(s) or the first indicated joint/DL TCI state to the first and/or second and/or third and/or fourth P/SP/AP CSI-RS(s) in the first group.

Yet for another example, an RRC configuration could be provided to the first and/or second and/or third and/or fourth P/SP/AP CSI-RS resource(s) in the second group and/or a CSI resource set that configures/provides the first and/or second and/or third and/or fourth P/SP/AP CSI-RS resource(s) in the second group as specified herein in the present disclosure. In this case, when/if the UE is configured with the RRC configuration (e.g., set to ‘enabled’), and/or when/if the RRC configuration is set to ‘0’ (or ‘1’) or ‘00’ (or ‘01’ or ‘10’ or ‘11’) or ‘first’ (or ‘both’), the UE could use/apply the first indicated joint/DL TCI state to the first and/or second and/or third and/or fourth P/SP/AP CSI-RS(s) in the second group and/or the first PDSCH; otherwise—e.g., one or more of the RRC configuration settings/values herein are not provided/configured/indicated/set, the UE could use/apply the configured joint/DL TCI state(s) or the second indicated joint/DL TCI state to the first and/or second and/or third and/or fourth P/SP/AP CSI-RS(s) in the second group. And/or, when/if the UE is configured with the RRC configuration (e.g., set to ‘enabled’), and/or when/if the RRC configuration is set to ‘1’ (or ‘0’) or ‘01’ (or ‘00’ or ‘10’ or ‘11’) or ‘second’ (or ‘both’), the UE could use/apply the second indicated joint/DL TCI state to the first and/or second and/or third and/or fourth P/SP/AP CSI-RS(s) in the second group and/or the second PDSCH; otherwise—e.g., one or more of the RRC configuration settings/values herein are not provided/configured/indicated/set, the UE could use/apply the configured joint/DL TCI state(s) or the first indicated joint/DL TCI state to the first and/or second and/or third and/or fourth P/SP/AP CSI-RS(s) in the second group.

Yet for another example, a first RRC configuration could be provided to the first and/or second and/or third and/or fourth P/SP/AP CSI-RS resource(s) in the first group and/or a CSI resource set that configures/provides the first and/or second and/or third and/or fourth P/SP/AP CSI-RS resource(s) in the first group, and a second RRC configuration could be provided to the first and/or second and/or third and/or fourth P/SP/AP CSI-RS resource(s) in the second group and/or a CSI resource set that configures/provides the first and/or second and/or third and/or fourth P/SP/AP CSI-RS resource(s) in the second group. In this case, when/if the UE is configured with the first RRC configuration (e.g., set to ‘enabled’), and/or when/if the UE is configured with the second RRC configuration (e.g., set to ‘enabled’), and/or when/if the first RRC configuration is set to ‘0’ (or ‘1’) or ‘00’ (or ‘01’ or ‘10’ or ‘11’) or ‘first’ (or ‘both’), and/or when/if the second RRC configuration is set to ‘0’ (or ‘1’) or ‘00’ (or ‘01’ or ‘10’ or ‘11’) or ‘first’ (or ‘both’), the UE could use/apply the first indicated joint/DL TCI state to the P/SP/AP CSI-RS(s) in the first and/or second group(s) as specified herein in the present disclosure and/or the first PDSCH(s); otherwise—e.g., one or more of the RRC configuration settings/values herein are not provided/configured/indicated/set, the UE could use/apply the configured joint/DL TCI state(s) for the P/SP/AP CSI-RSs in the first and/or second group(s) as specified herein in the present disclosure. And/or, when/if the UE is configured with the first RRC configuration (e.g., set to ‘enabled’), and/or when/if the UE is configured with the second RRC configuration (e.g., set to ‘enabled’), and/or when/if the first RRC configuration is set to ‘1’ (or ‘0’) or ‘01’ (or ‘00’ or ‘10’ or ‘11’) or ‘second’ (or ‘both’), and/or when/if the second RRC configuration is set to ‘1’ (or ‘0’) or ‘01’ (or ‘00’ or ‘10’ or ‘11’) or ‘second’ (or ‘both’), the UE could use/apply the second indicated joint/DL TCI state to the P/SP/AP CSI-RS(s) in the first and/or second group(s) as specified herein in the present disclosure and/or the second PDSCH(s); otherwise—e.g., one or more of the RRC configuration settings/values herein are not provided/configured/indicated/set, the UE could use/apply the configured joint/DL TCI state(s) for the P/SP/AP CSI-RSs in the first and/or second group(s) as specified herein in the present disclosure.

In yet another example, the association/mapping between the first/second indicated joint/DL TCI state(s) for the first/second PDSCH reception(s) and the first and/or the second and/or the third and/or the fourth configured joint/DL TCI state(s) for receiving the first and/or the second and/or the third and/or the fourth P/SP/AP CSI-RS(s) in the first/second group(s) as specified herein in the present disclosure—e.g., follow those specified in one or more examples described herein and their corresponding sub-examples in the present disclosure— could be applied/extended to M≥4 P/SP/AP CSI-RSs (or equivalently, M≥4 CMRs) in the first and/or second group(s) as specified herein in the present disclosure. In this case, the first group of P/SP/AP CSI-RS(s)—or CMR(s)— could comprise any combination(s) of one, two, three, four, . . . , M out of the M≥4 P/SP/AP CSI-RSs (or equivalently, M≥4 CMRs), and the second group of P/SP/AP CSI-RS(s)—or CMR(s)— could comprise the remaining P/SP/AP CSI-RS(s) out of the M≥4 P/SP/AP CSI-RSs not in the first group.

The described/specified design procedures/examples herein for up to N=2 indicated joint/DL TCI states can be applied/extended to when more than two (i.e., N≥2) joint/DL TCI states are indicated for the PDSCH reception(s), e.g., for the CJT operation as specified herein in the present disclosure. In this case, a first group of indicated joint/DL TCI state(s) could comprise any combination(s) of one, two, . . . , N out of the N≥2 indicated joint/DL TCI states, and a second group of indicated joint/DL TCI state(s) could comprise the remaining indicated joint/DL TCI state(s) out of the N≥2 indicated joint/DL TCI states not in the first group. For example, for N=3, the first group of indicated joint/DL TCI state(s) could comprise at least one of:
The first indicated joint/DL TCI state
The second indicated joint/DL TCI state
The third indicated joint/DL TCI state
The first and the second indicated joint/DL TCI states
The first and the third indicated joint/DL TCI states
The second and the third indicated joint/DL TCI states
The first, second and third indicated joint/DL TCI states

For another example, for N=4, the first group of indicated joint/DL TCI state(s) could comprise at least one of:
The first indicated joint/DL TCI state
The second indicated joint/DL TCI state
The third indicated joint/DL TCI state
The fourth indicated joint/DL TCI state
The first and the second indicated joint/DL TCI states
The first and the third indicated joint/DL TCI states
The first and the fourth indicated joint/DL TCI states
The first, second and third indicated joint/DL TCI states
The first, second and fourth indicated joint/DL TCI states
The first, third and fourth indicated joint/DL TCI states
The second and the third indicated joint/DL TCI states
The second and the fourth indicated joint/DL TCI states
The second, third and fourth indicated joint/DL TCI states
The third and fourth indicated joint/DL TCI states
The first, second, third and fourth indicated joint/DL TCI states

As specified/described herein in the present disclosure, the indicated joint/DL TCI state(s)—e.g., out of the N=3 or N=4 indicated joint/DL TCI states—not in the first group could be in the second group of indicated joint/DL TCI state(s). As specified herein in the present disclosure, the first group and/or the second group of indicated joint/DL TCI states could be: (i) determined according to fixed rule(s)/value(s) in system specification(s), (ii) provided/indicated/updated/configured by the network, e.g., via higher layer RRC signaling(s)/parameter(s) and/or MAC CE command(s) and/or dynamic DCI based L1 signaling(s), and/or (iii) autonomously determined by the UE, which could be further sent to the network, e.g., via/in part of a CSI/beam report and/or UE's capability signaling(s). In this case, the described/specified design procedures/examples herein (e.g., those provided in one or more examples described herein) for up to N=2 indicated joint/DL TCI states can be extended/applied to when more than two (i.e., N≥2) joint/DL TCI states are indicated by replacing the first indicated joint/DL TCI state with the indicated joint/DL TCI state(s) in the first group as specified herein in the present disclosure (e.g., throughout those provided in one or more examples described herein), and/or by the second indicated joint/DL TCI state with the indicated joint/DL TCI state(s) in the second group as specified herein in the present disclosure (e.g., throughout those provided in one or more examples described herein).

Throughout the present disclosure, the first P/SP/AP CSI-RS resource (or the first CMR) could correspond to the P/SP/AP CSI-RS resource (or the CMR) with the lowest/highest resource ID/index—e.g., among one or more CSI-RS resources (or CMRs) in a CSI resource set and/or the P/SP/AP CSI-RS resource (or the CMR) at/in the first entry in/of a CSI resource set—e.g., among one or more CSI-RS resources (or CMRs) in the CSI resource set, the second P/SP/AP CSI-RS resource (or the second CMR) could correspond to the P/SP/AP CSI-RS resource (or the CMR) with the second lowest/highest resource ID/index—e.g., among one or more CSI-RS resources (or CMRs) in a CSI resource set and/or the P/SP/AP CSI-RS resource (or the CMR) at/in the second entry in/of a CSI resource set—e.g., among one or more CSI-RS resources (or CMRs) in the CSI resource set, the third P/SP/AP CSI-RS resource (or the third CMR) could correspond to the P/SP/AP CSI-RS resource (or the CMR) with the third lowest/highest resource ID/index—e.g., among one or more CSI-RS resources (or CMRs) in a CSI resource set and/or the P/SP/AP CSI-RS resource (or the CMR) at/in the third entry in/of a CSI resource set—e.g., among one or more CSI-RS resources (or CMRs) in the CSI resource set, the fourth P/SP/AP CSI-RS resource (or the fourth CMR) could correspond to the P/SP/AP CSI-RS resource (or the CMR) with the fourth lowest/highest resource ID/index—e.g., among one or more CSI-RS resources (or CMRs) in a CSI resource set and/or the P/SP/AP CSI-RS resource (or the CMR) at/in the fourth entry in/of a CSI resource set—e.g., among one or more CSI-RS resources (or CMRs) in the CSI resource set, and so on. Furthermore, throughout the present disclosure, the first indicated (joint/DL) TCI state could correspond to the first TCI state of a TCI codepoint or a TCI state— of a TCI codepoint— associated with/to an indicator set to ‘0’ (or ‘1’) or ‘first’ or ‘enabled’, the second indicated (joint/DL) TCI state could correspond to the second TCI state of a TCI codepoint or a TCI state— of a TCI codepoint— associated with/to an indicator set to ‘1’ (or ‘0’) or ‘second’ or ‘enabled’, and so on.

Throughout the present disclosure, when/if one indicated TCI-State (or one indicated joint/DL TCI state) is associated/linked to a configured TCI-State (or a configured joint/DL TCI state) for receiving or to receive P/SP/AP CSI-RS(s)—or CMR(s)—as specified herein in the present disclosure, the UE (e.g., the UE 116) may not expect to receive TCI state(s) update/change/switching e.g., via (unified) TCI state(s) activation/deactivation MAC CE and/or beam indication DCI—for the one indicated (joint/DL) TCI state, wherein according to those specified herein in the present disclosure, the one indicated (joint/DL) TCI state could correspond to the first indicated TCI-State (or the first indicated joint/DL TCI state) or the second indicated TCI-State (or the second indicated joint/DL TCI state) of a TCI codepoint. Furthermore, when/if at least one indicated (joint/DL) TCI state (e.g., the first indicated joint/DL TCI state and/or the second indicated joint/DL TCI state for N=2) for PDSCH-CJT reception(s) is associated/linked to at least one configured TCI-State (or at least one configured joint/DL TCI state) for receiving or to receive P/SP/AP CSI-RS(s)—or CMR(s)—as specified herein in the present disclosure, the UE may not expect the second indicator or the TCI selection field as specified herein in the present disclosure for PDSCH reception(s) to be present in the corresponding DCI format (e.g., DCI 1_1/1_2), and/or even when/if the second indicator or the TCI selection field as specified herein in the present disclosure for PDSCH reception(s) is present in the corresponding DCI format (e.g., DCI 1_1/1_2), the UE may not follow the second indicator/TCI selection field to determine which of the indicated joint/DL TCI state(s) to use/apply for receiving the PDSCH(s)—in this case, the UE could apply the first indicated joint/DL TCI state to receive the PDSCH(s), or the second indicated joint/DL TCI state to receive the PDSCH(s), or both of the first and second indicated joint/DL TCI states to receive the PDSCH(s). Furthermore, a UE could report to the network, e.g., in/via part of their capability signaling(s)/signaling report(s), the number of indicated (joint/DL) TCI state(s)—e.g., 1 or 2—the UE can support for CJT-PDSCH reception(s). Additionally, when/if a U E is configured by higher layer parameter cjtSchemePDSCH and d-OrJointTCI-StateList and is indicated with two TCI-States applied for PDSCH reception and reports to the network that the UE could support for two joint/DL TCI states for PDSCH-CJT:
If the UE is configured with cjtSchemeA, the UE expects that PDSCH demodulation reference signal (DM-RS) port(s) are QCLed with the DL RSs of both indicated TCI-States with respect to QCL-TypeA.
If the UE is configured with cjtSchemeB, the UE expects that PDSCH DM-RS port(s) are QCLed with the DL RSs of both indicated TCI-States with respect to QCL-TypeA except for QCL parameters {Doppler shift, Doppler spread} of the second indicated joint/DL TCI state.

The settings/assumptions of the indicated joint/DL TCI state(s) for PDSCH-CJT reception(s) herein could be extended/applied to P/SP/AP CSI-RS(s) or CMR(s) reception(s) in CJT according to those specified herein in the present disclosure.

In one embodiment, the UE could be configured/indicated/provided by the network, e.g., via higher layer RRC signaling(s)/parameter(s) such as dl-OrJointTCI-StateList and/or MAC CE command(s) and/or dynamic DCI based L1 signaling(s), a first list/set/pool of one or more joint/DL/UL TCI states (or equivalently, TCI state IDs) each provided by TCI-State or DLorJointTCI-State or UL-TCIState. Furthermore, the UE could be configured/indicated/provided by the network, e.g., via higher layer RRC signaling(s)/parameter(s) such as CSI-ResourceConfig, NZP-CSI-RS-ResourceSet and/or etc. and/or MAC CE command(s) and/or dynamic DCI based L1 signaling(s), a first list/set/pool of one or more NZP CSI-RS resources (or equivalently, NZP CSI-RS resource IDs) such as CMRs (or equivalently, CMR IDs) each provided by nzp-CSI-RS-Resource/nzp-CSI-RS-ResourceId. A joint/DL/UL TCI state in the first list/set/pool of TCI states as specified herein in the present disclosure could be associated to/with one or more NZP CSI-RS resources in the first list/set/pool of NZP CSI-RS resources as specified herein in the present disclosure according to: (1) fixed rule(s)/value(s) in system specification(s), (2) network's configuration(s)/indication(s), e.g., via higher layer RRC signaling(s)/parameter(s) and/or MAC CE command(s) and/or dynamic DCI based L1 signaling(s), and/or (3) UE's autonomous selection/determination, which could be further sent to the network, e.g., via/in part of a/the CSI/beam report and/or UE's capability signaling(s).

In one example, the first TCI state or the TCI state with the lowest TCI state ID among the one or more TCI states in the first list/set/pool of TCI states could be associated to/with the first NZP CSI-RS resource or the NZP CSI-RS resource with the lowest resource ID among the one or more NZP CSI-RS resources in the first list/set/pool of NZP CSI-RS resources, the second TCI state or the TCI state with the second lowest TCI state ID among the one or more TCI states in the first list/set/pool of TCI states could be associated to/with the second NZP CSI-RS resource or the NZP CSI-RS resource with the second lowest resource ID in the first list/set/pool of NZP CSI-RS resources, etc., and the last TCI state or the TCI state with the highest TCI state ID among the one or more TCI states in the first list/set/pool of TCI states could be associated to/with the last NZP CSI-RS resource or the NZP CSI-RS resource with the highest resource ID among the one or more NZP CSI-RS resources in the first list/set/pool of NZP CSI-RS resources.

In another example, the last TCI state or the TCI state with the highest TCI state ID among the one or more TCI states in the first list/set/pool of TCI states could be associated to/with the first NZP CSI-RS resource or the NZP CSI-RS resource with the lowest resource ID among the one or more NZP CSI-RS resources in the first list/set/pool of NZP CSI-RS resources, the second last TCI state or the TCI state with the second highest TCI state ID among the one or more TCI states in the first list/set/pool of TCI states could be associated to/with the second NZP CSI-RS resource or the NZP CSI-RS resource with the second lowest resource ID in the first list/set/pool of NZP CSI-RS resources, etc., and the first TCI state or the TCI state with the lowest TCI state ID among the one or more TCI states in the first list/set/pool of TCI states could be associated to/with the last NZP CSI-RS resource or the NZP CSI-RS resource with the highest resource ID among the one or more NZP CSI-RS resources in the first list/set/pool of NZP CSI-RS resources.

In yet another example, the UE could be provided/indicated/configured by the network, e.g., via higher layer RRC signaling(s)/parameter(s) and/or MAC CE command(s) and/or dynamic DCI based L1 signaling(s), a second list/set/pool of one or more TCI states/TCI state IDs, wherein the one or more TCI states/TCI state IDs in the second list/set/pool of TCI states/TCI state IDs could be from the one or more TCI states/TCI state IDs in the first list/set/pool of TCI states/TCI state IDs. For this case, the first (or last) TCI state or the TCI state with the lowest (or highest) TCI state ID among the one or more TCI states in the second list/set/pool of TCI states could be associated to/with the first NZP CSI-RS resource or the NZP CSI-RS resource with the lowest resource ID among the one or more NZP CSI-RS resources in the first list/set/pool of NZP CSI-RS resources, the second (or second last) TCI state or the TCI state with the second lowest (or second highest) TCI state ID among the one or more TCI states in the second list/set/pool of TCI states could be associated to/with the second NZP CSI-RS resource or the NZP CSI-RS resource with the second lowest resource ID in the first list/set/pool of NZP CSI-RS resources, etc., and the last (or first) TCI state or the TCI state with the highest (or lowest) TCI state ID among the one or more TCI states in the second list/set/pool of TCI states could be associated to/with the last NZP CSI-RS resource or the NZP CSI-RS resource with the highest resource ID among the one or more NZP CSI-RS resources in the first list/set/pool of NZP CSI-RS resources. Optionally, the second list/set/pool of TCI states could be determined/identified according to fixed rule(s)/value(s) in system specification(s). For instance, the second list/set/pool of TCI states/TCI state IDs could include/contain/comprise the first/last K≥1 TCI states/TCI state IDs in the first list/set/pool of TCI states/TCI state IDs or the K≥1 TCI states/TCI state IDs in the first list/set/pool of TCI states/TCI state IDs starting from the k-th TCI state/TCI state ID or the TCI state with the k-th lowest/highest TCI state ID in the first list/set/pool of TCI states/TCI state IDs. The value(s) of k and/or K could be: (i) fixed value(s) in system specification(s), (ii) configured/provided/indicated by the network, e.g., via higher layer RRC signaling(s)/parameter(s) and/or MAC CE command(s) and/or dynamic DCI based L1 signaling(s), and/or (iii) determined/selected autonomously by the UE, which could be further reported to the network, e.g., via/in part of a/the CSI/beam report and/or UE's capability signaling(s). Alternatively, the UE could autonomously determine/select the second list/set/pool of TCI states/TCI state IDs out of the first list/set/pool of TCI states/TCI state IDs, and report to the network, e.g., in/via part of a/the CSI beam report and/or UE's capability signaling(s) and/or PUCCH/PUSCH/physical random access channel (PRACH)/etc., their determined/selected second list/set/pool of TCI states/TCI state IDs.

In yet another example, the UE could be provided/indicated/configured by the network, e.g., via higher layer RRC signaling(s)/parameter(s) and/or MAC CE command(s) and/or dynamic DCI based L1 signaling(s), a first bitmap with each entry/bit position of the first bitmap corresponding to a TCI state/TCI state ID in the first list/set/pool of TCI states/TCI state IDs. When/if an entry/bit position of the first bitmap is set to ‘1’ (or ‘0’), the corresponding/associated TCI state/TCI state ID in the first list/set/pool of TCI states/TCI state IDs could belong to a second list/set/pool of TCI states/TCI state IDs. For this case, the first (or last) TCI state or the TCI state with the lowest (or highest) TCI state ID among the one or more TCI states in the second list/set/pool of TCI states could be associated to/with the first NZP CSI-RS resource or the NZP CSI-RS resource with the lowest resource ID among the one or more NZP CSI-RS resources in the first list/set/pool of NZP CSI-RS resources, the second (or second last) TCI state or the TCI state with the second lowest (or second highest) TCI state ID among the one or more TCI states in the second list/set/pool of TCI states could be associated to/with the second NZP CSI-RS resource or the NZP CSI-RS resource with the second lowest resource ID in the first list/set/pool of NZP CSI-RS resources, etc., and the last (or first) TCI state or the TCI state with the highest (or lowest) TCI state ID among the one or more TCI states in the second list/set/pool of TCI states could be associated to/with the last NZP CSI-RS resource or the NZP CSI-RS resource with the highest resource ID among the one or more NZP CSI-RS resources in the first list/set/pool of NZP CSI-RS resources. Optionally, the second list/set/pool of TCI states could be determined/identified according to fixed rule(s)/value(s) in system specification(s). For instance, the second list/set/pool of TCI states/TCI state IDs could include/contain/comprise the first/last K≥1 TCI states/TCI state IDs in the first list/set/pool of TCI states/TCI state IDs or the K≥1 TCI states/TCI state IDs in the first list/set/pool of TCI states/TCI state IDs starting from the k-th TCI state/TCI state ID or the TCI state with the k-th lowest/highest TCI state ID in the first list/set/pool of TCI states/TCI state IDs. The value(s) of k and/or K could be: (i) fixed value(s) in system specification(s), (ii) configured/provided/indicated by the network, e.g., via higher layer RRC signaling(s)/parameter(s) and/or MAC CE command(s) and/or dynamic DCI based L1 signaling(s), and/or (iii) determined/selected autonomously by the UE, which could be further reported to the network, e.g., via/in part of a/the CSI/beam report and/or UE's capability signaling(s). Alternatively, the UE could autonomously determine/select the second list/set/pool of TCI states/TCI state IDs out of the first list/set/pool of TCI states/TCI state IDs, and report to the network, e.g., in/via part of a/the CSI beam report and/or UE's capability signaling(s) and/or PUCCH/PUSCH/PRACH/etc., their determined/selected second list/set/pool of TCI states/TCI state IDs.

In yet another example, the UE could be provided/indicated/configured by the network, e.g., via higher layer RRC signaling(s)/parameter(s) and/or MAC CE command(s) and/or dynamic DCI based L1 signaling(s), a second list/set/pool of one or more NZP CSI-RS resources/resource IDs, wherein the one or more NZP CSI-RS resources/NZP CSI-RS resource IDs in the second list/set/pool of NZP CSI-RS resources/NZP CSI-RS resource IDs could be from the one or more NZP CSI-RS resources/NZP CSI-RS resource IDs in the first list/set/pool of NZP CSI-RS resources/NZP CSI-RS resource IDs. For this case, the first (or last) NZP CSI-RS resource or the NZP CSI-RS resource with the lowest (or highest) NZP CSI-RS resource ID among the one or more NZP CSI-RS resources in the second list/set/pool of NZP CSI-RS resources could be associated to/with the first TCI state or the TCI state with the lowest TCI state ID among the one or more TCI states/TCI state IDs in the first list/set/pool of TCI states/TCI state IDs, the second (or second last) NZP CSI-RS resource or the NZP CSI-RS resource with the second lowest (or second highest) NZP CSI-RS resource ID among the one or more NZP CSI-RS resources in the second list/set/pool of NZP CSI-RS resources could be associated to/with the second TCI state or the TCI state with the second lowest TCI state ID among the one or more TCI states/TCI state IDs in the first list/set/pool of TCI states/TCI state IDs, etc., and the last (or first) NZP CSI-RS resource or the NZP CSI-RS resource with the highest (or lowest) NZP CSI-RS resource ID among the one or more NZP CSI-RS resources in the second list/set/pool of NZP CSI-RS resources could be associated to/with the last TCI state or the TCI state with the highest TCI state ID among the one or more TCI states/TCI state IDs in the first list/set/pool of TCI states/TCI state IDs. Optionally, the second list/set/pool of NZP CSI-RS resources could be determined/identified according to fixed rule(s)/value(s) in system specification(s). For instance, the second list/set/pool of NZP CSI-RS resources/NZP CSI-RS resource IDs could include/contain/comprise the first/last M≥1 NZP CSI-RS resources/NZP CSI-RS resource IDs in the first list/set/pool of NZP CSI-RS resources/NZP CSI-RS resource IDs or the M≥1 NZP CSI-RS resources/NZP CSI-RS resource IDs in the first list/set/pool of NZP CSI-RS resources/NZP CSI-RS resource IDs starting from the m-th NZP CSI-RS resource/NZP CSI-RS resource ID or the NZP CSI-RS resource with the m-th lowest/highest NZP CSI-RS resource ID in the first list/set/pool of NZP CSI-RS resources/NZP CSI-RS resource IDs. The value(s) of m and/or M could be: (i) fixed value(s) in system specification(s), (ii) configured/provided/indicated by the network, e.g., via higher layer RRC signaling(s)/parameter(s) and/or MAC CE command(s) and/or dynamic DCI based L1 signaling(s), and/or (iii) determined/selected autonomously by the UE, which could be further reported to the network, e.g., via/in part of a/the CSI/beam report and/or UE's capability signaling(s). Alternatively, the UE could autonomously determine/select the second list/set/pool of NZP CSI-RS resources/NZP CSI-RS resource IDs out of the first list/set/pool of NZP CSI-RS resources/NZP CSI-RS resource IDs, and report to the network, e.g., in/via part of a/the CSI beam report and/or UE's capability signaling(s) and/or PUCCH/PUSCH/PRACH/etc., their determined/selected second list/set/pool of NZP CSI-RS resources/NZP CSI-RS resource IDs.

In yet another example, the UE could be provided/indicated/configured by the network, e.g., via higher layer RRC signaling(s)/parameter(s) and/or MAC CE command(s) and/or dynamic DCI based L1 signaling(s), a second bitmap with each entry/bit position of the second bitmap corresponding to a NZP CSI-RS resource/NZP CSI-RS resource ID in the first list/set/pool of NZP CSI-RS resources/NZP CSI-RS resource IDs. When/if an entry/bit position of the second bitmap is set to ‘1’ (or ‘0’), the corresponding/associated NZP CSI-RS resource/NZP CSI-RS resource ID in the first list/set/pool of NZP CSI-RS resources/NZP CSI-RS resource IDs could belong to a second list/set/pool of NZP CSI-RS resources/NZP CSI-RS resource IDs. For this case, the first (or last) NZP CSI-RS resource or the NZP CSI-RS resource with the lowest (or highest) NZP CSI-RS resource ID among the one or more NZP CSI-RS resources in the second list/set/pool of NZP CSI-RS resources could be associated to/with the first TCI state or the TCI state with the lowest TCI state ID among the one or more TCI states/TCI state IDs in the first list/set/pool of TCI states/TCI state IDs, the second (or second last) NZP CSI-RS resource or the NZP CSI-RS resource with the second lowest (or second highest) NZP CSI-RS resource ID among the one or more NZP CSI-RS resources in the second list/set/pool of NZP CSI-RS resources could be associated to/with the second TCI state or the TCI state with the second lowest TCI state ID among the one or more TCI states/TCI state IDs in the first list/set/pool of TCI states/TCI state IDs, etc., and the last (or first) NZP CSI-RS resource or the NZP CSI-RS resource with the highest (or lowest) NZP CSI-RS resource ID among the one or more NZP CSI-RS resources in the second list/set/pool of NZP CSI-RS resources could be associated to/with the last TCI state or the TCI state with the highest TCI state ID among the one or more TCI states/TCI state IDs in the first list/set/pool of TCI states/TCI state IDs. Optionally, the second list/set/pool of NZP CSI-RS resources could be determined/identified according to fixed rule(s)/value(s) in system specification(s). For instance, the second list/set/pool of NZP CSI-RS resources/NZP CSI-RS resource IDs could include/contain/comprise the first/last M≥1 NZP CSI-RS resources/NZP CSI-RS resource IDs in the first list/set/pool of NZP CSI-RS resources/NZP CSI-RS resource IDs or the M≥1 NZP CSI-RS resources/NZP CSI-RS resource IDs in the first list/set/pool of NZP CSI-RS resources/NZP CSI-RS resource IDs starting from the m-th NZP CSI-RS resource/NZP CSI-RS resource ID or the NZP CSI-RS resource with the m-th lowest/highest NZP CSI-RS resource ID in the first list/set/pool of NZP CSI-RS resources/NZP CSI-RS resource IDs. The value(s) of m and/or M could be: (i) fixed value(s) in system specification(s), (ii) configured/provided/indicated by the network, e.g., via higher layer RRC signaling(s)/parameter(s) and/or MAC CE command(s) and/or dynamic DCI based L1 signaling(s), and/or (iii) determined/selected autonomously by the UE, which could be further reported to the network, e.g., via/in part of a/the CSI/beam report and/or UE's capability signaling(s). Alternatively, the UE could autonomously determine/select the second list/set/pool of NZP CSI-RS resources/NZP CSI-RS resource IDs out of the first list/set/pool of NZP CSI-RS resources/NZP CSI-RS resource IDs, and report to the network, e.g., in/via part of a/the CSI beam report and/or UE's capability signaling(s) and/or PUCCH/PUSCH/PRACH/etc., their determined/selected second list/set/pool of NZP CSI-RS resources/NZP CSI-RS resource IDs.

In yet another example, the higher layer parameter(s) such as TCI-State, QCL-Info, DLorJoint-TCIState and/or ULTCI-State that configures/provides/indicates a TCI state, e.g., in the first list/set/pool of TCI states/TCI state IDs, could include/contain/comprise/indicate/provide/configure one or more CSI resource settings/CSI resource setting IDs. For this case/design example, the TCI state could be associated to/with the one or more CSI resource settings/CSI resource setting IDs (and therefore, the corresponding NZP CSI-RS resource set(s) and/or NZP CSI-RS resource(s) provided/indicated/configured therein).

In yet another example, the higher layer parameter(s) such as TCI-State, QCL-Info, DLorJoint-TCIState and/or ULTCI-State that configures/provides/indicates a TCI state, e.g., in the first list/set/pool of TCI states/TCI state IDs, could include/contain/comprise/indicate/provide/configure one or more CSI resource sets/CSI resource set IDs (e.g., one or more NZP CSI-RS resource sets/NZP CSI-RS resource set IDs). For this case/design example, the TCI state could be associated to/with the one or more CSI resource sets/CSI resource set IDs (and therefore, the corresponding NZP CSI-RS resource(s) provided/indicated/configured therein).

In yet another example, the higher layer parameter(s) such as TCI-State, QCL-Info, DLorJoint-TCIState and/or ULTCI-State that configures/provides/indicates a TCI state, e.g., in the first list/set/pool of TCI states/TCI state IDs, could include/contain/comprise/indicate/provide/configure one or more NZP CSI-RS resources/NZP CSI-RS resource IDs. For this case/design example, the TCI state could be associated to/with the one or more NZP CSI-RS resources/NZP CSI-RS resource IDs.

In yet another example, the higher layer parameter(s) such as CSI-ResourceConfig that configures/provides/indicates a CSI resource setting, could include/contain/comprise/indicate/provide/configure one or more TCI states/TCI state IDs and/or QCL-Info's. For this case/design example, the CSI resource setting (and therefore, the corresponding NZP CSI-RS resource set(s) and/or NZP CSI-RS resource(s) provided/indicated/configured therein) could be associated to/with the one or more TCI states/TCI state IDs and/or QCL-Info's.

In yet another example, the higher layer parameter(s) such as NZP-CSI-RS-ResourceSet that configures/provides/indicates a CSI resource set such as NZP CSI-RS resource set, could include/contain/comprise/indicate/provide/configure one or more TCI states/TCI state IDs and/or QCL-Info's. For this case/design example, the CSI resource set/NZP CSI-RS resource set (and therefore, the corresponding NZP CSI-RS resource(s) provided/indicated/configured therein) could be associated to/with the one or more TCI states/TCI state IDs and/or QCL-Info's.

In yet another example, the higher layer parameter(s) such as NZP-CSI-RS-Resource that configures/provides/indicates a NZP CSI-RS resource could include/contain/comprise/indicate/provide/configure one or more TCI states/TCI state IDs and/or QCL-Info's. For this case/design example, the NZP CSI-RS resource could be associated to/with the one or more TCI states/TCI state IDs and/or QCL-Info's.

As specified herein in the present disclosure, a UE could be indicated/provided by the network (e.g., the network 130) one or more joint/DL/UL TCI states, e.g., via/in/by one or more (unified) TCI state(s) activation/deactivation MAC CEs and/or one or more TCI codepoints in one or more TCI fields of one or more beam indication DCIs (e.g., DCI(s) 1_1/1_2 with or without DL assignment and/or group common DCI(s) for a group of UEs) for at least UE-dedicated reception(s) on PDSCH(s)/PDCCH(s) and/or dynamic-grant/configured-grant based PUSCH(s) and dedicated PUCCH resources. An indicated joint/DL/UL TCI state could be associated/corresponding to/with one or more NZP CSI-RS resources/NZP CSI-RS resource IDs (e.g., CMRs/CMR IDs) according to those specified herein in the present disclosure (e.g., those provided/specified in one or more examples described herein, and their corresponding sub-examples provided/specified therein). Furthermore, as specified herein in the present disclosure, when/if a UE is operated in/under CJT and/or configured with one or more CJT transmission/reception schemes (e.g., when/if the UE is configured by higher layer parameter cjtSchemePDSCH), and/or when/if the UE is configured/provided one or more type-I NZP CSI-RS resources (or type-I CMRs), the UE could determine QCL assumption(s) and/or TCI state(s) for the one or more type-I NZP CSI-RS resources (or type-I CMRs) according to one or more of the following.

In one example, the UE could first identify/determine one or more type-II NZP CSI-RS resources (or type-II CMRs) associated/corresponding to or from the one or more indicated joint/DL/UL TCI states following those specified herein in the present disclosure (e.g., following those provided/specified in one or more examples described herein, and their corresponding sub-examples provided/specified therein). For instance, when/if a configured type-I NZP CSI-RS resource also belongs to or corresponds to an identified/determined type-II NZP CSI-RS resource—denoted by/as a type-III NZP CSI-RS resource (or a type-III CMR), the UE could use/apply the indicated TCI state(s) associated/corresponding to the identified/determined type-II NZP CSI-RS resource to/for the configured type-I NZP CSI-RS resource, or equivalently, the type-III NZP CSI-RS resource. For a configured type-I NZP CSI-RS resource that does not correspond to or belong to any of the identified/determined type-II NZP CSI-RS resource(s)—denoted by/as a type-IV NZP CSI-RS resource (or a type-IV CMR), the UE could use/apply the TCI state(s) that is RRC configured/provided to the configured type-I NZP CSI-RS resource, or equivalently, the type-IV NZP CSI-RS resource, to receive the configured type-I NZP CSI-RS resource, or equivalently, the type-IV NZP CSI-RS resource. For this case/design example, the configured type-I NZP CSI-RS resources (or type-I CMRs) could correspond to the type-III NZP CSI-RS resource(s) (or type-III CMR(s)) as specified/defined herein in the present disclosure; alternatively, the configured type-I NZP CSI-RS resources (or type-I CMRs) could correspond to the type-IV NZP CSI-RS resource(s) (or type-IV CMR(s)) as specified/defined herein in the present disclosure.

In another example, the UE could first identify/determine one or more type-II NZP CSI-RS resources (or type-II CMRs) associated/corresponding to or from the one or more indicated joint/DL/UL TCI states following those specified herein in the present disclosure (e.g., following those provided/specified in one or more examples described herein, and their corresponding sub-examples provided/specified therein). For instance, when/if a configured type-I NZP CSI-RS resource also belongs to or corresponds to an identified/determined type-II NZP CSI-RS resource—denoted by/as a type-III NZP CSI-RS resource (or a type-III CMR), the UE could use/apply the indicated TCI state(s) associated/corresponding to the identified/determined type-II NZP CSI-RS resource to/for the configured type-I NZP CSI-RS resource, or equivalently, the type-III NZP CSI-RS resource. For a configured type-I NZP CSI-RS resource that does not correspond to or belong to any of the identified/determined type-II NZP CSI-RS resource(s)—denoted by/as a type-IV NZP CSI-RS resource (or a type-IV CMR), when/if the configured type-I NZP CSI-RS resource (or equivalently, the type-IV NZP CSI-RS resource) is configured to follow one or more (e.g., the first, second or both) of the indicated joint/DL/UL TCI states, the UE could use/apply the one or more (e.g., the first, second or both) of the indicated joint/DL/UL TCI states, to receive the configured type-I NZP CSI-RS resource, or equivalently, the type-IV NZP CSI-RS resource. For this case/design example, the configured type-I NZP CSI-RS resources (or type-I CMRs) could correspond to the type-III NZP CSI-RS resource(s) (or type-III CMR(s)) as specified/defined herein in the present disclosure; alternatively, the configured type-I NZP CSI-RS resources (or type-I CMRs) could correspond to the type-IV NZP CSI-RS resource(s) (or type-IV CMR(s)) as specified/defined herein in the present disclosure.

In yet another example, the UE could first identify/determine one or more type-II NZP CSI-RS resources (or type-II CMRs) associated/corresponding to or from the one or more indicated joint/DL/UL TCI states following those specified herein in the present disclosure (e.g., following those provided/specified in one or more examples described herein, and their corresponding sub-examples provided/specified therein). For instance, the TCI state(s)—and therefore, the corresponding QCL assumption(s)—that is RRC configured/provided to the type-II NZP CSI-RS resource(s) could be the same as or identical to the one or more indicated joint/DL/UL TCI states—and therefore, the corresponding QCL assumption(s)—that are associated/corresponding to the type-II NZP CSI-RS resource(s); and/or, the RS(s) in the TCI state(s) that is RRC configured/provided to the type-II NZP CSI-RS resource(s) could be QCL'ed with the RS(s) in the one or more indicated joint/DL/UL TCI states that are associated/corresponding to the type-II NZP CSI-RS resource(s). For this case/design example, the UE could expect that only the one or more type-II NZP CSI-RS resources (or type-II CMRs) are configured/provided/activated/triggered/indicated for the CJT operation(s) and/or the one or more CJT transmission/reception schemes (e.g., when/if the UE is configured by higher layer parameter cjtSchemePDSCH).

In yet another example, the UE could first identify/determine one or more type-II NZP CSI-RS resources (or type-II CMRs) associated/corresponding to or from the one or more indicated joint/DL/UL TCI states following those specified herein in the present disclosure (e.g., following those provided/specified in one or more examples described herein, and their corresponding sub-examples provided/specified therein). For instance, the TCI state(s)—and therefore, the corresponding QCL assumption(s)—that is RRC configured/provided to the type-II NZP CSI-RS resource(s) could be the same as or identical to the one or more indicated joint/DL/UL TCI states—and therefore, the corresponding QCL assumption(s)—that are associated/corresponding to the type-II NZP CSI-RS resource(s); and/or, the RS(s) in the TCI state(s) that is RRC configured/provided to the type-II NZP CSI-RS resource(s) could be QCL'ed with the RS(s) in the one or more indicated joint/DL/UL TCI states that are associated/corresponding to the type-II NZP CSI-RS resource(s). For this case/design example, the UE could expect that at least one of the identified/determined one or more type-II NZP CSI-RS resources (or type-II CMRs) could be configured/provided/activated/triggered/indicated for the CJT operation(s) and/or the one or more CJT transmission/reception schemes (e.g., when/if the UE is configured by higher layer parameter cjtSchemePDSCH). That is, in addition to the configured/provided/activated/triggered/indicated at least one of the identified/determined one or more type-II NZP CSI-RS resources (or type-II CMRs), the UE could also expect to be configured/provided with one or more type-V NZP CSI-RS resources (or type-V CMRs) such that (1) the UE could use/apply the TCI state(s) that is RRC configured/provided to the configured/provided type-V NZP CSI-RS resource(s) to receive the configured/provided type-V NZP CSI-RS resource(s), and/or (2) when/if the configured type-V NZP CSI-RS resource(s) is configured to follow one or more (e.g., the first, second or both) of the indicated joint/DL/UL TCI states, the UE could use/apply the one or more (e.g., the first, second or both) of the indicated joint/DL/UL TCI states, to receive the configured/provided type-V NZP CSI-RS resource(s), wherein the configured/provided type-V NZP CSI-RS resource(s) (or the type-V CMRs) does not correspond to or belong to any of the identified/determined type-II NZP CSI-RS resources.

For example, the configured/provided type-V NZP CSI-RS resource(s) (or the type-V CMR(s)) as specified herein in the present disclosure could be associated with/to the configured/provided/activated/triggered/indicated at least one of the identified/determined one or more type-II NZP CSI-RS resources (or type-II CMRs) according to: (i) fixed value(s)/rule(s) in system specification(s), (ii) network's configuration(s)/indication(s), e.g., via higher layer RRC signaling(s)/parameter(s) and/or MAC CE command(s) and/or dynamic DCI based L1 signaling(s), and/or (iii) UE's autonomous determination/selection, which could be further sent to the network, e.g., in/via part of a/the CSI/beam report and/or UE's capability signaling(s). In one example, the configured/provided type-V NZP CSI-RS resource(s) (or the type-V CMR(s)) could be with the lowest/highest (odd/even) resource ID(s) lower than the resource ID(s) of the configured/provided/activated/triggered/indicated at least one of the identified/determined one or more type-II NZP CSI-RS resources (or the type-II CMRs), e.g., in a list/set/pool of configured/activated/indicated NZP CSI-RS resources (or CMRs). In another example, the configured/provided type-V NZP CSI-RS resource(s) (or the type-V CMR(s)) could be with the highest/lowest (odd/even) resource ID(s) higher than the resource ID(s) of the configured/provided/activated/triggered/indicated at least one of the identified/determined one or more type-II NZP CSI-RS resources (or the type-II CMRs), e.g., in a list/set/pool of configured/activated/indicated NZP CSI-RS resources (or CMRs). In yet another example, the configured/provided type-V NZP CSI-RS resource(s) (or the type-V CMR(s)) could correspond to the first/last (odd/even) resource(s) starting from the configured/provided/activated/triggered/indicated at least one of the identified one or more type-II NZP CSI-RS resources (or the type-II CMRs), e.g., in a list/set/pool of configured/activated/indicated NZP CSI-RS resources (or CMRs). In yet another example, the configured/provided type-V NZP CSI-RS resource(s) (or the type-V CMR(s)) could correspond to the last/first (odd/even) resource(s) ending at the configured/provided/activated/triggered/indicated at least one of the identified/determined one or more type-II NZP CSI-RS resources (or the type-II CMRs), e.g., in a list/set/pool of configured/activated/indicated NZP CSI-RS resources (or CMRs).

For another example, the TCI state(s) configured/activated/indicated for the configured/provided type-V NZP CSI-RS resource(s) (or the type-V CMR(s))—denoted by type-V TCI state(s)—as specified herein in the present disclosure could be associated with/to the TCI state(s) configured/activated/indicated for the configured/provided/activated/triggered/indicated at least one of the identified/determined one or more type-II NZP CSI-RS resources (or the type-II CMRs)—denoted by type-II TCI state(s)—as specified herein in the present disclosure, according to: (i) fixed value(s)/rule(s) in system specification(s), (ii) network's configuration(s)/indication(s), e.g., via higher layer RRC signaling(s)/parameter(s) and/or MAC CE command(s) and/or dynamic DCI based L1 signaling(s), and/or (iii) UE's autonomous determination/selection, which could be further sent to the network, e.g., in/via part of a/the CSI/beam report and/or UE's capability signaling(s). In one example, the type-V TCI state(s) could be with the lowest/highest (odd/even) TCI state ID(s) lower than the TCI state ID(s) of the type-II TCI state(s), e.g., in a list/set/pool of configured/activated/indicated TCI states/TCI state IDs. In another example, the type-V TCI state(s) could be with the highest/lowest (odd/even) TCI state ID(s) higher than the TCI state ID(s) of the type-II TCI state(s), e.g., in a list/set/pool of configured/activated/indicated TCI states/TCI state IDs. In yet another example, the type-V TCI state(s) could correspond to the first/last (odd/even) TCI state(s) starting from the type-II TCI state(s), e.g., in a list/set/pool of configured/activated/indicated TCI states/TCI state IDs. In yet another example, the type-V TCI state(s) could correspond to the last/first (odd/even) TCI state(s) ending at the type-II TCI state(s), e.g., in a list/set/pool of configured/activated/indicated TCI states/TCI state IDs.

Yet for another example, the UE could be first configured/provided/activated/indicated a list/set/pool of NZP CSI-RS resources (or CMRs). The configured/provided type-V NZP CSI-RS resource(s) (or the type-V CMR(s)) as specified herein in the present disclosure could be from the list/set/pool of NZP CSI-RS resources (or CMRs) according to: (i) fixed value(s)/rule(s) in system specification(s), (ii) network's configuration(s)/indication(s), e.g., via higher layer RRC signaling(s)/parameter(s) and/or MAC CE command(s) and/or dynamic DCI based L1 signaling(s), and/or (iii) UE's autonomous determination/selection, which could be further sent to the network, e.g., in/via part of a/the CSI/beam report and/or UE's capability signaling(s). In one example, the configured/provided type-V NZP CSI-RS resource(s) (or the type-V CMR(s)) could be with the lowest/highest (odd/even) resource ID(s) among the NZP CSI-RS resources in the list/set/pool of configured/activated/indicated NZP CSI-RS resources (or CMRs). In another example, the configured/provided type-V NZP CSI-RS resource(s) (or the type-V CMR(s)) could be with the lowest/highest (odd/even) resource ID(s) lower than the resource ID of the k-th NZP CSI-RS resource among the NZP CSI-RS resources in the list/set/pool of configured/activated/indicated NZP CSI-RS resources (or CMRs). In yet another example, the configured/provided type-V NZP CSI-RS resource(s) (or the type-V CMR(s)) could be with the highest/lowest (odd/even) resource ID(s) higher than the resource ID of the k-th NZP CSI-RS resource among the NZP CSI-RS resources in the list/set/pool of configured/activated/indicated NZP CSI-RS resources (or CMRs). In yet another example, the configured/provided type-V NZP CSI-RS resource(s) (or the type-V CMR(s)) could correspond to the first/last (odd/even) resource(s) among the NZP CSI-RS resources in the list/set/pool of configured/activated/indicated NZP CSI-RS resources (or CMRs). In yet another example, the configured/provided type-V NZP CSI-RS resource(s) (or the type-V CMR(s)) could correspond to the first/last (odd/even) resource(s) starting from the k-th NZP CSI-RS resource among the NZP CSI-RS resources in the list/set/pool of configured/activated/indicated NZP CSI-RS resources (or CMRs). In yet another example, the configured/provided type-V NZP CSI-RS resource(s) (or the type-V CMR(s)) could correspond to the last/first (odd/even) resource(s) ending at the k-th NZP CSI-RS resource among the NZP CSI-RS resources in the list/set/pool of configured/activated/indicated NZP CSI-RS resources (or CMRs). The value(s) of k could be determined according to: (i) fixed value(s)/rule(s) in system specification(s), (ii) network's configuration(s)/indication(s), e.g., via higher layer RRC signaling(s)/parameter(s) and/or MAC CE command(s) and/or dynamic DCI based L1 signaling(s), and/or (iii) UE's autonomous determination/selection, which could be further sent to the network, e.g., in/via part of a/the CSI/beam report and/or UE's capability signaling(s).

Yet for another example, the UE (e.g., the UE 116) could be first configured/provided/activated/indicated a list/set/pool of TCI states/TCI state IDs. The TCI state(s) configured/activated/indicated for the configured/provided type-V NZP CSI-RS resource(s) (or the type-V CMR(s))—denoted by type-V TCI state(s)—as specified herein in the present disclosure could be from the list/set/pool of TCI states/TCI state IDs according to: (i) fixed value(s)/rule(s) in system specification(s), (ii) network's configuration(s)/indication(s), e.g., via higher layer RRC signaling(s)/parameter(s) and/or MAC CE command(s) and/or dynamic DCI based L1 signaling(s), and/or (iii) UE's autonomous determination/selection, which could be further sent to the network, e.g., in/via part of a/the CSI/beam report and/or UE's capability signaling(s). In one example, the type-V TCI state(s) could be with the lowest/highest (odd/even) TCI state ID(s) among the TCI states/TCI state IDs in the list/set/pool of configured/activated/indicated TCI states/TCI state IDs. In another example, the type-V TCI state(s) could be with the lowest/highest (odd/even) TCI state ID(s) lower than the TCI state ID of the k-th TCI state among the TCI states in the list/set/pool of configured/activated/indicated TCI states/TCI state IDs. In yet another example, the type-V TCI state(s) could be with the highest/lowest (odd/even) TCI state ID(s) higher than the TCI state ID of the k-th TCI state among the TCI states in the list/set/pool of configured/activated/indicated TCI states/TCI state IDs. In yet another example, the type-V TCI state(s) could correspond to the first/last (odd/even) TCI states among the TCI states in the list/set/pool of configured/activated/indicated TCI states/TCI state IDs. In yet another example, the type-V TCI state(s) could correspond to the first/last (odd/even) TCI state(s) starting from the k-th TCI state among the TCI states in the list/set/pool of configured/activated/indicated TCI states/TCI state IDs. In yet another example, the type-V TCI state(s) could correspond to the last/first (odd/even) TCI state(s) ending at the k-th TCI state among the TCI states in the list/set/pool of configured/activated/indicated TCI states/TCI state IDs. The value(s) of k could be determined according to: (i) fixed value(s)/rule(s) in system specification(s), (ii) network's configuration(s)/indication(s), e.g., via higher layer RRC signaling(s)/parameter(s) and/or MAC CE command(s) and/or dynamic DCI based L1 signaling(s), and/or (iii) UE's autonomous determination/selection, which could be further sent to the network, e.g., in/via part of a/the CSI/beam report and/or UE's capability signaling(s).

In yet another example, the UE could first identify/determine one or more type-II NZP CSI-RS resources (or type-II CMRs) associated/corresponding to or from the one or more indicated joint/DL/UL TCI states following those specified herein in the present disclosure (e.g., following those provided/specified in one or more examples described herein, and their corresponding sub-examples provided/specified therein). For instance, the TCI state(s)—and therefore, the corresponding QCL assumption(s)—that is RRC configured/provided to the type-II NZP CSI-RS resource(s) could be the same as or identical to the one or more indicated joint/DL/UL TCI states—and therefore, the corresponding QCL assumption(s)—that are associated/corresponding to the type-II NZP CSI-RS resource(s); and/or, the RS(s) in the TCI state(s) that is RRC configured/provided to the type-II NZP CSI-RS resource(s) could be QCL'ed with the RS(s) in the one or more indicated joint/DL/UL TCI states that are associated/corresponding to the type-II NZP CSI-RS resource(s). For this case/design example, the UE could expect that at least the identified/determined one or more type-II NZP CSI-RS resources (or type-II CMRs) are configured/provided/activated/triggered/indicated for the CJT operation(s) and/or the one or more CJT transmission/reception schemes (e.g., when/if the UE is configured by higher layer parameter cjtSchemePDSCH). That is, in addition to the one or more type-II NZP CSI-RS resources (or type-II CMRs), the UE could also expect to be configured/provided with one or more type-V NZP CSI-RS resources (or type-V CMRs) such that (1) the UE could use/apply the TCI state(s) that is RRC configured/provided to the configured/provided type-V NZP CSI-RS resource(s) to receive the configured/provided type-V NZP CSI-RS resource(s), and/or (2) when/if the configured type-V NZP CSI-RS resource(s) is configured to follow one or more (e.g., the first, second or both) of the indicated joint/DL/UL TCI states, the UE could use/apply the one or more (e.g., the first, second or both) of the indicated joint/DL/UL TCI states, to receive the configured/provided type-V NZP CSI-RS resource(s), wherein the configured/provided type-V NZP CSI-RS resource(s) (or the type-V CMRs) does not correspond to or belong to any of the identified/determined type-II NZP CSI-RS resources.

For example, the configured/provided type-V NZP CSI-RS resource(s) (or the type-V CMR(s)) as specified herein in the present disclosure could be associated with/to the configured/provided/activated/triggered/indicated at least the identified/determined one or more type-II NZP CSI-RS resources (or type-II CMRs) according to: (i) fixed value(s)/rule(s) in system specification(s), (ii) network's configuration(s)/indication(s), e.g., via higher layer RRC signaling(s)/parameter(s) and/or MAC CE command(s) and/or dynamic DCI based L1 signaling(s), and/or (iii) UE's autonomous determination/selection, which could be further sent to the network, e.g., in/via part of a/the CSI/beam report and/or UE's capability signaling(s). In one example, the configured/provided type-V NZP CSI-RS resource(s) (or the type-V CMR(s)) could be with the lowest/highest (odd/even) resource ID(s) lower than the resource ID(s) of the configured/provided/activated/triggered/indicated at least the identified/determined one or more type-II NZP CSI-RS resources (or the type-II CMRs), e.g., in a list/set/pool of configured/activated/indicated NZP CSI-RS resources (or CMRs). In another example, the configured/provided type-V NZP CSI-RS resource(s) (or the type-V CMR(s)) could be with the highest/lowest (odd/even) resource ID(s) higher than the resource ID(s) of the configured/provided/activated/triggered/indicated at least the identified/determined one or more type-II NZP CSI-RS resources (or the type-II CMRs), e.g., in a list/set/pool of configured/activated/indicated NZP CSI-RS resources (or CMRs). In yet another example, the configured/provided type-V NZP CSI-RS resource(s) (or the type-V CMR(s)) could correspond to the first/last (odd/even) resource(s) starting from the configured/provided/activated/triggered/indicated at least the identified/determined one or more type-II NZP CSI-RS resources (or the type-II CMRs), e.g., in a list/set/pool of configured/activated/indicated NZP CSI-RS resources (or CMRs). In yet another example, the configured/provided type-V NZP CSI-RS resource(s) (or the type-V CMR(s)) could correspond to the last/first (odd/even) resource(s) ending at the configured/provided/activated/triggered/indicated at least the identified/determined one or more type-II NZP CSI-RS resources (or the type-II CMRs), e.g., in a list/set/pool of configured/activated/indicated NZP CSI-RS resources (or CMRs).

For another example, the TCI state(s) configured/activated/indicated for the configured/provided type-V NZP CSI-RS resource(s) (or the type-V CMR(s))—denoted by type-V TCI state(s)—as specified herein in the present disclosure could be associated with/to the TCI state(s) configured/activated/indicated for the configured/provided/activated/triggered/indicated at least the identified/determined one or more type-II NZP CSI-RS resources (or the type-II CMRs)—denoted by type-II TCI state(s)—as specified herein in the present disclosure, according to: (i) fixed value(s)/rule(s) in system specification(s), (ii) network's configuration(s)/indication(s), e.g., via higher layer RRC signaling(s)/parameter(s) and/or MAC CE command(s) and/or dynamic DCI based L1 signaling(s), and/or (iii) UE's autonomous determination/selection, which could be further sent to the network, e.g., in/via part of a/the CSI/beam report and/or UE's capability signaling(s). In one example, the type-V TCI state(s) could be with the lowest/highest (odd/even) TCI state ID(s) lower than the TCI state ID(s) of the type-II TCI state(s), e.g., in a list/set/pool of configured/activated/indicated TCI states/TCI state IDs. In another example, the type-V TCI state(s) could be with the highest/lowest (odd/even) TCI state ID(s) higher than the TCI state ID(s) of the type-II TCI state(s), e.g., in a list/set/pool of configured/activated/indicated TCI states/TCI state IDs. In yet another example, the type-V TCI state(s) could correspond to the first/last (odd/even) TCI state(s) starting from the type-II TCI state(s), e.g., in a list/set/pool of configured/activated/indicated TCI states/TCI state IDs. In yet another example, the type-V TCI state(s) could correspond to the last/first (odd/even) TCI state(s) ending at the type-II TCI state(s), e.g., in a list/set/pool of configured/activated/indicated TCI states/TCI state IDs.

Yet for another example, the UE could be first configured/provided/activated/indicated a list/set/pool of NZP CSI-RS resources (or CMRs). The configured/provided type-V NZP CSI-RS resource(s) (or the type-V CMR(s)) as specified herein in the present disclosure could be from the list/set/pool of NZP CSI-RS resources (or CMRs) according to: (i) fixed value(s)/rule(s) in system specification(s), (ii) network's configuration(s)/indication(s), e.g., via higher layer RRC signaling(s)/parameter(s) and/or MAC CE command(s) and/or dynamic DCI based L1 signaling(s), and/or (iii) UE's autonomous determination/selection, which could be further sent to the network, e.g., in/via part of a/the CSI/beam report and/or UE's capability signaling(s). In one example, the configured/provided type-V NZP CSI-RS resource(s) (or the type-V CMR(s)) could be with the lowest/highest (odd/even) resource ID(s) among the NZP CSI-RS resources in the list/set/pool of configured/activated/indicated NZP CSI-RS resources (or CMRs). In another example, the configured/provided type-V NZP CSI-RS resource(s) (or the type-V CMR(s)) could be with the lowest/highest (odd/even) resource ID(s) lower than the resource ID of the k-th NZP CSI-RS resource among the NZP CSI-RS resources in the list/set/pool of configured/activated/indicated NZP CSI-RS resources (or CMRs). In yet another example, the configured/provided type-V NZP CSI-RS resource(s) (or the type-V CMR(s)) could be with the highest/lowest (odd/even) resource ID(s) higher than the resource ID of the k-th NZP CSI-RS resource among the NZP CSI-RS resources in the list/set/pool of configured/activated/indicated NZP CSI-RS resources (or CMRs). In yet another example, the configured/provided type-V NZP CSI-RS resource(s) (or the type-V CMR(s)) could correspond to the first/last (odd/even) resource(s) among the NZP CSI-RS resources in the list/set/pool of configured/activated/indicated NZP CSI-RS resources (or CMRs). In yet another example, the configured/provided type-V NZP CSI-RS resource(s) (or the type-V CMR(s)) could correspond to the first/last (odd/even) resource(s) starting from the k-th NZP CSI-RS resource among the NZP CSI-RS resources in the list/set/pool of configured/activated/indicated NZP CSI-RS resources (or CMRs). In yet another example, the configured/provided type-V NZP CSI-RS resource(s) (or the type-V CMR(s)) could correspond to the last/first (odd/even) resource(s) ending at the k-th NZP CSI-RS resource among the NZP CSI-RS resources in the list/set/pool of configured/activated/indicated NZP CSI-RS resources (or CMRs). The value(s) of k could be determined according to: (i) fixed value(s)/rule(s) in system specification(s), (ii) network's configuration(s)/indication(s), e.g., via higher layer RRC signaling(s)/parameter(s) and/or MAC CE command(s) and/or dynamic DCI based L1 signaling(s), and/or (iii) UE's autonomous determination/selection, which could be further sent to the network, e.g., in/via part of a/the CSI/beam report and/or UE's capability signaling(s).

Yet for another example, the UE could be first configured/provided/activated/indicated a list/set/pool of TCI states/TCI state IDs. The TCI state(s) configured/activated/indicated for the configured/provided type-V NZP CSI-RS resource(s) (or the type-V CMR(s))—denoted by type-V TCI state(s)—as specified herein in the present disclosure could be from the list/set/pool of TCI states/TCI state IDs according to: (i) fixed value(s)/rule(s) in system specification(s), (ii) network's configuration(s)/indication(s), e.g., via higher layer RRC signaling(s)/parameter(s) and/or MAC CE command(s) and/or dynamic DCI based L1 signaling(s), and/or (iii) UE's autonomous determination/selection, which could be further sent to the network, e.g., in/via part of a/the CSI/beam report and/or UE's capability signaling(s). In one example, the type-V TCI state(s) could be with the lowest/highest (odd/even) TCI state ID(s) among the TCI states/TCI state IDs in the list/set/pool of configured/activated/indicated TCI states/TCI state IDs. In another example, the type-V TCI state(s) could be with the lowest/highest (odd/even) TCI state ID(s) lower than the TCI state ID of the k-th TCI state among the TCI states in the list/set/pool of configured/activated/indicated TCI states/TCI state IDs. In yet another example, the type-V TCI state(s) could be with the highest/lowest (odd/even) TCI state ID(s) higher than the TCI state ID of the k-th TCI state among the TCI states in the list/set/pool of configured/activated/indicated TCI states/TCI state IDs. In yet another example, the type-V TCI state(s) could correspond to the first/last (odd/even) TCI states among the TCI states in the list/set/pool of configured/activated/indicated TCI states/TCI state IDs. In yet another example, the type-V TCI state(s) could correspond to the first/last (odd/even) TCI state(s) starting from the k-th TCI state among the TCI states in the list/set/pool of configured/activated/indicated TCI states/TCI state IDs. In yet another example, the type-V TCI state(s) could correspond to the last/first (odd/even) TCI state(s) ending at the k-th TCI state among the TCI states in the list/set/pool of configured/activated/indicated TCI states/TCI state IDs. The value(s) of k could be determined according to: (i) fixed value(s)/rule(s) in system specification(s), (ii) network's configuration(s)/indication(s), e.g., via higher layer RRC signaling(s)/parameter(s) and/or MAC CE command(s) and/or dynamic DCI based L1 signaling(s), and/or (iii) UE's autonomous determination/selection, which could be further sent to the network, e.g., in/via part of a/the CSI/beam report and/or UE's capability signaling(s).

As specified herein in the present disclosure, a UE could be indicated/provided by the network one or more joint/DL/UL TCI states, e.g., via/in/by one or more (unified) TCI state(s) activation/deactivation MAC CEs and/or one or more TCI codepoints in one or more TCI fields of one or more beam indication DCIs (e.g., DCI(s) 1_1/1_2 with or without DL assignment and/or group common DCI(s) for a group of UEs) for at least UE-dedicated reception(s) on PDSCH(s)/PDCCH(s) and/or dynamic-grant/configured-grant based PUSCH(s) and dedicated PUCCH resources. Furthermore, as specified herein in the present disclosure, the UE could also be provided/configured/indicated/activated/triggered by the network one or more NZP CSI-RS resources (or CMRs) for CJT operation(s), wherein the UE could be configured with one or more CJT transmission/reception schemes (e.g., when/if the UE is configured by higher layer parameter cjtSchemePDSCH) and/or each of the one or more NZP CSI-RS resources (or CMRs) could be higher layer RRC configured/provided with a TCI state. In this case, see the following.

In one example, the UE could expect that each of the one or more indicated joint/DL/UL TCI states could correspond to at least one of the TCI state(s) higher layer RRC configured/provided to the one or more NZP CSI-RS resources (or CMRs) for the CJT operation(s); i.e., the UE could expect that the one or more indicated joint/DL/UL TCI states belong to the TCI state(s) higher layer RRC configured/provided to the one or more NZP CSI-RS resources (or CMRs) for the CJT operation(s). Or, the UE could expect that RS(s) in each of the one or more indicated joint/DL/UL TCI states could be QCL'ed with RS(s) in at least one of the TCI state(s) higher layer RRC configured/provided to the one or more NZP CSI-RS resources (or CMRs) for the CJT operation(s); i.e., the UE could expect that RS(s) in one or more indicated joint/DL/UL TCI states are QCL'ed with one or more of the TCI states higher layer RRC configured/provided to the one or more NZP CSI-RS resources (or CMRs) for the CJT operation(s). The design procedure(s), UE behavior(s)/assumption(s) and/or etc. described/defined/specified in this case/design example could be applied when/if one or more of the following conditions are achieved/satisfied:
The number of provided/configured/activated/indicated/triggered NZP CSI-RS resource(s)—or CMR(s)—for the CJT operation(s) as specified herein in the present disclosure is less than or greater than and/or equal to a threshold y0;
The number of indicated one or more joint/DL/UL TCI states for the CJT operation(s)—e.g., for PDSCH-CJT reception(s)—as specified herein in the present disclosure is less than or greater than and/or equal to a threshold y1;
The number of provided/configured/activated/indicated/triggered NZP CSI-RS resource(s)—or CMR(s)—for the CJT operation(s) as specified herein in the present disclosure is less than or greater than and/or equal to the number of indicated one or more joint/DL/UL TCI states for the CJT operation(s)—e.g., for PDSCH-CJT reception(s)—as specified herein in the present disclosure; and/or
Each of the provided/configured/activated/indicated/triggered NZP CSI-RS resource(s)—or CMR(s)—for the CJT operation(s) as specified herein in the present disclosure could correspond to one or more of: (1) a CSI-RS (resource) for CSI or CSI acquisition, (2) a CSI-RS (resource) for beam management, (3) a tracking reference signal (TRS), (4) a CSI-RS (resource) configured with ‘repetition’ set to ‘on’, (5) a CSI-RS (resource) configured with ‘repetition’ set to ‘off’ and/or etc.

The value(s)/threshold(s) of y0 and/or y1 could be determined according to: (i) fixed rule(s)/value(s) specified/provided in system specification(s), (ii) network's configuration(s)/indication(s), e.g., via/in higher layer RRC signaling(s)/parameter(s) and/or MAC CE command(s) and/or dynamic DCI based L1 signaling(s), and/or (iii) UE's autonomous determination/selection, which could be further sent to the network, e.g., in/by part of a beam/CSI report and/or UE's capability signaling(s).

In another example, the UE could expect that at least one of the one or more indicated joint/DL/LL TCI states could correspond to at least one of the TCI state(s) higher layer RRC configured/provided to the one or more NZP CSI-RS resources (or CMRs) for the CJT operation(s); i.e., the UE could expect that at least one of the one or more indicated joint/DL/UL TCI states belong to the TCI state(s) higher layer RRC configured/provided to the one or more NZP CSI-RS resources (or CMRs) for the CJT operation(s). Or the UE could expect that RS(s) in at least one of the one or more indicated joint/DL/UL TCI states could be QCL'ed with RS(s) in at least one of the TCI state(s) higher layer RRC configured/provided to the one or more NZP CSI-RS resources (or CMRs) for the CJT operation(s). The design procedure(s), UE behavior(s)/assumption(s) and/or etc. described/defined/specified in this case/design example could be applied when/if one or more of the following conditions are achieved/satisfied:
The number of provided/configured/activated/indicated/triggered NZP CSI-RS resource(s)—or CMR(s)—for the CJT operation(s) as specified herein in the present disclosure is less than or greater than and/or equal to a threshold y0;
The number of indicated one or more joint/DL/UL TCI states for the CJT operation(s)—e.g., for PDSCH-CJT reception(s)—as specified herein in the present disclosure is less than or greater than and/or equal to a threshold y1;
The number of provided/configured/activated/indicated/triggered NZP CSI-RS resource(s)—or CMR(s)—for the CJT operation(s) as specified herein in the present disclosure is less than or greater than and/or equal to the number of indicated one or more joint/DL/UL TCI states for the CJT operation(s)—e.g., for PDSCH-CJT reception(s)—as specified herein in the present disclosure; and/or
Each of the provided/configured/activated/indicated/triggered NZP CSI-RS resource(s)—or CMR(s)—for the CJT operation(s) as specified herein in the present disclosure could correspond to one or more of: (1) a CSI-RS (resource) for CSI or CSI acquisition, (2) a CSI-RS (resource) for beam management, (3) a TRS, (4) a CSI-RS (resource) configured with ‘repetition’ set to ‘on’, (5) a CSI-RS (resource) configured with ‘repetition’ set to ‘off’ and/or etc.

The value(s)/threshold(s) of y0 and/or y1 could be determined according to: (i) fixed rule(s)/value(s) specified/provided in system specification(s), (ii) network's configuration(s)/indication(s), e.g., via/in higher layer RRC signaling(s)/parameter(s) and/or MAC CE command(s) and/or dynamic DCI based L1 signaling(s), and/or (iii) UE's autonomous determination/selection, which could be further sent to the network, e.g., in/by part of a beam/CSI report and/or UE's capability signaling(s).

In yet another example, the UE could expect that none of the one or more indicated joint/DL/UL TCI states could correspond to any of the TCI state(s) higher layer RRC configured/provided to the one or more NZP CSI-RS resources (or CMRs) for the CJT operation(s). Or the UE could expect that none of the RS(s) in the one or more indicated joint/DL/UL TCI states could be QCL'ed with the RS(s) in any of the TCI state(s) higher layer RRC configured/provided to the one or more NZP CSI-RS resources (or CMRs) for the CJT operation(s). The design procedure(s), UE behavior(s)/assumption(s) and/or etc. described/defined/specified in this case/design example could be applied when/if one or more of the following conditions are achieved/satisfied:
The number of provided/configured/activated/indicated/triggered NZP CSI-RS resource(s)—or CMR(s)—for the CJT operation(s) as specified herein in the present disclosure is less than or greater than and/or equal to a threshold y0;
The number of indicated one or more joint/DL/UL TCI states for the CJT operation(s)—e.g., for PDSCH-CJT reception(s)—as specified herein in the present disclosure is less than or greater than and/or equal to a threshold y1;
The number of provided/configured/activated/indicated/triggered NZP CSI-RS resource(s)—or CMR(s)—for the CJT operation(s) as specified herein in the present disclosure is less than or greater than and/or equal to the number of indicated one or more joint/DL/UL TCI states for the CJT operation(s)—e.g., for PDSCH-CJT reception(s)—as specified herein in the present disclosure; and/or
Each of the provided/configured/activated/indicated/triggered NZP CSI-RS resource(s)—or CMR(s)—for the CJT operation(s) as specified herein in the present disclosure could correspond to one or more of: (1) a CSI-RS (resource) for CSI or CSI acquisition, (2) a CSI-RS (resource) for beam management, (3) a TRS, (4) a CSI-RS (resource) configured with ‘repetition’ set to ‘on’, (5) a CSI-RS (resource) configured with ‘repetition’ set to ‘off’ and/or etc.

The value(s)/threshold(s) of y0 and/or y1 could be determined according to: (i) fixed rule(s)/value(s) specified/provided in system specification(s), (ii) network's configuration(s)/indication(s), e.g., via/in higher layer RRC signaling(s)/parameter(s) and/or MAC CE command(s) and/or dynamic DCI based L1 signaling(s), and/or (iii) UE's autonomous determination/selection, which could be further sent to the network, e.g., in/by part of a beam/CSI report and/or UE's capability signaling(s).

Throughout the present disclosure, a type-I NZP CSI-RS resource, a type-II NZP CSI-RS resource, a type-III NZP CSI-RS resource, a type-IV NZP CSI-RS resource and/or a type-V NZP CSI-RS resource could correspond to one or more of: (1) a CSI-RS (resource) for CSI or CSI acquisition, (2) a CSI-RS (resource) for beam management, (3) a TRS, (4) a CSI-RS (resource) configured with ‘repetition’ set to ‘on’, (5) a CSI-RS (resource) configured with ‘repetition’ set to ‘off’ and/or etc. The methods and/or design examples described/specified throughout the present disclosure could also be applied/extended to SRS(s)/SRS resource(s) transmission(s). Or throughout the present disclosure, a NZP CSI-RS resource could correspond to one or more of: (1) a CSI-RS (resource) for CSI or CSI acquisition, (2) a CSI-RS (resource) for beam management, (3) a TRS, (4) a CSI-RS (resource) configured with ‘repetition’ set to ‘on’, (5) a CSI-RS (resource) configured with ‘repetition’ set to ‘off’ and/or etc. Furthermore, as specified herein in the present disclosure, an indicated joint/DL/UL TCI state for the CJT operation(s) as specified herein in the present disclosure—e.g., for the PDSCH-CJT reception(s) could be associated/corresponding to more than one NZP CSI-RS resources (or CMRs) provided/configured/activated/indicated/triggered for the CJT operation(s) as specified herein in the present disclosure; for this case, the more than one NZP CSI-RS resources (or CMRs) that are mapped/associated/corresponding to the indicated joint/DL/UL TCI state could be one or more of: (1) a CSI-RS (resource) for CSI or CSI acquisition, (2) a CSI-RS (resource) for beam management, (3) a TRS, (4) a CSI-RS (resource) configured with ‘repetition’ set to ‘on’, (5) a CSI-RS (resource) configured with ‘repetition’ set to ‘off’ and/or etc. Optionally, as specified herein in the present disclosure, an indicated joint/DL/UL TCI state for the CJT operation(s) as specified herein in the present disclosure—e.g., for the PDSCH-CJT reception(s) could be associated/corresponding to a single NZP CSI-RS resource (or CMR) provided/configured/activated/indicated/triggered for the CJT operation(s) as specified herein in the present disclosure; for this case, the single NZP CSI-RS resource (or CMR) that is mapped/associated/corresponding to the indicated joint/DL/UL TCI state could be one or more of: (1) a CSI-RS (resource) for CSI or CSI acquisition, (2) a CSI-RS (resource) for beam management, (3) a TRS, (4) a CSI-RS (resource) configured with ‘repetition’ set to ‘on’, (5) a CSI-RS (resource) configured with ‘repetition’ set to ‘off’, and/or etc.

Throughout the present disclosure, a UE could follow one or more of the design examples as specified herein in the present disclosure to determine/identify the NZP CSI-RS resource(s) for the CJT operation(s) as specified herein in the present disclosure and/or the one or more indicated joint/DL/UL TCI states (and therefore, the RS(s) and/or QCL assumption(s)/parameter(s) provided/indicated therein) for the CJT operation(s)—e.g., the PDSCH-CJT reception(s)—as specified herein in the present disclosure and/or the TCI state(s)—and therefore, the RS(s) and/or QCL assumption(s)/parameter(s) provided/indicated therein—to use for receiving the NZP CSI-RS resource(s) for the CJT operation(s) as specified herein in the present disclosure, when/if one or more of the following conditions are achieved/satisfied:
The number of provided/configured/activated/indicated/triggered NZP CSI-RS resource(s)—or CMR(s)—for the CJT operation(s) as specified herein in the present disclosure is less than or greater than and/or equal to a threshold y0;
The number of indicated one or more joint/DL/UL TCI states for the CJT operation(s)—e.g., for PDSCH-CJT reception(s)—as specified herein in the present disclosure is less than or greater than and/or equal to a threshold y1;
The number of provided/configured/activated/indicated/triggered NZP CSI-RS resource(s)—or CMR(s)—for the CJT operation(s) as specified herein in the present disclosure is less than or greater than and/or equal to the number of indicated one or more joint/DL/UL TCI states for the CJT operation(s)—e.g., for PDSCH-CJT reception(s)—as specified herein in the present disclosure.

The value(s)/threshold(s) of y0 and/or y1 could be determined according to: (i) fixed rule(s)/value(s) specified/provided in system specification(s), (ii) network's configuration(s)/indication(s), e.g., via/in higher layer RRC signaling(s)/parameter(s) and/or MAC CE command(s) and/or dynamic DCI based L1 signaling(s), and/or (iii) UE's autonomous determination/selection, which could be further sent to the network, e.g., in/by part of a beam/CSI report and/or UE's capability signaling(s).

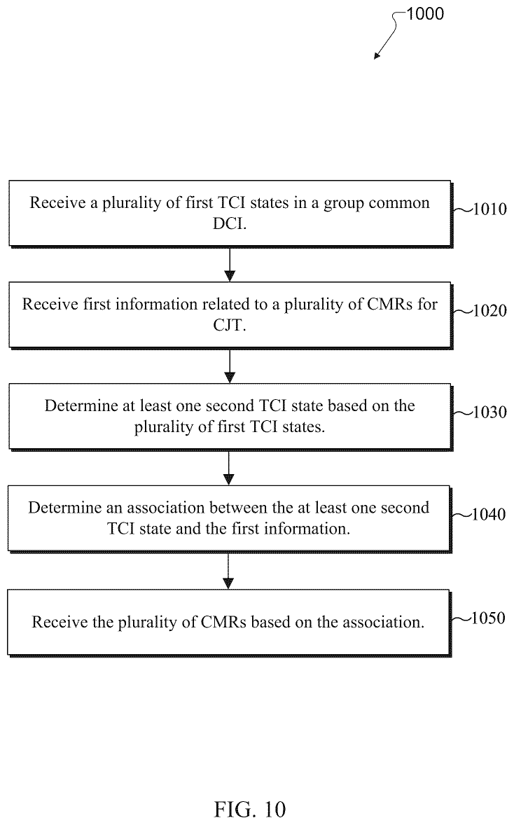

FIG. 10 illustrates an example method 1000 performed by a UE in a wireless communication system according to embodiments of the present disclosure. The method 1000 of FIG. 10 can be performed by any of the UEs 111-116 of FIG. 1, such as the UE 116 of FIG. 3, and a corresponding method can be performed by any of the BSs 101-103 of FIG. 1, such as BS 102 of FIG. 2. The method 1000 is for illustration only and other embodiments can be used without departing from the scope of the present disclosure.

The method 1000 begins with the UE receiving a plurality of first TCI states in a group common DCI (1010). For example, in 1010, the group common DCI may be of format 2_0, 2_1, 2_2, 2_3 or 2_4. In various embodiments, the plurality of first TCI states are indicated by a plurality of TCI codepoints of respective TCI fields in the group common DCI or the plurality of first TCI states are indicated by a TCI codepoint of a TCI field in the group common DCI. The UE then receives first information related to a plurality of CMRs for CJT (1020). For example, in 1020, the first information comprises at least a number of the plurality of CMRs and time-frequency domain resource configurations for the plurality of CMRs.

The UE then determines at least one second TCI state based on the plurality of first TCI states (1030). For example, in 1030, the at least one second TCI state corresponds to a subset of the plurality of first TCI states, and the subset includes the plurality of first TCI states or is identified according to a mapping rule between the plurality of first TCI states and a plurality of UEs. In various embodiments, the at least one second TCI state corresponds to a subset of the plurality of first TCI states, and the UE receives second information related to the subset and determines, based on the second information and the plurality of first TCI states, the subset. In some examples, the second information includes indexes of TCI states in the subset among the plurality of first TCI states and/or IDs of the TCI states in the subset.

The UE then determines an association between the at least one second TCI state and the first information (1040). For example, in 1040, the determination of the association may be according to a mapping rule between the at least one second TCI state and the first information related to the plurality of CMRs. In various embodiments, the UE receives third information related to the association and determines, based on the third information, the association. The UE then receives the plurality of CMRs based on the association (1050).

The above flowchart(s) illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the figures illustrate different examples of user equipment, various changes may be made to the figures. For example, the user equipment can include any number of each component in any suitable arrangement. In general, the figures do not limit the scope of the present disclosure to any particular configuration(s). Moreover, while figures illustrate operational environments in which various user equipment features disclosed in this patent document can be used, these features can be used in any other suitable system.

Although the present disclosure has been described with exemplary embodiments, various changes and modifications may be suggested to one skilled in the art. It is intended that the present disclosure encompass such changes and modifications as fall within the scope of the appended claims. None of the descriptions in this application should be read as implying that any particular element, step, or function is an essential element that must be included in the claims scope. The scope of patented subject matter is defined by the claims.

What is claimed is:

1. A user equipment (UE), comprising:
a transceiver configured to:
receive a plurality of first transmission configuration indication (TCI) states in a group common downlink control information (DCI); and
receive first information related to a plurality of channel measurement resources (CMRs) for coherent-joint transmission (CJT); and
a processor operably coupled to the transceiver, the processor configured to:
determine, based on the plurality of first TCI states, at least one second TCI state; and
determine an association between the at least one second TCI state and the first information,
wherein the transceiver is further configured to receive, based on the association, the plurality of CMRs, and
wherein the first information comprises at least a number of the plurality of CMRs and time-frequency domain resource configurations for the plurality of CMRs.

2. The UE of claim 1, wherein the group common DCI is of format 2_0, 2_1, 2_2, 2_3 or 2_4.

3. The UE of claim 1, wherein:
the plurality of first TCI states are indicated by a plurality of TCI codepoints of respective TCI fields in the group common DCI; or
the plurality of first TCI states are indicated by a TCI codepoint of a TCI field in the group common DCI.

4. The UE of claim 1, wherein:
the at least one second TCI state corresponds to a subset of the plurality of first TCI states, and
the subset:
includes the plurality of first TCI states, or
is identified according to a mapping rule between the plurality of first TCI states and a plurality of UEs.

5. The UE of claim 1, wherein:
the at least one second TCI state corresponds to a subset of the plurality of first TCI states;
the transceiver is further configured to receive second information related to the subset; and
the processor is further configured to determine, based on the second information and the plurality of first TCI states, the subset.

6. The UE of claim 5, wherein the second information includes at least one of:
indexes of TCI states in the subset among the plurality of first TCI states; and
identifiers (IDs) of the TCI states in the subset.

7. The UE of claim 1, wherein the determination of the association is according to a mapping rule between the at least one second TCI state and the first information related to the plurality of CMRs.

8. The UE of claim 1, wherein:
the transceiver is further configured to receive third information related to the association; and
the processor is further configured to determine, based on the third information, the association.

9. A base station (BS), comprising:
a processor; and
a transceiver operably coupled to the processor, the transceiver configured to:
transmit a plurality of first transmission configuration indication (TCI) states in a group common downlink control information (DCI);
transmit first information related to a plurality of channel measurement resources (CMRs) for coherent-joint transmission (CJT); and
transmit the plurality of CMRs based on an association between at least one second TCI state from the plurality of first TCI states and the first information,
wherein the first information comprises at least a number of the plurality of CMRs and time-frequency domain resource configurations for the plurality of CMRs.

10. The BS of claim 9, wherein the group common DCI is of format 2_0, 2_1, 2_2, 2_3 or 2_4.

11. The BS of claim 9, wherein:
the plurality of first TCI states are indicated by a plurality of TCI codepoints of respective TCI fields in the group common DCI; or
the plurality of first TCI states are indicated by a TCI codepoint of a TCI field in the group common DCI.

12. The BS of claim 9, wherein:
the at least one second TCI state corresponds to a subset of the plurality of first TCI states, and
the subset:
includes the plurality of first TCI states, or
is identified according to a mapping rule between the plurality of first TCI states and a plurality of user equipments.

13. The BS of claim 9, wherein:
the at least one second TCI state corresponds to a subset of the plurality of first TCI states;
the transceiver is further configured to transmit second information to indicate the subset.

14. The BS of claim 13, wherein the second information includes at least one of:
indexes of TCI states in the subset among the plurality of first TCI states; and
identifiers (IDs) of the TCI states in the subset.

15. The BS of claim 9, wherein the association is according to a mapping rule between the at least one second TCI state and the first information related to the plurality of CMRs.

16. The BS of claim 9, wherein the transceiver is further configured to transmit third information to indicate the association.

17. A method performed by a user equipment (UE), the method comprising:
receiving a plurality of first transmission configuration indication (TCI) states in a group common downlink control information (DCI);
receiving first information related to a plurality of channel measurement resources (CMRs) for coherent-joint transmission (CJT);
determining, based on the plurality of first TCI states, at least one second TCI state;
determining an association between the at least one second TCI state and the first information; and
receiving, based on the association, the plurality of CMRs,
wherein the first information comprises at least a number of the plurality of CMRs and time-frequency domain resource configurations for the plurality of CMRs.

18. The method of claim 17, wherein the group common DCI is of format 2_0, 2_1, 2_2, 2_3 or 2_4.

19. The method of claim 17, wherein:
the plurality of first TCI states are indicated by a plurality of TCI codepoints of respective TCI fields in the group common DCI; or
the plurality of first TCI states are indicated by a TCI codepoint of a TCI field in the group common DCI.

20. The method of claim 17, wherein:
the at least one second TCI state corresponds to a subset of the plurality of first TCI states, and
the subset:
includes the plurality of first TCI states, or
is identified according to a mapping rule between the plurality of first TCI states and a plurality of UEs.
